(19) United States
(12) Patent Application Publication
(10) Pub. No.: US 2026/0013572 A1
(43) Pub. Date: Jan. 15, 2026

(54) MOBILE COMMUNICATION TERMINAL INCLUDING AEROSOL GENERATOR AND CONTROL METHOD THEREOF

(71) Applicant: KT&G CORPORATION, Daejeon (KR)

(72) Inventors: Won Kyung LEE, Gyeonggi-do (KR); Sang Kyu PARK, Seoul (KR); Jang Heun YEUM, Seoul (KR)

(73) Assignee: KT&G CORPORATION, Daejeon (KR)

(21) Appl. No.: 18/992,805

(22) PCT Filed: Nov. 6, 2023
(86) PCT No.: PCT/KR2023/017637

§ 371 Date: Jan. 9, 2025

(30) Foreign Application Priority Data
Nov. 8, 2022 (KR) 10-2022-0147796

(51) Int. Cl. A24F 40/65; A24F 40/465; A24F 40/51; A24F 40/60; H04M 1/72454

(52) U.S. Cl. CPC A24F 40/65; A24F 40/465; A24F 40/51; A24F 40/60; H04M 1/72454

(57) ABSTRACT

A mobile communication terminal including a power supply configured to supply power; an aerosol generator configured to supply power to a coil using the power supplied by the power supply to heat a susceptor located in the aerosol generator and cause heating of an aerosol generating article; a sensor configured to sense a change in magnetic force occurring in the aerosol generator in response to a change in temperature of the susceptor; a communication circuit; and a controller configured to: control the communication circuit to transmit and receive wireless signals; and control the power supplied to the coil, based on the change in magnetic force.

### TECHNICAL FIELD

The following disclosure relates to a mobile communication terminal and a control method thereof.

More specifically, the following disclosure relates to a mobile communication terminal capable of generating an aerosol and a control method thereof.

### BACKGROUND ART

In the case of conventional electronically driven aerosol generating devices, a user inserts a stick through a separate device equipped with a heating element and inhales the aerosol generated by heating the stick by mouth.

As technology advances, more and more of these aerosol generating devices are being equipped with communication modules to communicate with mobile terminals.

Furthermore, a conventional aerosol generating device is provided in a communication terminal such as a cell phone (see, e.g., U.S. Pat. No. 9,894,938). The aerosol generator provided in the communication terminal is supplied with power through a power supply unit (battery, etc.) provided inside the communication terminal to heat the aerosol generating material.

However, this structure only shares the power supply and does not provide a functional or structural solution actually implemented by a single combined device.

For example, if an aerosol generating device and a mobile communication terminal are provided as a single device, multiple components must be arranged within the space of the device, which can result in a very narrow mounting space and severe interference between the components as the separation distance between the components decreases.

This may lead to poor performance and degradation of components (display, processor, memory, etc.).

If the aerosol generating device and the mobile communication terminal are provided as a single device, the stick insertion part may protrude from the mobile communication terminal or increase the thickness of the device, causing inconvenience in terms of portability.

Furthermore, if the aerosol generating device and the mobile communication device are provided as a single device, droplets or the like may be generated on the mobile communication device, causing binding of the other parts.

In addition, the residue of the aerosol generating material stuck to the heating part of the aerosol generating device may cause hygiene problems and inconvenience as it should be cleaned.

If an aerosol generating device and a mobile communication terminal are provided as a single device, it may be difficult to measure and control the temperature in the aerosol generating device depending on how they are coupled. As a result, it may not be possible to perform device control, such as proportional-integral-differential (PID) control.

### DISCLOSURE

### Technical Problem

An object of the present disclosure devised to solve the problems described above is to provide a mobile communication terminal and a control method thereof that allow a user to conveniently obtain an aerosol inhalation experience in various ways using the mobile communication terminal.

Another object of the present disclosure is to provide a mobile communication terminal and a control method thereof that may minimize decrease in performance and deterioration of components even when an aerosol generating device and the mobile communication terminal are provided as a single device.

Another object of the present disclosure is to provide a mobile communication terminal and a control method thereof that may maintain portability even if the aerosol generating device and the mobile communication terminal are provided as a single device, and may minimize the hygiene issue or inconvenience of cleaning the device.

Another object of the present disclosure is to provide a mobile communication terminal and a control method thereof that enable control of the temperature in a heating part in generating an aerosol and corresponding control of a device.

### Technical Solution

In one aspect of the present disclosure, provided herein is a mobile communication terminal including a power supply configured to supply power; an aerosol generator configured to supply power to a coil using the power supplied by the power supply to heat a susceptor located in the aerosol generator and cause heating of an aerosol generating article; a sensor configured to sense a change in magnetic force occurring in the aerosol generator in response to a change in temperature of the susceptor; a communication circuit; and a controller configured to: control the communication circuit to transmit and receive wireless signals; and control the power supplied to the coil, based on the change in magnetic force.

Alternatively, the aerosol generator is shaped to define an accommodation space, wherein the susceptor is located in the accommodation space.

Alternatively, the susceptor is included in the aerosol generating article.

Alternatively, the controller is further configured to control the power supplied to the coil to inductively heat the susceptor, based on the aerosol generating article being located in the aerosol generator.

Alternatively, the sensor comprises: a magnetic force sensor comprising at least one Hall sensor, wherein the magnetic force sensor senses a change in the magnetic force in response to the change in temperature of the susceptor.

Alternatively, the mobile communication terminal further comprise a flexible display comprising a first region contacting a first surface of the aerosol generator, wherein the first region of the flexible display changes from a flat surface to a curved surface, based on the aerosol generating article being received at the aerosol generator.

Alternatively, the mobile communication terminal further comprise a heat pipe shaped to define a vacuumed interior, wherein a fluid is located in the vacuumed interior, wherein a first region of the heat pipe is coupled to a first region of the aerosol generator, and wherein a second region of the heat pipe is coupled to a second region of the mobile communication terminal.

Alternatively, the mobile communication terminal further comprise a display; and an additional sensor, wherein the controller is further configured to: receive, from the additional sensor, first temperature information for the display; control the display based on the first temperature information; and control the additional sensor to obtain second temperature information for the aerosol generator, based on the aerosol generating article being received by the aerosol generator.

In another aspect of the present disclosure, provided herein is a mobile communication terminal including a power supply configured to supply power; an aerosol generator sized to receive an aerosol generating article; a coil coupled to the aerosol generator; a sensor configured to sense a change in magnetic force occurring in the aerosol generator in response to a change in temperature of a susceptor located in the aerosol generator; a communication circuit; and a controller. The controller is configured to control the communication circuit to transmit and receive wireless signals; and control the power from the power supply to be supplied to the coil to heat the susceptor and cause heating of the aerosol generating article to generate an aerosol, based on the change in magnetic force.

### Advantageous Effects

According to the following disclosure, a user may be provided with various aerosol inhalation experiences in a convenient manner while using a mobile communication terminal.

According to the following disclosure, even when the aerosol generating device and the mobile communication terminal are provided as a single device, the decrease in performance and deterioration of components may be minimized.

According to the following disclosure, even when the aerosol generating device and the mobile communication terminal are provided as a single device, portability may be maintained and the hygiene issue and inconvenience in terms of cleaning the device may be minimized.

Furthermore, according to the following disclosure, in generating an aerosol, control of the temperature in the heating part and corresponding control of the device may be facilitated.

### DESCRIPTION OF DRAWINGS

FIG. 1 is a block diagram illustrating a mobile communication terminal according to an embodiment.

FIG. 2 is a front view and a rear view of an embodiment of the mobile communication terminal.

FIG. 3 is an exploded view of an embodiment of the mobile communication terminal.

FIG. 4 is a cross-sectional view of one embodiment of an aerosol generation module, taken along one direction.

FIG. 5 is a cutaway view of one embodiment of the aerosol generation module disclosed above, taken along another direction.

FIG. 6 is an enlarged cross-sectional view of some components in an embodiment of the aerosol generation module disclosed above.

FIG. 8 is a view illustrating an example in which a stick is inserted into an aerosol generator of a mobile communication terminal according to an embodiment.

FIG. 7 is a view illustrating an example of the process of air movement in a second support 2220 according to the embodiment disclosed above.

FIGS. 9 and 10 are views illustrating an example structure of an aerosol generator capable of accommodating a stick according to an embodiment.

FIGS. 11 and 12 are views illustrating some embodiments of an aerosol generating device using a film-type heater outside of an aerosol generating article.

FIG. 13 illustrates an aerosol generator according to another embodiment.

FIG. 14 is a cutaway view of a second layer in an embodiment of the aerosol generator.

FIGS. 15 to 17 illustrate coupling circuits and blocks of an aerosol generator.

FIG. 18 is a view illustrating a portion of an embodiment of an aerosol generator inserted into a stick to implement an inductive heating method.

FIG. 19 is a view illustrating a portion of a heater in an embodiment of the aerosol generator.

FIG. 20 is a view illustrating a heater in an embodiment of the aerosol generator.

FIG. 21 is a view illustrating a heater including an induction coil as an embodiment of the aerosol generator.

FIG. 22 is a view illustrating a heater including an induction coil as an embodiment of an aerosol generator.

FIG. 23 is a view illustrating another embodiment of the aerosol generator that is inserted into a stick to implement an inductive heating method.

FIGS. 24 and 25 are cross-sectional views of an embodiment of the aerosol generator seen from different sides when a heater assembly is included in the aerosol generator.

FIGS. 26 and 27 are cross-sectional views from different sides of an embodiment of the aerosol generator when the heater assembly is provided as one embodiment of the aerosol generator.

FIG. 28 is an exemplary view showing an aerosol generator and a portion of a communicator coupled to each other in an embodiment of a mobile communication terminal.

FIG. 29 is a cross-sectional view and top view of the coupled module 4100 disclosed above.

FIG. 30 is a view illustrating other examples of the coupled module disclosed above.

FIG. 31 is another exemplary view of an embodiment of a mobile communication terminal, showing an aerosol generator 200 and a portion a communicator 400 coupled thereto.

FIG. 32 is a view illustrating another embodiment of a coupled module in which an antenna of a communicator is coupled to an aerosol generator.

FIG. 33 is a view illustrating another embodiment of the coupled module in which the antenna of the communicator is coupled to the aerosol generator.

FIG. 34 is a view illustrating another embodiment of the coupled module in which the antenna of the communicator is coupled to the aerosol generator.

FIG. 35 is a view illustrating another embodiment of a coupled module in which the antenna of the communicator is coupled to the aerosol generator.

FIG. 36 is a view schematically illustrating an embodiment of the aerosol generator.

FIG. 37 is a view illustrating an example of an aerosol generating article or cigarette that may be coupled to the aerosol generator of a mobile communication terminal.

FIG. 38 illustrates an example of a cigarette being inserted into the aerosol generator of the mobile communication terminal.

FIG. 39 illustrates an example of a method of winding a coil in an aerosol generator.

FIG. 40 is a flowchart illustrating an example of measuring a temperature of a heating part of an aerosol generator.

FIG. 41 is a diagram depicting a relationship between a driving frequency applied to a coil and a frequency response characteristic.

FIG. 42 is a diagram depicting the relationship between a change in resonant frequency and a response characteristic according to a change in temperature of a susceptor.

FIG. 43 is a diagram depicting a difference in resonant frequency and a change in frequency response characteristic.

FIG. 44 shows a flowchart illustrating another example of a method of operating an aerosol generator and a diagram illustrating a control period thereof.

FIG. 45 is a block diagram of one example of a mobile communication terminal capable of facilitating control of the temperature and system of an aerosol generator.

FIG. 46 is a view illustrating embodiments of a method of winding a coil in an aerosol generator.

FIG. 47 depicts a change in magnetic force and an output voltage according to a change in temperature of a susceptor.

FIG. 48 illustrates an example of controlling the temperature of a susceptor with a coil in an aerosol generator of a mobile communication terminal.

FIG. 49 is a diagram illustrating a relationship between a control period and intervals according to an example of controlling a susceptor of an aerosol generator.

FIG. 50 illustrates an example of controlling a susceptor when the coil unit of the aerosol generator is configured as a single coil unit.

FIG. 51 illustrates an example of controlling a susceptor when the coil unit of the aerosol generator includes two or more coils.

FIG. 52 illustrates an embodiment of a mobile communication terminal capable of easily controlling the temperature and system of an aerosol generator.

FIG. 53 is a block diagram illustrating a mobile communication terminal including an aerosol generator.

FIG. 54 is a diagram illustrating an aerosol generator based on an external inductive heating method.

FIG. 55 is a diagram illustrating an equivalent resistance of an aerosol generator accommodating a stick including a susceptor.

FIG. 56 is a flowchart illustrating a method of controlling the power of the aerosol generator based on the equivalent resistance calculated by a controller.

FIG. 57 is a block diagram illustrating a mobile communication terminal including an aerosol generator.

FIG. 58 is a diagram illustrating how an aerosol generator inductively heats a susceptor included in a stick.

FIG. 59 is a diagram illustrating how a characteristics change sensor senses a change in characteristic of a susceptor.

FIG. 60 is a diagram illustrating a method of controlling power to the aerosol generator by a controller based on an estimated temperature of the susceptor.

FIG. 61 is a block diagram schematically illustrating a mobile communication terminal including an aerosol generator.

FIGS. 62 and 63 illustrate a method of controlling the performance of a display module by a controller based on whether a stick is accommodated in the aerosol generator.

FIGS. 64 and 65 illustrate methods of performing, by the controller, operations related to the aerosol generator based on the second temperature information.

FIG. 66 is a front view of a mobile communication terminal without a stick accommodated according to one embodiment of the present disclosure.

FIG. 67 is a front view of a mobile communication terminal with a stick accommodated according to one embodiment of the present disclosure.

FIG. 68 is a top view of a mobile communication terminal with a stick accommodated according to one embodiment of the present disclosure.

FIG. 69 is a top view of a mobile communication terminal without a stick accommodated according to one embodiment of the present disclosure.

FIG. 70 is a top view of a mobile communication terminal with a stick accommodated according to one embodiment of the present disclosure.

FIG. 71 is a view illustrating an embodiment of operation of a mobile communication terminal in a stick accommodation mode according to one embodiment of the present disclosure.

FIG. 72 is a view illustrating a first region of a flexible display of a mobile communication terminal according to one embodiment of the present disclosure.

FIG. 73 is a view illustrating a first region of a flexible display of a mobile communication terminal according to another embodiment of the present disclosure.

FIG. 74 is a view illustrating a flexible display of a mobile communication terminal according to one embodiment of the present disclosure.

FIG. 75 is a view illustrating a flexible display of a mobile communication terminal according to one embodiment of the present disclosure.

FIG. 76 is a view illustrating a pressure sensor array of a flexible display according to one embodiment of the present disclosure.

FIG. 77 is a view illustrating a pressure sensor array of a flexible display according to one embodiment of the present disclosure.

FIG. 78 illustrates component modules of a mobile communication terminal according to one embodiment of the present disclosure.

FIG. 79 is a view illustrating a mobile communication terminal according to one embodiment of the present disclosure.

FIG. 80 is a view illustrating a heat pipe according to one embodiment of the present disclosure.

FIG. 81 is a view illustrating an aerosol generator according to one embodiment of the present disclosure.

FIG. 82 is a view illustrating an aerosol generator according to one embodiment of the present disclosure.

FIG. 83 is a view illustrating component modules of a mobile communication terminal according to one embodiment of the present disclosure.

### BEST MODE

Hereinafter, embodiments disclosed herein will be described in detail with reference to the accompanying drawings, wherein the same or like parts will be assigned the same reference numerals regardless of drawing designation, and redundant descriptions thereof will be omitted.

In the description below, a substance that produces an aerosol will be referred to as an aerosol generating article (cigarette) and it will be assumed that the the article is formed in the shape of a stick.

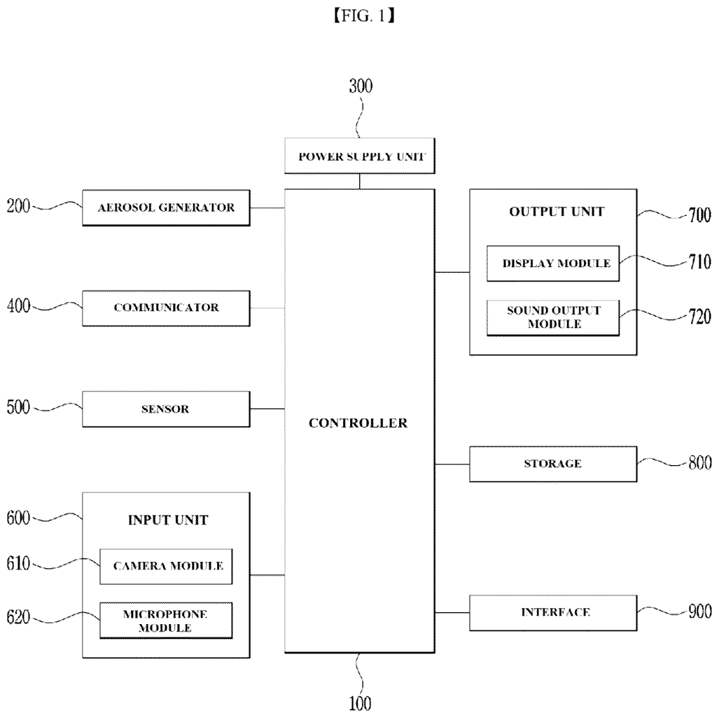

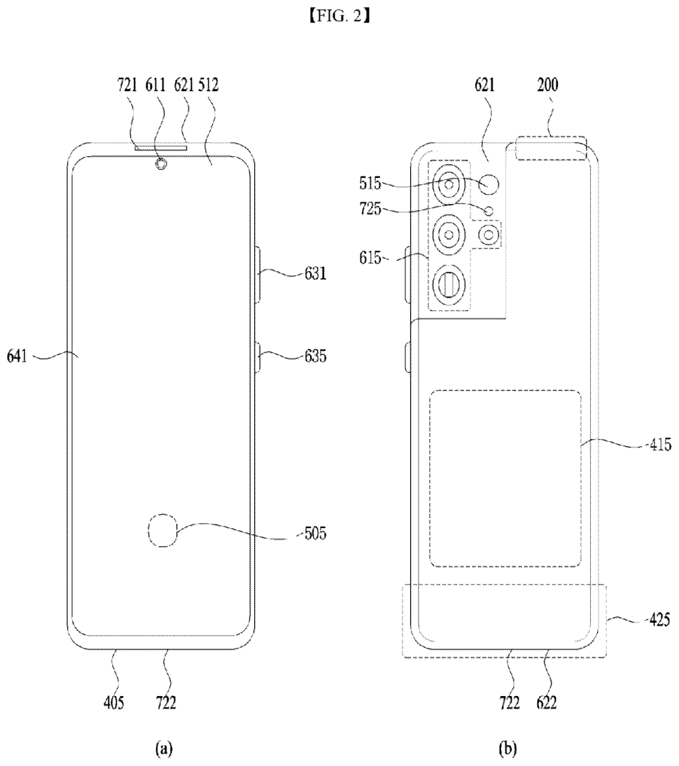

FIG. 1 is a block diagram illustrating a mobile communication terminal according to an embodiment.

The disclosed embodiment illustrates a logical configuration of a mobile communication terminal.

One example of the mobile communication terminal may include a controller 100, an aerosol generator 200, a power supply unit 300, a communicator 400, a sensor 500, an input unit 600, an output unit 700, a storage 800, and an interface 900.

The controller 100 outputs signals that control or may control the components disclosed below.

Under the control of the controller 100, the power supply unit 300 receives external power and internal power and supplies the power to the respective components included in the mobile communication terminal. The power supply unit 300 may include a battery, which may be a built-in battery or a replaceable battery.

The aerosol generator 200 may receive power input from the power supply unit 300 and may generate an aerosol for the user to experience under the control of the controller 200.

The aerosol generator 200 may accommodate an aerosol generating article or cigarette. It is assumed herein that the cigarette is in the form of a stick, but the concept of the disclosure need not be limited thereto. The internal configuration of the stick may differ among embodiments, and detailed embodiments thereof will be disclosed below.

The aerosol generator 200 has an accommodation space or insertion space and may accommodate an aerosol generating article, cartridge or cigarette. The aerosol generator 200 may have various shapes, but will be described below as having a pipe shape as an example.

The aerosol generator 200 may include a heater or heating part in various ways to heat the aerosol generating article or cigarette. The heater may include multiple components. In this case, it is referred to as a heater assembly or heating assembly.

The aerosol generator 200 may heat the aerosol generating article or cigarette using one of multiple heating methods. For example, the aerosol generator 200 may heat the aerosol generating article by heating a receptor in the accommodation space using a magnetic field from a coil embedded in the housing of the accommodation space, or may heat the aerosol generating article directly or inductively using, for example, a heating patterned element on the housing, or a heating element or pin inside the housing.

Examples of the heating method, structure and function of the aerosol generator 200 will be described in detail below.

The controller 100 may control the function and operation of the aerosol generator 200. In the disclosed embodiments, the controller 100 may obtain the temperature in the aerosol generator 200 or the temperature of the aerosol generating article in the aerosol generator 200 directly or from the sensor 500 spaced apart from the aerosol generator 200 according to the heating method.

An embodiment in which the controller 100 senses the temperature of the aerosol generator 200 and reliably controls a system including proportional-integral-differential (PID) control of a mobile communication terminal including the aerosol generator 200 on the basis thereof is shown in FIGS. 36 to 60.

Based on the temperature obtained from the sensor 500 and the like, the controller 100 may control the whole or each part of the mobile communication terminal such that the various functions of the mobile communication terminal operate smoothly and are not significantly affected by the temperature. Even when the aerosol generator 200 is in operation, the controller 100 may control the mobile communication terminal to be supplied with appropriate power from the power supply unit 200 and adjust the functions.

Specific embodiments will be disclosed below.

The communicator 400 may include one or more modules that enable wireless communication between the exemplified mobile communication terminal and a wireless communication system, between the exemplified mobile communication terminal and another exemplified mobile communication terminal, or between the exemplified mobile communication terminal and an external server.

The communicator 400 may include or be equipped with a universal subscriber identity module (USIM), and the terminal may communicate with a base station or another terminal based on the unique identification of the user.

In addition, the communicator 400 may include one or more modules that connect the exemplary mobile communication terminal to one or more networks.

The communicator 400 may include at least one of a broadcast reception module, a mobile communication module, a wireless Internet module, a short-range communication module, and a location information module.

The broadcast reception module (not shown) receives broadcast signals and/or broadcast-related information from an external broadcast management server on a broadcast channel. The broadcast channel may include a satellite channel and a terrestrial channel. Two or more broadcast reception modules may be included in the mobile communication terminal for simultaneous broadcast reception on at least two broadcast channels or for broadcast channel switching.

The mobile communication module (not shown) may transmit and/or receive a wireless signal to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), 5G NR, and the like).

The wireless signal may include an audio call signals a video call signals, or various formats of data according to text/multimedia messages.

When the communicator 400 includes a wireless Internet module, the wireless Internet module of the communicator 400 refers to a module for wireless Internet access. It may be included in or external to the disclosed mobile communication terminal. The wireless Internet module of the communicator 400 transmits and receives wireless signals over a communication network according to wireless Internet technologies.

Wireless Internet technologies include, for example, Wireless LAN (WLAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

If the communicator 400 includes a near field communication module, the near field communication module of the communicator 400 is for short range communication and may support short range communication using at least one of Bluetooth™ Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies. The short-range wireless communication networks may be short-range wireless personal area networks. For example, the communicator 400 may recognize data and/or communicate with data via NFC communication with an antenna module including a loop coil.

When the communicator 400 includes a location information module, the location information module of the communicator 400 is configured to acquire the location (or current location) of the mobile communication terminal, such as a Global Positioning System (GPS) module or a Wi-Fi module. For example, when the mobile communication terminal employs the GPS module, it may acquire the location of the mobile communication terminal based on a signal from a GPS satellite. In another example, when the mobile communication terminal employs the Wi-Fi module, it may acquire the location of the mobile communication terminal based on information about a wireless access point (WAP) transmitting or receiving wireless signals to or from the Wi-Fi module. Alternatively or additionally, the location information module may perform the function of any of the other modules of the wireless communicator to acquire data about the location of the mobile communication terminal. The location information module is used to acquire the location (or current location) of the mobile communication terminal, and is not limited to a module that directly calculates or acquires the location of the mobile communication terminal.

The antenna of the communicator 400 may be coupled to the aerosol generator 200 or may be a coupled module. For example, the antenna of the communicator 400 may be located on the body of the aerosol generator 200. The antenna may include a patch formed of a conductor and a ground spaced apart from the patch. Detailed embodiments thereof will be disclosed below.

The sensor 500 may include one or more sensors configured to sense at least one of information in the mobile communication terminal, information about the environment surrounding the mobile communication terminal, or user information. For example, the sensor 500 may include at least one of a proximity sensor, an illumination sensor, a touch sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor, a microphone, a battery gauge of the power supply unit, an environmental sensor (e.g., a barometer, a hygrometer, a thermometer, a radiation detection sensor, a heat detection sensor, a gas detection sensor, etc.), or a chemical sensor (e.g., an electronic nose, a healthcare sensor, or a biometric sensor, etc.).

The input unit 600 may include a camera module 610 or image input unit configured to input an image signal and a microphone module 620 or audio input unit configured to input an audio signal. The input unit 600 may include a user input unit (e.g., a touch key, a mechanical key, etc.) configured to receive input of information from a user. Voice data or image data collected by the input unit 600 may be analyzed and processed into control commands of the user.

The camera module 610 processes image frames such as still images or moving images obtained by an image sensor. The processed image frames may be displayed on the display module 710 of the output unit 700 or stored in the storage 800.

The camera module 610 may be connected to the sensor 500, which includes various sensors.

The output unit 700 is configured to generate outputs related to visual, auditory, or tactile sensations, and may include a display module 710 and a sound output module 720. The output unit 700 may further include a haptic module and an optical output unit.

The display module 710 may be layered or integrally formed with the touch sensor, thereby implementing a touchscreen. Such a touch screen may function as a module of the user input unit to provide an input interface between the mobile communication terminal and a user, or may function as a module of the output unit between the mobile communication terminal and the user.

The display module 710 includes or is connected to a touch sensor capable of sensing touch input. When the display module 710 is connected to the touch sensor, the touch sensor may be included in the sensor 500.

The touch sensor senses a touch (or touch input) applied on the touch screen using at least one of various touch schemes, such as a resistive scheme, a capacitive scheme, an infrared scheme, an ultrasonic scheme, or a magnetic field scheme.

In one example, the touch sensor may be configured to convert a change in pressure applied to a particular region of the touch screen of the display module 710, or a change in capacitance at a particular region, into an electrical input signal. The touch sensor may be configured to detect the touch location, area, pressure at touch, capacitance at touch, or the like of a touch object on the touch sensor when the touch object applies a touch to the touch screen.

The sound output module 720 may output audio data received from the communicator 400 or stored in the storage 800 in a call signal reception mode, a call mode, a recording mode, a speech recognition mode, a broadcast reception mode, or the like. The sound output module 720 may also output a sound signal related to a function (e.g., a call signal reception sound, a message reception sound, etc.) performed by the mobile communication terminal. The sound output module 720 may include a receiver, a speaker, and a buzzer.

When the output unit 700 includes a haptic module, the haptic module generates various tactile effects that may be felt by a user. A representative example of the tactile effects generated by the haptic module may be vibration. The intensity and pattern of the vibration generated by the haptic module may be controlled by user selection or by settings in the controller. For example, the haptic module may synthesize and output different vibrations or output the vibrations sequentially.

When the output unit 700 includes an optical output unit, the optical output unit outputs a signal to indicate the occurrence of an event using light from a light source of the mobile communication terminal. Examples of events occurring on the mobile communication terminal may message reception, call signal reception, a missed call, an alarm, a schedule notification, an email reception, and information reception through an application.

The storage 800 stores data that supports various functions of the mobile communication terminal. The storage 800 may store application programs (or applications) executed on the mobile communication terminal, and data and instructions for operating the mobile communication terminal, and the like. At least some of these applications may be downloaded from an external server via wireless communication. In addition, at least some of these applications may be present on the mobile communication terminal at time of shipping for basic functions of the mobile communication terminal (e.g., receiving calls, sending calls, receiving messages, and sending messages). Applications may be stored in the storage 800 and installed on the mobile communication terminal, and executed by controller 100 to perform an operation (or function) of the mobile communication terminal.

The interface 900 serves as a pathway for various types of external devices to be connected to the mobile communication terminal. The interface 900 may include at least one of a wired/wireless headset port, an external charger port, a wired/wireless data port, a memory card port, a port for connecting a device equipped with an identification module, an audio input/output (I/O) port, a video I/O port, or an earphone port. In response to an external device being connected to the interface 900, the mobile communication terminal may perform appropriate controls related to the connected external device.

In addition to operations related to the applications, the controller 100 generally controls the overall operation of the mobile communication terminal. The controller 100 may provide or process appropriate information or functions for the user by processing signals, data, information, and the like that are input or output through the components discussed above, or by executing applications stored in the storage 800.

The controller 100 may control at least some of the components illustrated in this figure to run the applications stored in the storage 800. Further, the controller 100 may operate at least two of the components included in the mobile communication terminal in combination to execute the applications.

At least some of the components may operate in cooperation with each other to implement the operation, control, or control method of the mobile communication terminal according to various embodiments described below. Further, the operation, control, or control method of the mobile communication terminal may be implemented by executing at least one application stored in the storage 800.

The blocks disclosed above represent a logical structure. In terms of a physical structure, two or more blocks may constitute one physical structure, or one block may include two or more physical structures.

Hereinafter, an example of the physical structure of a mobile communication terminal is described.

FIG. 2 is a front view and a rear view of an embodiment of the mobile communication terminal. In this figure, the front view is shown in (a) and the rear view is shown in (b).

This figure illustrates an example of a layout of an actual mobile communication terminal, wherein the front and rear views illustrate the actual locations of the functional blocks disclosed above.

Referring to the front view in (a) of this figure, as an example of an output unit of the exemplary mobile communication terminal, a speaker 721 may be located at the top, and a multi-type port 722 for an earphone jack, a USB, or the like may be located at the bottom. The user may use the sound output service of the mobile communication terminal from the sound output module.

As an example of the input unit of the mobile communication terminal, a front camera 611 may be located in the upper center of the display of the terminal to receive and process images.

As an example of the input unit, a microphone 621 may be located at the top of the mobile communication terminal. As examples of the input unit, a volume control key 631 and a side push key 635 related to the application operation or power may be located at one end (in this example, the right side surface) of the example mobile communication terminal.

The display module may be a touch screen 641. The touch screen 641 provides an input function in terms of processing information as it receives user information by touch. Also, the touch screen 641 provides a sensing function in terms of input method as the user information is input through the sensing of touch.

In the front view (a) of this figure, a touch sensor 505, which is an example element included in the sensor, is illustrated as being located near the center of the touch screen 641. The touch sensor 505 may sense touch input on the touch screen 641 using at least one of several touch methods.

The sensor of the mobile communication terminal may include a proximity sensor 512, which is illustrated in the upper right corner in the front view in (a) of this figure. The proximity sensor 512 may include an optical sensor to sense whether a user is in close proximity during a call.

In the example shown in the front view in (a) of this figure, a tray 405 into which a SIM card can be inserted is arranged at the bottom of the terminal. A user may inset a SIM card, which is an IC card implementing a subscriber identification module, into the bottom of the terminal to enable mobile communication with a base station.

Referring to the rear view in (b) of this figure, a separate speaker 722 may be located at the lower end as an example output unit of the mobile communication terminal.

The rear view in (b) of this figure exemplarily shows that a camera module 615 and a laser sensor 515 for focusing the camera module are disposed at the upper left corner. An example of the mobile communication terminal may include a flash 725 as an example of an optical output unit among the output units. The flash 725 may be controlled to operate independently from or in conjunction with the camera module 615.

As examples of the input unit of the mobile communication terminal, a microphone 621 may be disposed at the upper center and a microphone 622 may be disposed at the lower end. The microphone 621 at the upper center is also shown in the front view in (a).

At the center of the rear surface of the mobile communication terminal, a loop antenna module 415 including a loop coil may be disposed, which performs wireless charging as a power supply unit and functions as an NFC antenna as a communicator.

The loop antenna module 415 is a loop-shaped antenna that may communicate by magnetic induction or the like, and may enable wireless power supply to the mobile communication terminal.

The loop antenna module 415 may transmit data using a magnetic field between the loop antennas, or perform communication by selectively generating an electromagnetic field.

Additionally, the loop antenna module 415 may sense a frequency for temperature control of a susceptor heated in the aerosol generator 200 in a magnetic induction manner. A detailed embodiment thereof will be described below.

A main communication antenna 425, which sends or receives wireless communication signals to and from a base station, may be disposed at a lower portion of the rear surface of the mobile communication terminal.

In this figure, the aerosol generator 200 is shown as being disposed at one upper end of the mobile communication terminal. The location of the aerosol generator 200 may vary depending on the embodiments. When the aerosol generator 200 is disposed at the location illustrated in this embodiment, it may be coupled with the GPS antenna.

In this case, a structure for preventing deterioration of the GPS antenna may be required. A detailed embodiment thereof will be disclosed below.

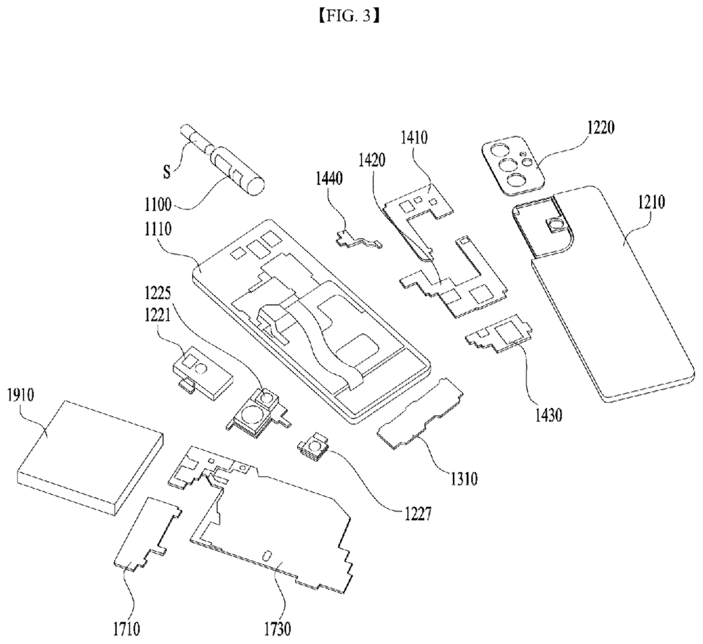

FIG. 3 is an exploded view of an embodiment of the mobile communication terminal.

The exploded view of the mobile communication terminal includes a main body 1110 and a rear frame 1210. The rear frame 1210 is separable from a camera frame 1220.

The camera frame 1220 may provide a frame in which a camera module array including a first camera module 1221, a second camera module 1225, and a third camera module 1227 is disposed.

An antenna module 1310 for wireless communication may be disposed on the lower side of the main body 1110.

The main body 1110 may include a circuit board set including a first circuit board 1410, a second circuit board 1420, a third circuit board 1430, and a fourth circuit board 1440.

Each circuit board may include various chips on both surfaces thereof. The chips perform control functions. For example, the first circuit board 1410 may include a front-end chip for communications and an audio amplification chip. The second circuit board 1420 may include a mobile processor, a communication modulator, a power control chip, and a memory.

The third circuit board 1430 may include a camera control module to control the camera module array, and the fourth circuit board 1440 may have a laser control chip attached thereto for the camera module array.

The loop coil module 1730 may include a coil and its control circuit for short-range radio antenna communication and wireless charging.

The fifth circuit board 1710 may include a circuit for audio output. A battery module 1910 to provide power to the circuit may be included in the main body 1110.

The aerosol generator 1100 may be disposed at the top of the main body 1110 and electrically connected to the circuit board set of the main body 1110. The aerosol generator 1100 may accommodate a stick S including an aerosol generating article or cigarette.

While the aerosol generator 1110 and the stick are illustrated in this example as being cylindrically shaped, they may be implemented differently depending on the embodiments. In the embodiments described below, the aerosol generator 1110 and the stick are illustrated as having a cylindrical shape for simplicity.

Hereinafter, embodiments of the above-disclosed aerosol generator of a mobile communication terminal will be disclosed in detail.

The disclosed aerosol generator serves to generate an aerosol by electrically heating a cigarette accommodated in an inner space thereof.

The aerosol generator 200 may include a heater. In one embodiment, the heater may be an electrically resistive heater. For example, the heater may include electrically conductive tracks, and the heater may be heated when current flows through the electrically conductive tracks.

The heater may include a tubular heating element, a plate-shaped heating element, a needle-shaped heating element, or a rod-shaped heating element, and may heat the inside or outside of the cigarette depending on the shape of the heating element. Related embodiments will be described in detail below.

The cigarette may include a tobacco rod and a filter rod. The tobacco rod may be made of a sheet, may be made of a strand, or may be made of a shredded tobacco sheet. Further, the tobacco rod may be surrounded by a thermally conductive material.

For example, the thermally conductive material may be, but is not limited to, a metal foil such as aluminum foil.

The filter rod may be a cellulose acetate filter. The filter rod may include at least one segment. For example, the filter rod may include a first segment for cooling the aerosol and a second segment for filtering a predetermined component contained within the aerosol.

In another embodiment, the aerosol generator may generate an aerosol using a cartridge that holds an aerosol generating material.

The aerosol generator may include a cartridge configured to hold the aerosol generating material and a body supporting the cartridge. The cartridge may be removably coupled to the mobile communication terminal or the aerosol generator, but is not limited thereto. The cartridge may be integrally formed or connected with the mobile communication terminal or the aerosol generator, and may be fixed so as not to be removed by a user. The cartridge may be mounted to the body with the aerosol generating material accommodated therein. However, embodiments are not limited thereto. The aerosol generating material may be injected into the cartridge with the cartridge coupled to the mobile communication terminal or the aerosol generator.

The cartridge may hold an aerosol-generating material in any one of various states, such as liquid state, solid state, gas state, and gel state. The aerosol generating material may include a liquid composition. For example, the liquid composition may be a liquid containing a tobacco-containing substance including a volatile tobacco flavor component, or may be a liquid containing a non-tobacco substance.

The cartridge is operated by an electrical signal or wireless signal transmitted from the body, thereby converting the phase of the aerosol-generating material inside the cartridge into a gas phase to generate an aerosol. Aerosol may refer to a gas containing a mixture of vaporized particles generated from the aerosol generating material and air.

In another embodiment, an aerosol may be generated by heating an aerosol mobile communication terminal or the aerosol generator and a liquid composition. The generated aerosol may be delivered to the user through a cigarette. That is, the aerosol generated from the liquid composition may move along the airflow passage in the aerosol generator. The airflow passage may be configured to allow the aerosol to pass through the cigarette and be delivered to the user.

In another embodiment, an aerosol mobile communication terminal or aerosol generator and an ultrasonic vibration method may be used to generate an aerosol from an aerosol generating material. Here, the ultrasonic vibration method may refer to a method of generating an aerosol by atomizing the aerosol generating material with ultrasonic vibration generated by a vibrator.

The aerosol generator may include a vibrator, and may generate short-period vibrations through the vibrator to atomize the aerosol generating material. The vibration generated from the vibrator may be ultrasonic vibration, and the frequency band of the ultrasonic vibration may be from about 100 kHz to about 3.5 MHz, but is not limited thereto.

The aerosol generator may further include a wick that absorbs the aerosol generating material. For example, the wick may be arranged to surround at least one region of the vibrator or may be arranged to contact at least one region of the vibrator.

As a voltage (e.g., alternating voltage) is applied to the vibrator, heat and/or ultrasonic vibration may be generated from the vibrator. The heat and/or ultrasonic vibration generated from the vibrator may be transmitted to the aerosol generating material absorbed by the wick. The aerosol generating material absorbed into the wick may be converted into a gas phase by the heat and/or ultrasonic vibration transmitted from the vibrator. As a result, an aerosol may be generated.

For example, the viscosity of the aerosol generating material absorbed into the wick by the heat generated from the vibrator may be lowered. The aerosol generating material with the lowered viscosity due to ultrasonic vibration generated from the vibrator may be converted into fine particles, thereby generating an aerosol. However, embodiments are not limited thereto.

In another embodiment, the aerosol generator may generate an aerosol by heating an aerosol generating article accommodated in the aerosol generator using inductive heating.

The aerosol generator may include a susceptor and a coil. In one embodiment, the coil may apply a magnetic field to the susceptor. As power is supplied to the coil from the aerosol generator, a magnetic field may be formed inside the coil. In one embodiment, the susceptor may be a magnetic member that generates heat by an external magnetic field. As the susceptor is disposed inside the coil and a magnetic field is applied, the aerosol generating article may be heated by generating heat. Additionally, optionally, the susceptor may be disposed in the aerosol generating article.

Embodiments of the present disclosure will be described in detail below with reference to the accompanying drawings to facilitate practice by one having ordinary skill in the art.

Disclosed examples include a heater that heats an aerosol generating material according to a non-contact, externally inducing method.

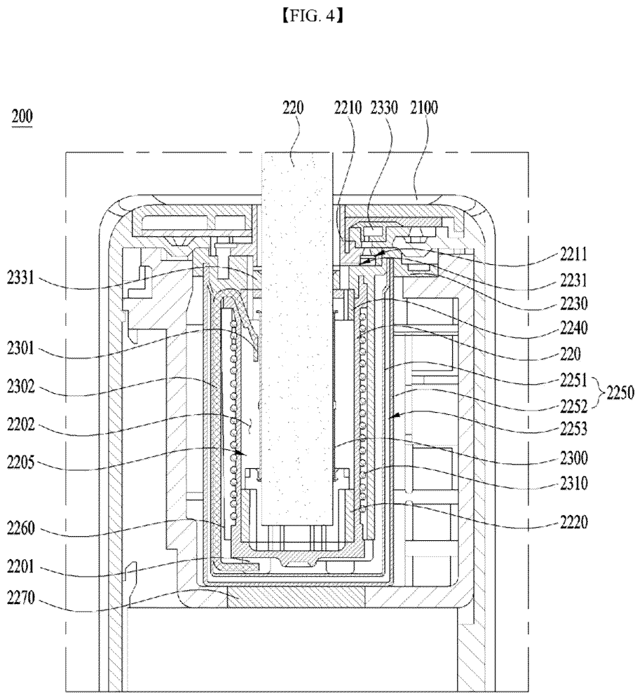

FIG. 4 is a cross-sectional view of one embodiment of an aerosol generation module, taken along one direction.

The aerosol generator 200 may include a heater capable of heating an aerosol generating article using one of several methods when the aerosol generating article is inserted into the pipe-shaped inner space.

Here, the aerosol generator 200 according to one embodiment may include an inner container 2200, a first support part 2210, a second support part 2220, and a heater 2300.

The inner container 2200 may be disposed in the inner space of the housing 2100. The inner container 2200 may include an accommodation space 2205 for accommodating an aerosol generating article 220.

The accommodation space 2205 may not only accommodate the aerosol generating article 220, but also serve as a passage through which air coming from the outside flows. An internal passage 2202 may be formed between the inner container 2200 and the heater 2300 to allow the air introduced into the accommodation space 2205 through the inflow passage (not shown) of the first support part 2210 to flow to the second support part 2220. The air introduced into the accommodation space 2205 may move along the internal passage 2202 and reach the second support part 2220.

The first support part 2210 may be disposed at the entrance of the accommodation space 2205 and thus support at least a portion of the aerosol generating article 220 accommodated in the accommodation space 2205. Additionally, the first support part 2210 may allow air existing outside the aerosol generator 200 to flow into the accommodation space 2205.

The first support part 2210 may include a support member (not shown) arranged to support at least a portion of the aerosol generating article and an inflow passage allowing air outside the aerosol generator 200 to flow into the accommodation space 2205.

The first support part 2210 may include a puff sensing hole 2211 that leads to a puff sensor 2330. The puff sensing hole 2211 may be disposed at a lower end of the puff sensor 2330, which is adjacent to the first support part 2210. Air that has passed through the inflow passage may flow into the puff sensor 2330 through the puff sensing hole 2211.

The puff sensing hole 2211 may become narrower as it extends toward the puff sensor 2330. However, it not limited to the shape described above.

The second support part 2220 may be disposed inside the accommodation space 2205 to support an end of the aerosol generating article 220. Additionally, the second support part 2220 may allow air present in the accommodation space 2205 to flow into the aerosol generating article 220.

The second support part 2220 may include a delivery passage (not shown) that allows air in the accommodation space 2205 to flow into the aerosol generating article therethrough.

One end of the heater 2300 may be inserted into the second support part 2220. Accordingly, the heater 2300 may be supported by the second support part 2220.

A coupler 2230 may be coupled to the lower end of the first support part 2210.

The coupler 2230 may include a first air hole (not shown) that allows air that has passed through the inflow passage of the first support part 2210 to flow into the accommodation space 2205 therethrough.

Once the coupler 2230 and the first support part 2210 are coupled, a puff sensing passage 2301 may be formed between the upper end of the coupler 2230 and the first support part 2210. The puff sensing passage 2301 may connect the inflow passage and the puff sensor 2330. Air that has passed through the inflow passage of the first support part 2210 may pass through the puff sensing passage 2301 and flow into the puff sensor 2330 adjacent to the first support part 2210.

According to one embodiment, air moving along the puff sensing passage 2301 may pass through the puff sensing hole 2211 of the first support part 2210 and reach the puff sensor 2330.

A portion of the coupler 2230 may surround the outer circumference of the inner container 2200. Other components outside the coupler 2230 may be arranged in contact with a portion of the coupler 2230, and thus be supported by the coupler 2230.

Another portion of the coupler 2230 may be open. As a result, the aerosol generator 200 may secure inner space where other components can be disposed.

The coupler 2230 may further include a guide 2331 that guides the operation of inserting the aerosol generating article 220.

In order to prevent the guide 2310 from obstructing the aerosol generating article 220 from being inserted into the aerosol generator 200, at least a portion (e.g., the upper portion) of the guide 2310 may be chamfered. The chamfered portion may be beveled or rounded.

In another example, the guide 2310 may support at least a portion of the outer circumferential surface of the aerosol generating article 220.

One end (e.g., upper end) of the inner container 2200 may be inserted into the coupler 2230. Thus, the inner container 2200 may be supported by the coupler 2230.

An outer container 2250 may be positioned spaced apart from the inner container 2200, facing the outer side of the inner container 2200.

The outer container 2250 may block heat generated by the heater 2300 from being transferred to the outside. In order to increase the efficiency of insulation, the outer container 2250 may include a double wall structure.

The outer container 2250 may include an inner wall 2251 facing the inner container 2200, an outer wall 2252 spaced apart from the inner wall 2251 and facing the outside of the outer container 2250, and an insulating space 2253 defined between the inner wall 2251 and the outer wall 2252. The insulating space 2253 may remain vacuumed to minimize heat transfer to the outside of the aerosol generator 200. As used herein, “vacuumed” does not refer only to a complete absence of air, but also includes being at a pressure lower than the ambient atmospheric pressure.

The outer container 2250 may include a through hole (not shown) at the lower end thereof. One or more wires or a magnetic field generator 2310 may extend to the outside of the outer container 2250 through the through hole in the outer container 2250.

The inner container 2200 may include one or more supports 2201 that contact the inner lower end of the outer container 2250. Due to the supports 2201, the inner container 2200 may be arranged spaced apart from the inside of the outer container 2250 and may be supported by the outer container 2250 in a longitudinal direction, in which the aerosol generating article 220 is inserted.

The shielding part 2260 may be arranged to surround at least a portion of the outer circumferential surface of the coupler 2230. The shielding part 2260 may be arranged to contact at least a portion of the outer circumferential surface of the coupler 2230 and thus be supported by the coupler 2230.

The shielding part 2260 may block the induced magnetic field generated inside the aerosol generator 200 from leaking to the outside of the aerosol generator 200.

The shielding part 2260 may include a wiring hole (not shown) that is open in the radial direction of the accommodation space 2205 to allow a temperature sensing wire 2320 to extend therethrough.

A scaling part 2270 may be disposed at the outer lower end of the outer container 2250 to prevent leakage of liquid. For example, the sealing part 2270 may include an clastic material such as rubber or silicone.

The sealing part 2270 may include a wiring passage (not shown) through which the one or more wires or the magnetic field generator 2310 extends. The one or more wires or magnetic field generator 2310 may extend to the outside of the sealing part 2270 through the wiring passage in the sealing part 2270.

The heater 2300 may be disposed inside the accommodation space 2205. The heater 2300 may accommodate at least a portion of the aerosol generating article 220 inserted into the housing 2100. The heater 2300 may support the outer circumferential surface of the aerosol generating article 220 accommodated in the accommodation space 2205.

The heater 2300 may generate heat as power is supplied. At least one region of the accommodated aerosol generating article 220 may be heated by the heater 2300. The aerosol generating article 220 may be heated to mix vaporized particles generated from the aerosol generating article 220 with the air in the inner space of the housing 2100 to generate an aerosol.

According to one embodiment, the aerosol generator 200 may include a magnetic field generator 2310. In this case, the heater 2300 may be a susceptor.

The magnetic field generator 2310 may be coupled to the inner container 2200. For example, the magnetic field generator 2310 may be mounted on the outside of the inner container 2200.

The magnetic field generator 2310 may heat at least one region of the aerosol generating article 220 accommodated in the accommodation space 2205 by inductive heating.

The magnetic field generator 2310 may be arranged to surround the outer circumferential surface of the susceptor 2300 and may generate an induced magnetic field toward the susceptor 2300 using the power supplied from a battery (not shown).

The susceptor 2300 may be disposed to surround at least a portion of the outer circumferential surface of the aerosol generating article 220 accommodated in the accommodation space 2205. The susceptor 2300 may generate heat due to the alternating magnetic fields generated by the magnetic field generator 2310, thereby heating the aerosol generating article accommodated in the accommodation space 2205.

As another example of the heater 2300, the aerosol generator 200 may include an electrically resistive heater. For example, it may include a film heater disposed to surround at least a portion of the outer circumferential surface of the aerosol generating article inserted into the housing 2100. The film heater may include an electrically conductive track. As a current flows through the electrically conductive track, the film heater may generate heat to heat the aerosol generating article inserted into the housing 2100.

As another example of the heater 2300, the aerosol generator 200 may include at least one of a needle-type heater, a rod-type heater, and a tubular heater capable of heating the inside of the aerosol generating article inserted into the housing 2100. For example, the heater described above may be inserted into at least one region of the aerosol generating article to heat the inside of the aerosol generating article.

The examples are not limited by a specific implementation method of the heater 2300. The heater may be modified in various forms to heat the aerosol generating article 220 to a specified temperature. In the present disclosure, the “specified temperature” may mean a temperature at which the aerosol generating material contained in the aerosol generating article 220 is heated to generate an aerosol. The specified temperature may be a temperature preset in the aerosol generator 200. Alternatively, the specified temperature may be changed by the type of the aerosol generator 200 and/or a user operation.

The temperature sensing wire 2320 is an example of a temperature sensor. The temperature sensing wire may be a thermocouple. As another example, the temperature sensing wire may be a thermally conductive wire for transferring heat, and a sensor module to generate a signal according to a change in temperature may be connected to the temperature sensing wire.

A portion of the temperature sensing wire 2320 may be connected to the heater 2300. The temperature sensing wire 2320 may sense a change in temperature of the heater 2300 while the heater 2300 is operating.

The temperature sensing wire 2320 may extend from the accommodation space 2205 to the outside of the inner container 2200 through the space between the inner container 2200 and the coupler 2230. The temperature sensing wire 2320 may extend through the space between the inner container 2200 and the outer tube 2250.

The other portion of the temperature sensing wire 2320 may pass through the outer container 2250 via the through hole in the outer container 2250 and extend to the outside of the outer container 2250.

The heater 2300 may further include a protrusion 301 that protrudes outward. A portion of the above-described temperature sensing wire 2320 may be connected to the protrusion 301 of the heater 2300.

The puff sensor 2330 may detect a change in pressure in the airflow passage in response to the user's puffing action. The puff sensor 2330 may be disposed adjacent to the first support part 2210.

The locations and shapes of the above-described components are not limited to the disclosed embodiments and may be modified in various ways.

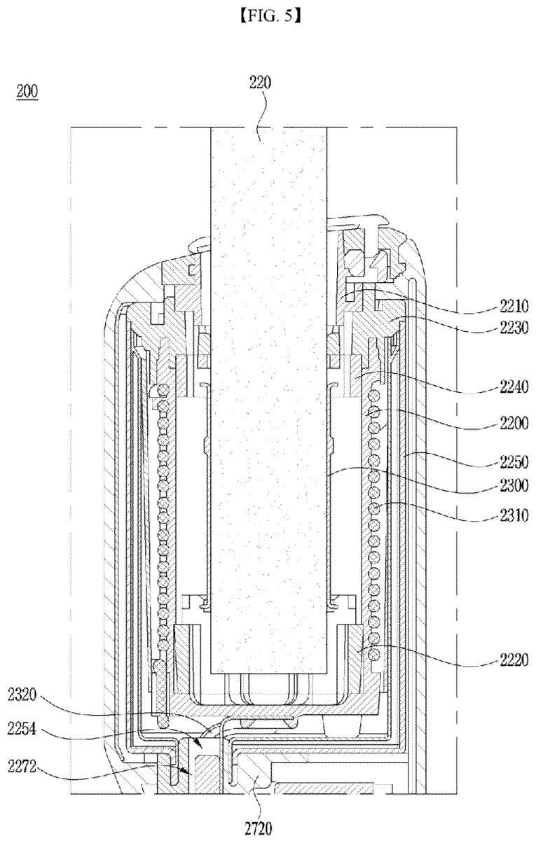

FIG. 5 is a cutaway view of one embodiment of the aerosol generation module disclosed above, taken along another direction.

The same reference numerals as in the embodiment disclosed above indicate the same components, and descriptions that overlap with the content disclosed above regarding the same components will be omitted.

In the embodiment illustrated in this figure, the through hole 2254 of the outer container 2250 and the wiring passage 2270 of the sealing part 2270 may be disposed at a distance from the central axis in the longitudinal direction of the aerosol generating article 220.

At least a portion of the sealing part 2270 may be inserted into the through hole 2254 of the outer container 2250. One or more wires or the magnetic field generator 2310 may extend through the through hole 2254 of the outer container 2250 and through the wiring passage 2272 of the sealing part 2270.

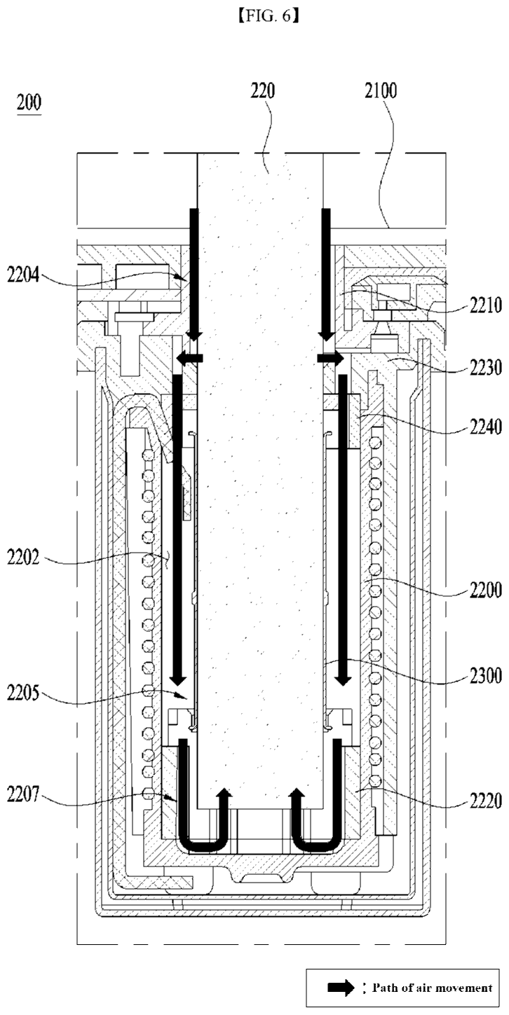

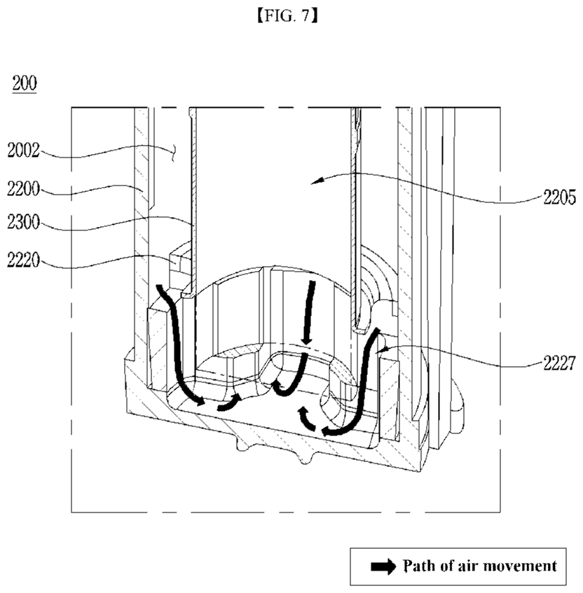

FIG. 6 is an enlarged cross-sectional view of some components in an embodiment of the aerosol generation module disclosed above.

This figure discloses the process of movement of air according to a user's puffing action in an embodiment of the aerosol generating module.

When the user performs a puffing action with his or her mouth contacting the aerosol generating article 220, a pressure difference may occur between the outside of the aerosol generating module and the inner space of the housing 2100, causing external air to flow into the housing 2100 through the first support part 2210.

The external air introduced into the housing 2100 may pass through the inflow passage 2204 of the first support part 2210. The air that has passed through the inflow passage 2204 may pass through a first air hole 2231 and a second air hole 2241 and reach the internal passage 2202 between the inner container 2200 and the heater 2300. Air moving along the internal passage 2202 described above may flow into the second support part 2220.

The air introduced into the delivery passage 2227 of the second support part 2220 may pass through the delivery passage 2227 in a U-shape according to the shape of the second support part 2220, and flow into the end of the aerosol generating article 220 inserted into the accommodation space 2205.

The air introduced into the aerosol generating article 220 may be mixed with vaporized particles generated as the aerosol generating article 220 is heated to generate an aerosol. The user may inhale the aerosol generated in the accommodation space 2205 through a puffing action of inhaling the aerosol generating article 220.

FIG. 7 is a view illustrating an example of the process of air movement in the second support part 2220 according to the embodiment disclosed above.

Once an aerosol generating article (not shown) is inserted into the aerosol generator 200 and comes into contact with the inner side surface of the second support part 2220, the delivery passage 2227 may be formed in the space between the second support part 2220 and the aerosol generating article (not shown).

Air moving along an internal passage 2002 between the inner container 2200 and the heater 2300 may flow into the delivery passage 2227 of the second support part 2220. The delivery passage 2227 may have a U-shape following the shape of the second support part 2220. Air moving along the delivery passage 2227 may reach the end of the aerosol generating article.

However, the arrangement and shape of the delivery passage 2227 are not limited to the above-described embodiment and may change in various ways.

In the disclosed examples, the aerosol generator 200 heats the aerosol generating article with a film-type heater on the outside of the aerosol generating article.

As described, the aerosol generator 200 may include a heater capable of heating the aerosol generating article using one of several methods when the aerosol generating article is inserted into the pipe-shaped inner space.

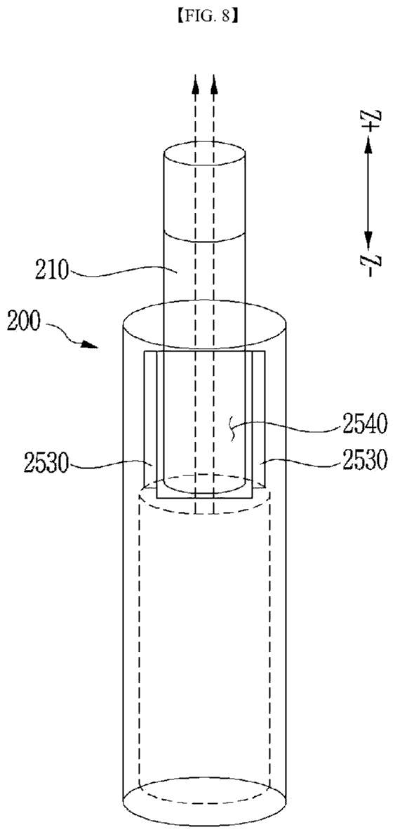

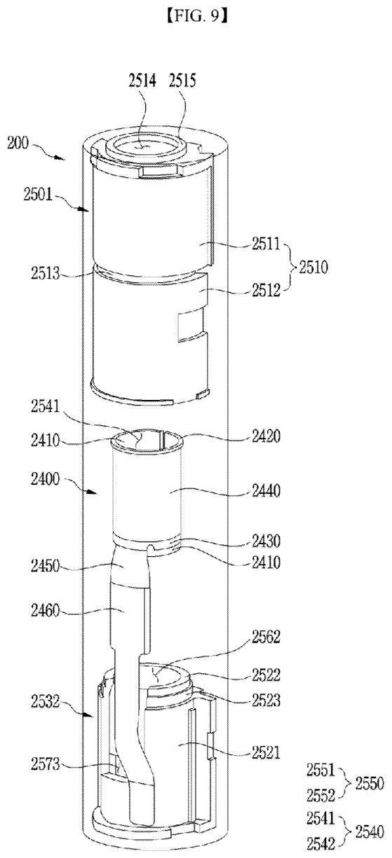

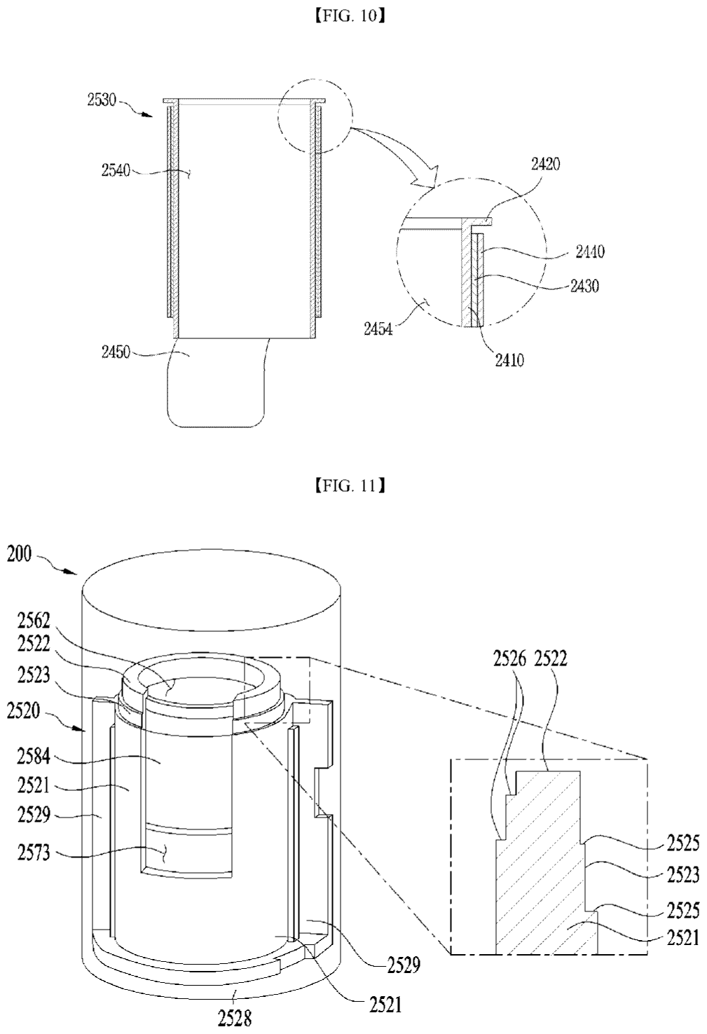

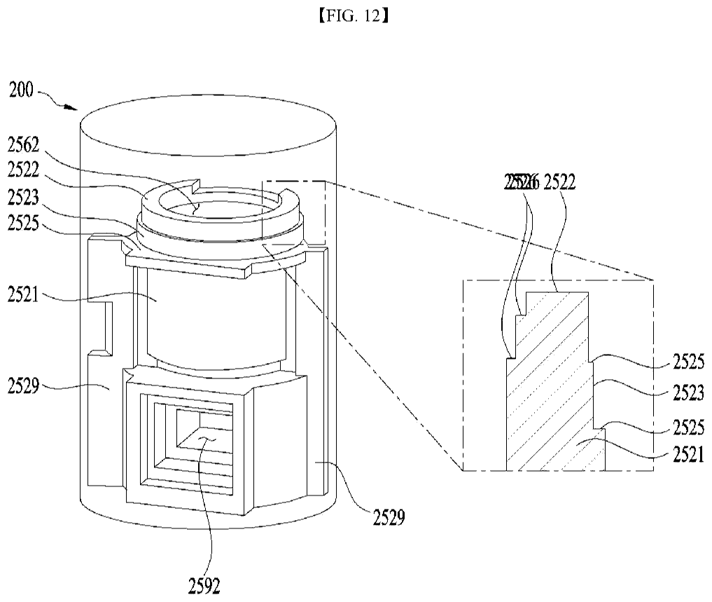

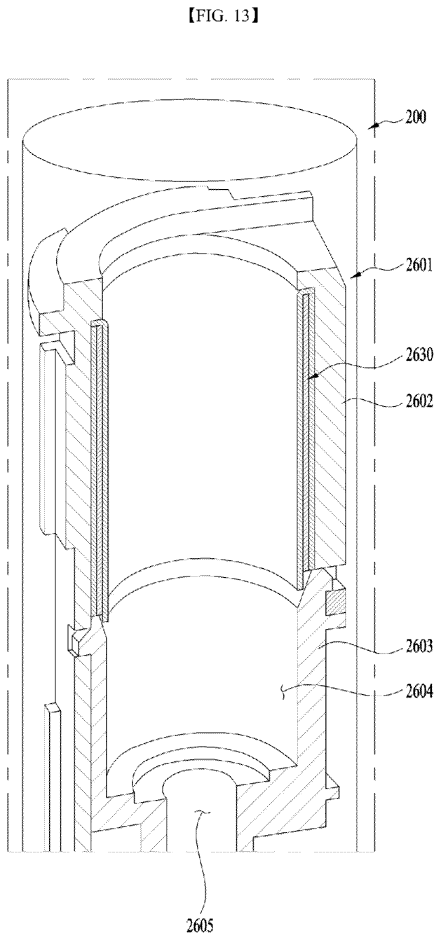

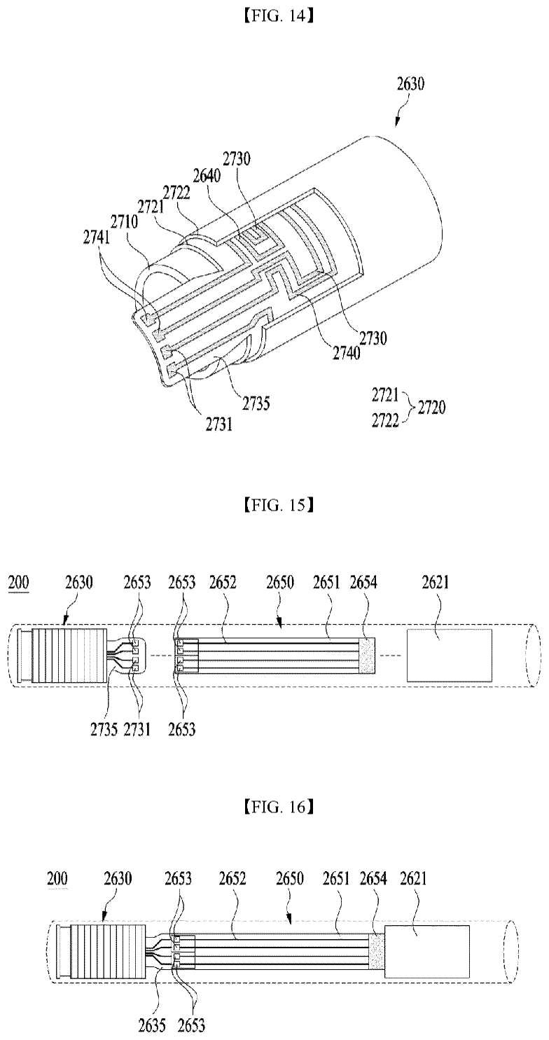

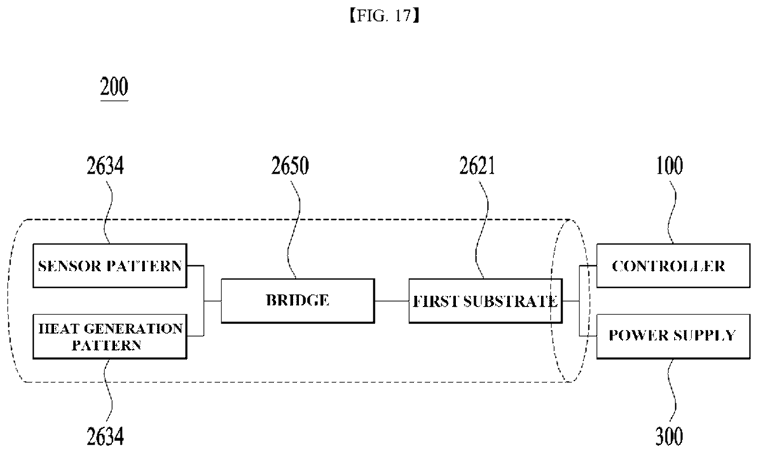

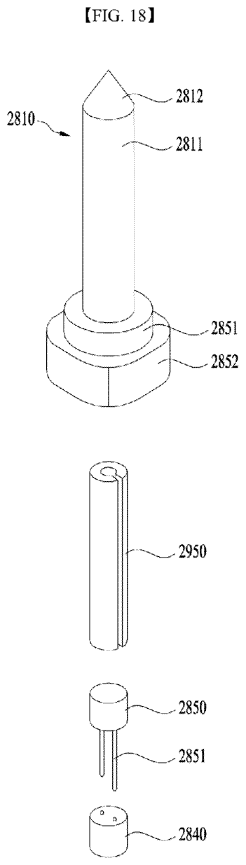

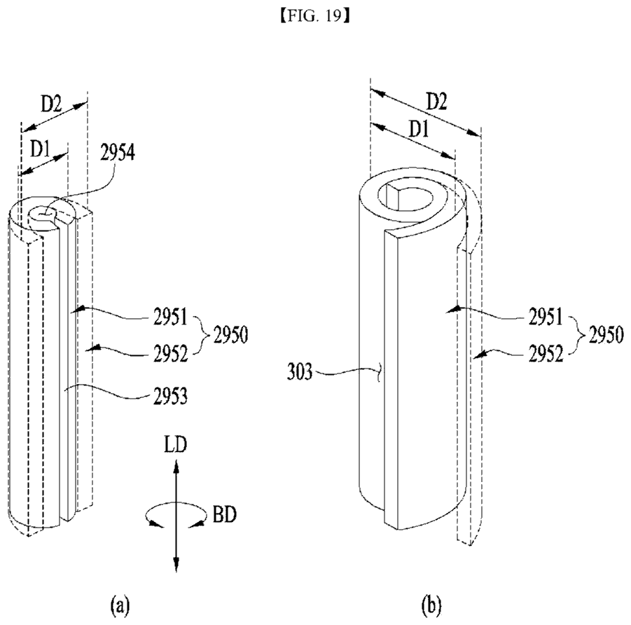

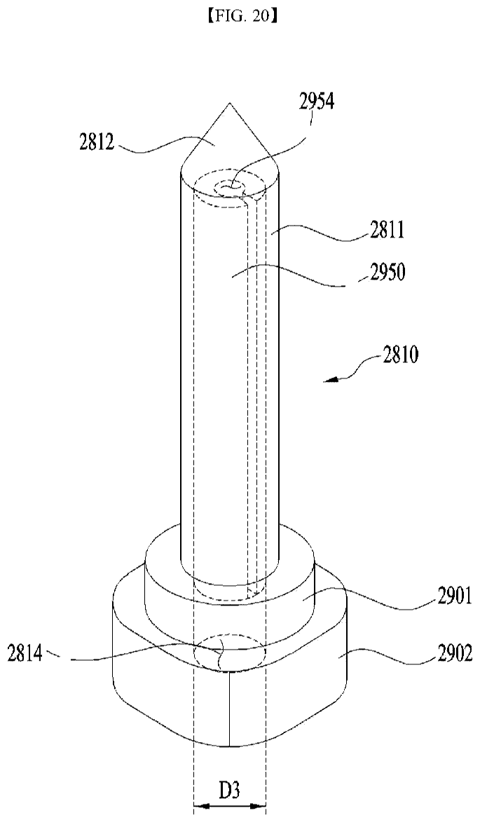

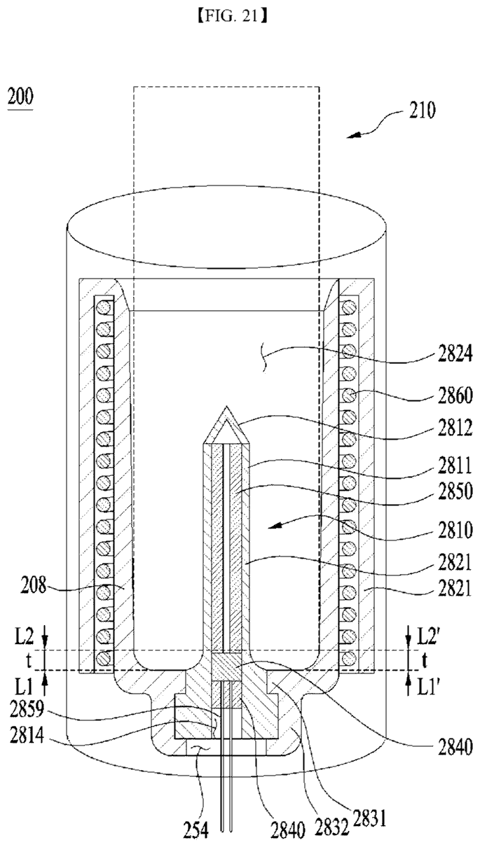

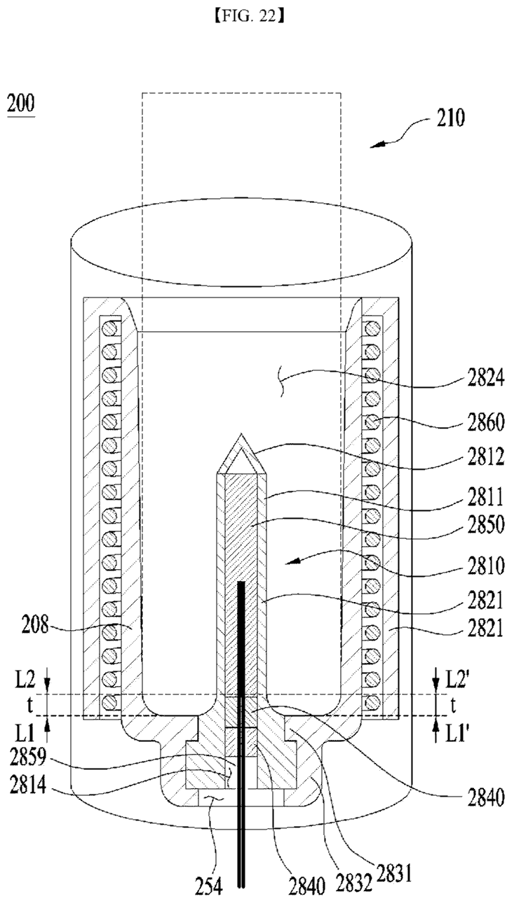

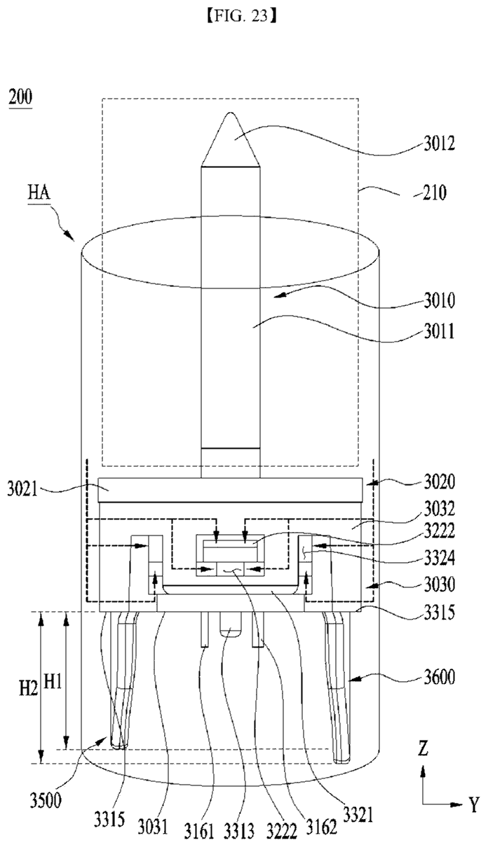

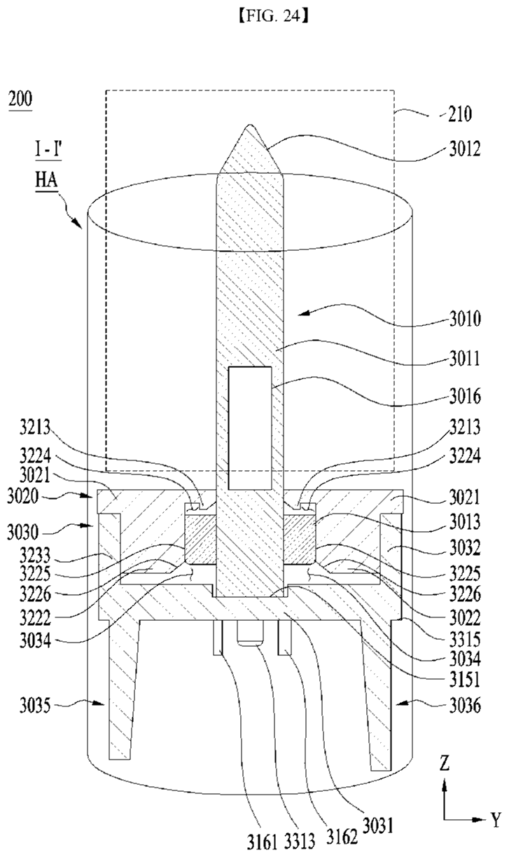

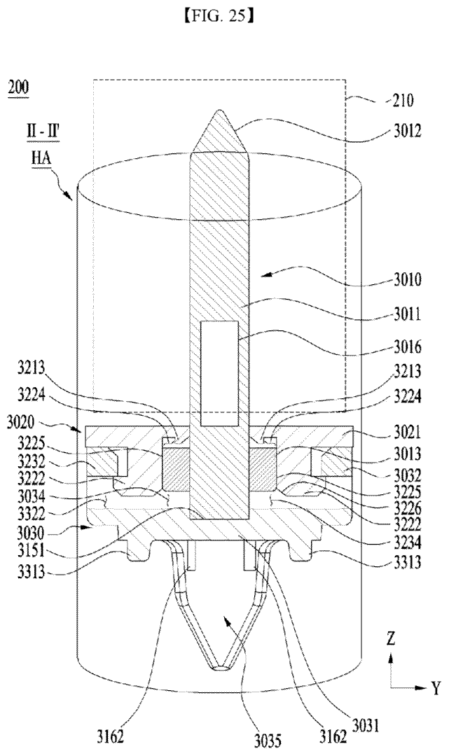

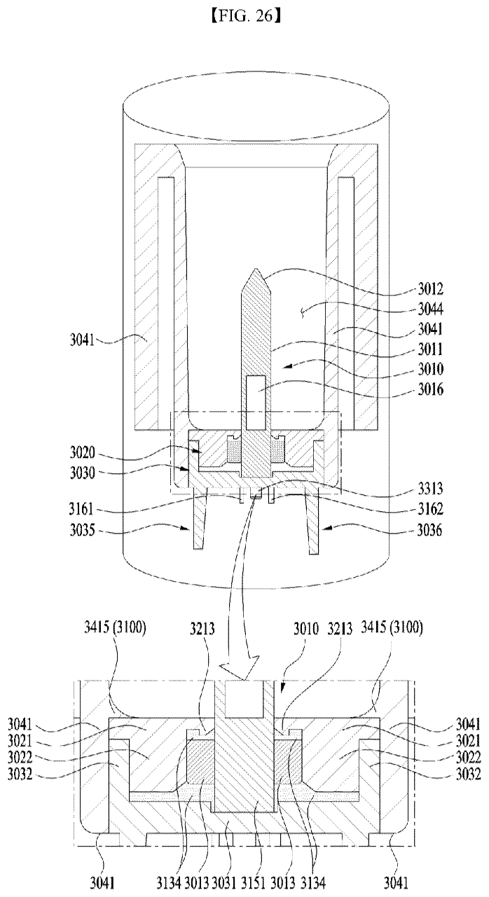

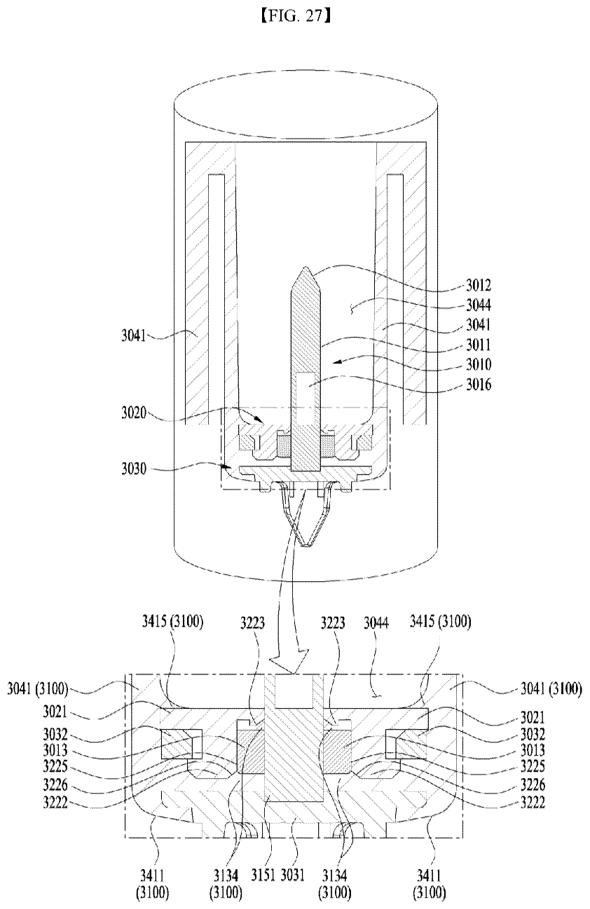

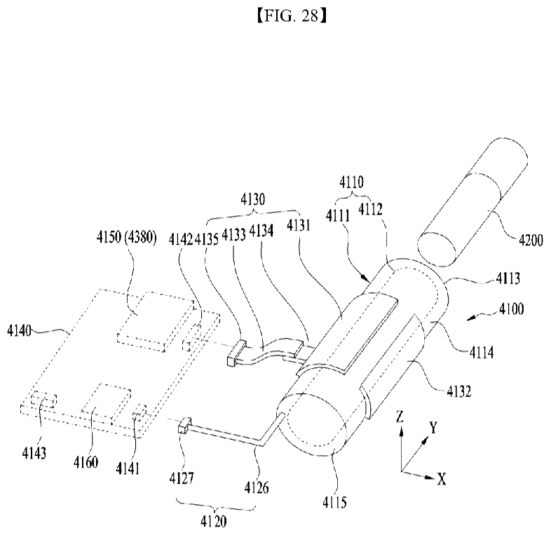

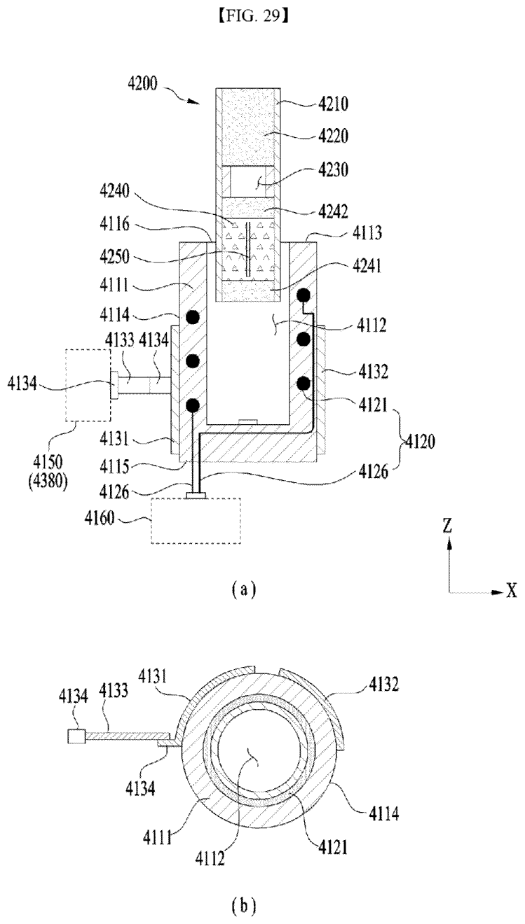

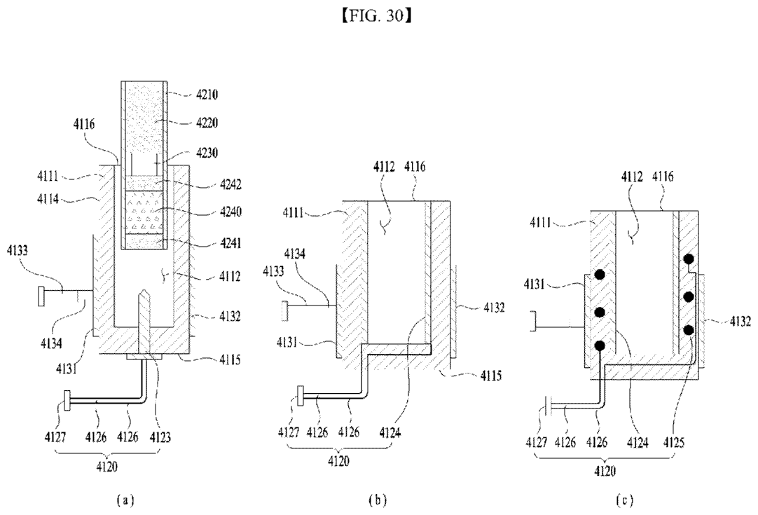

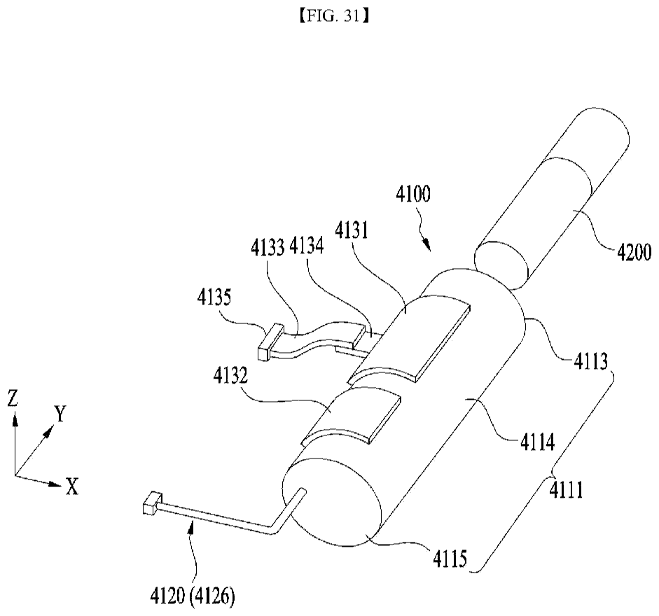

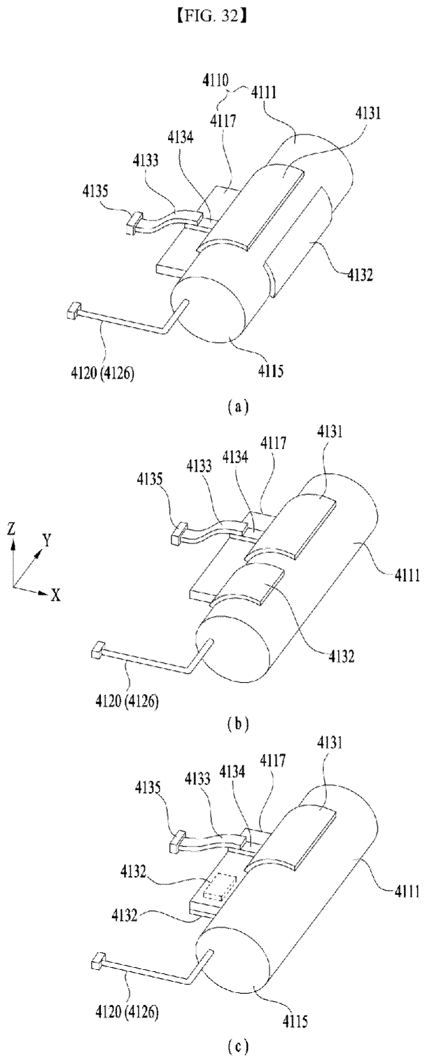

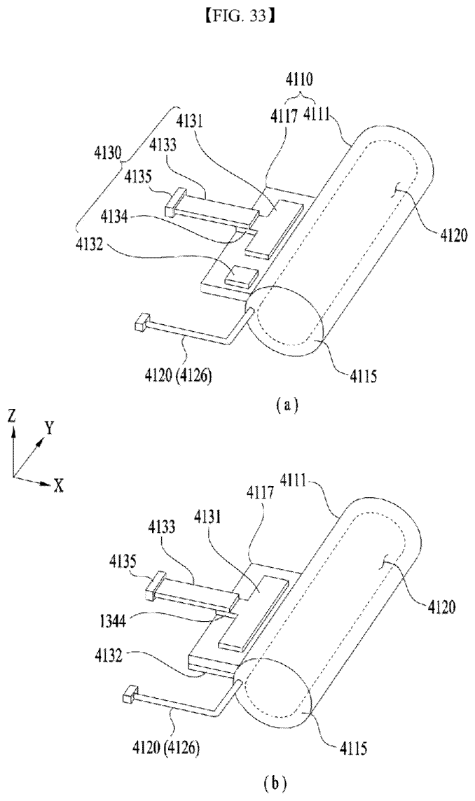

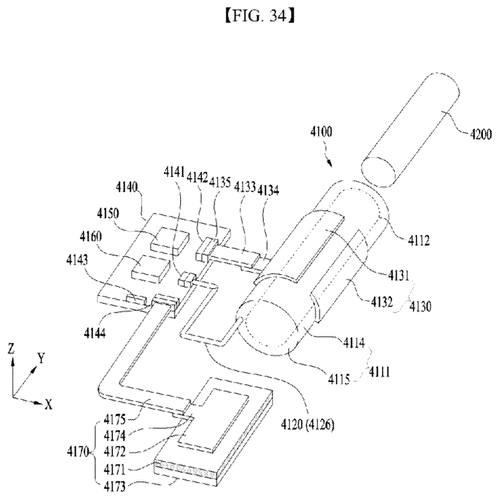

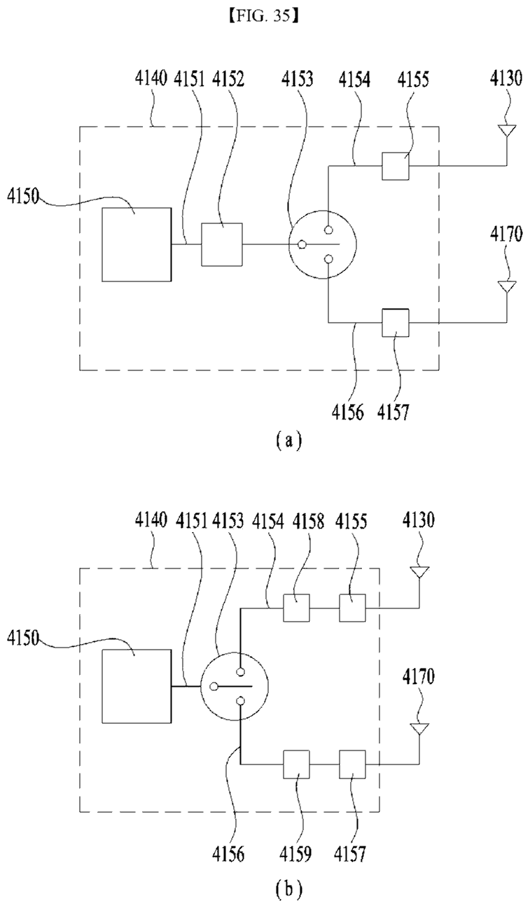

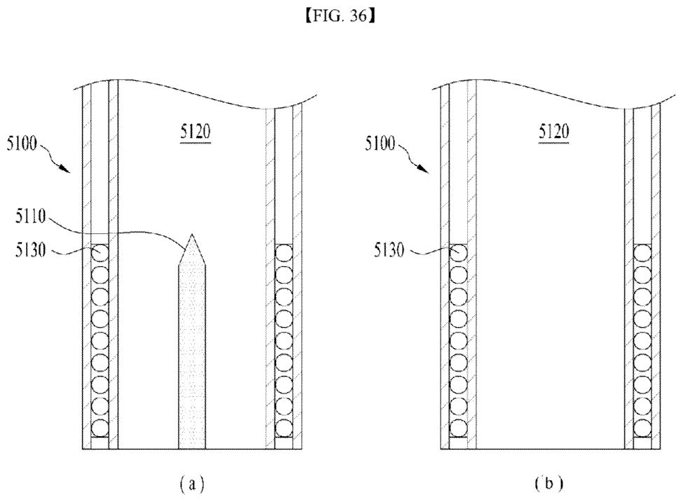

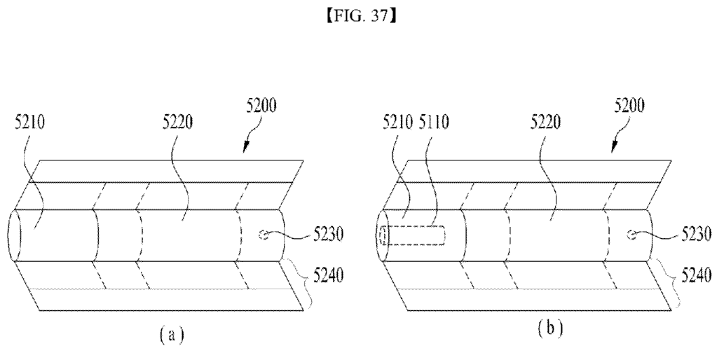

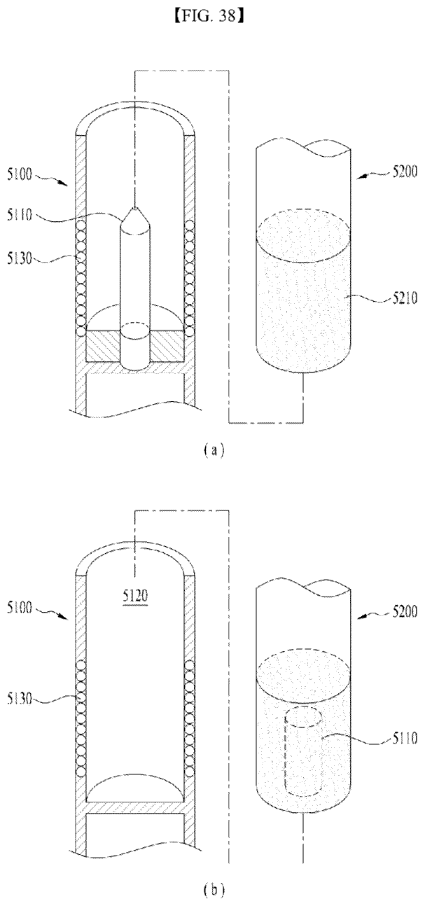

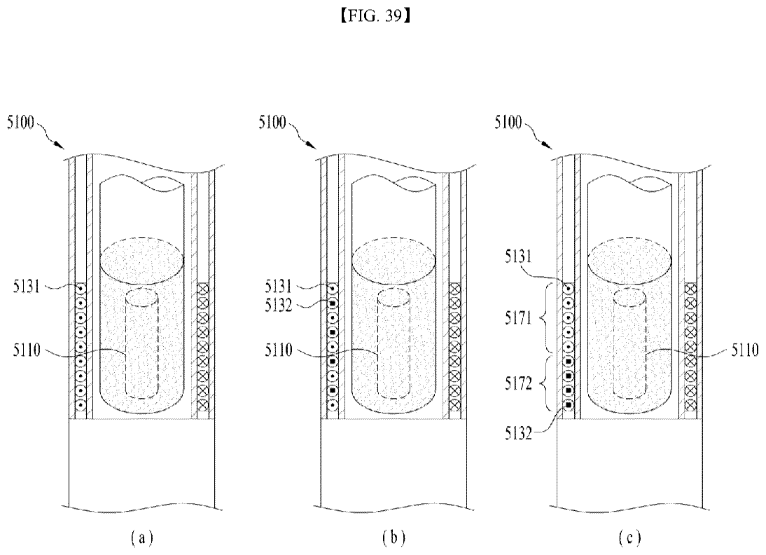

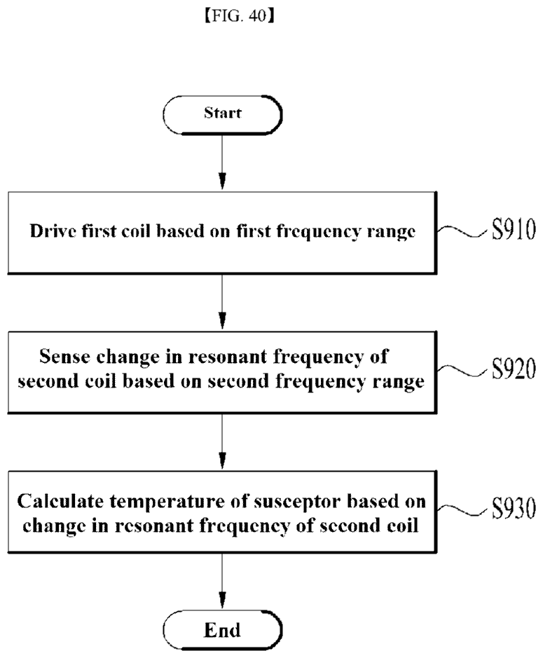

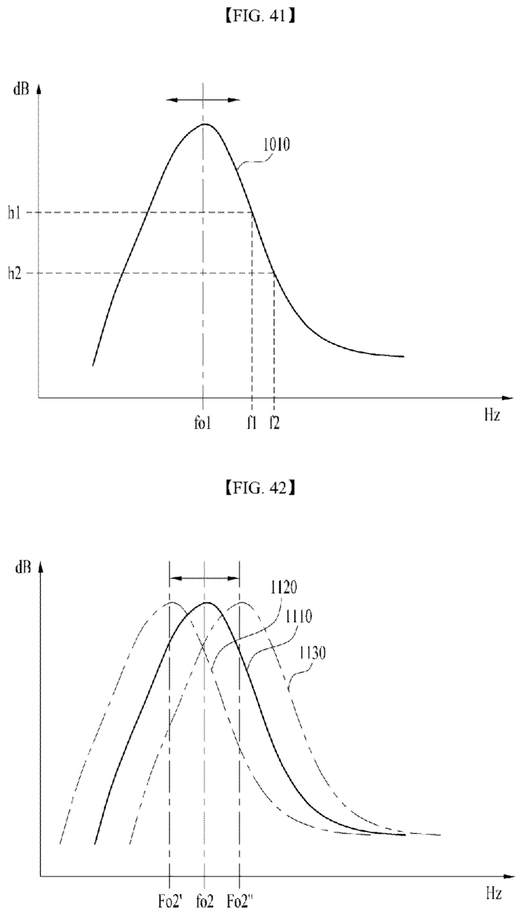

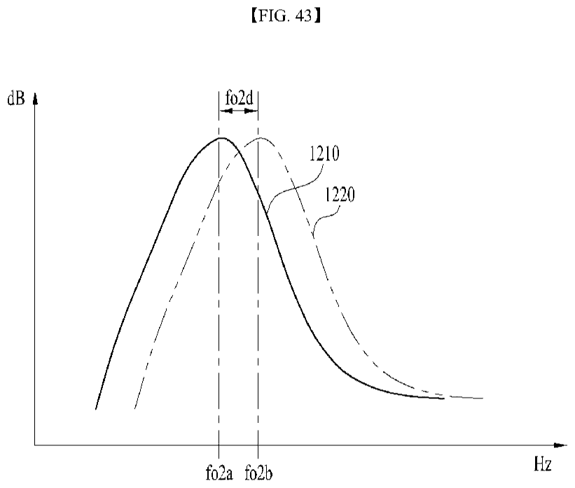

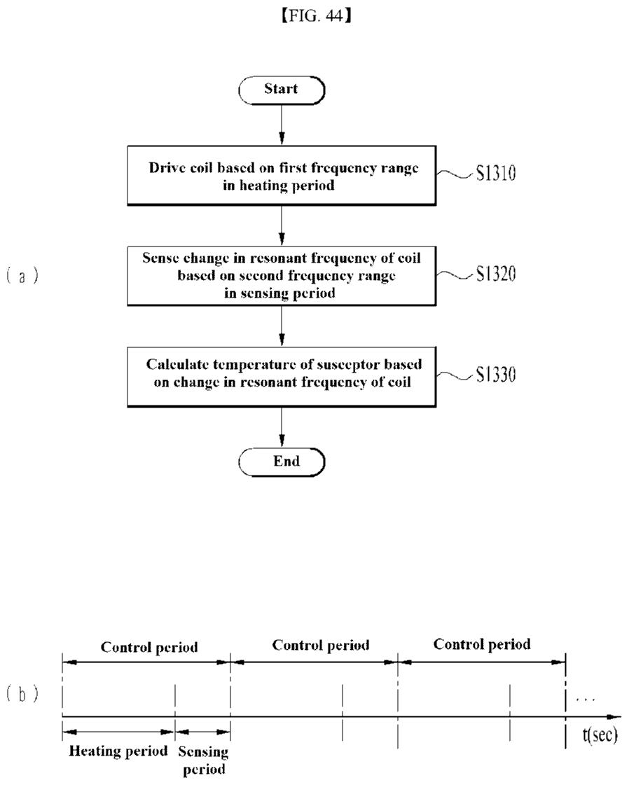

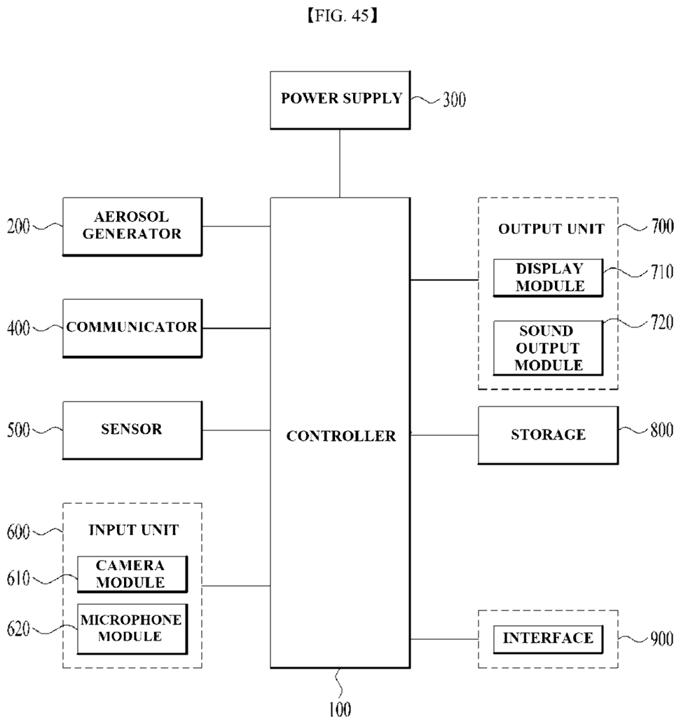

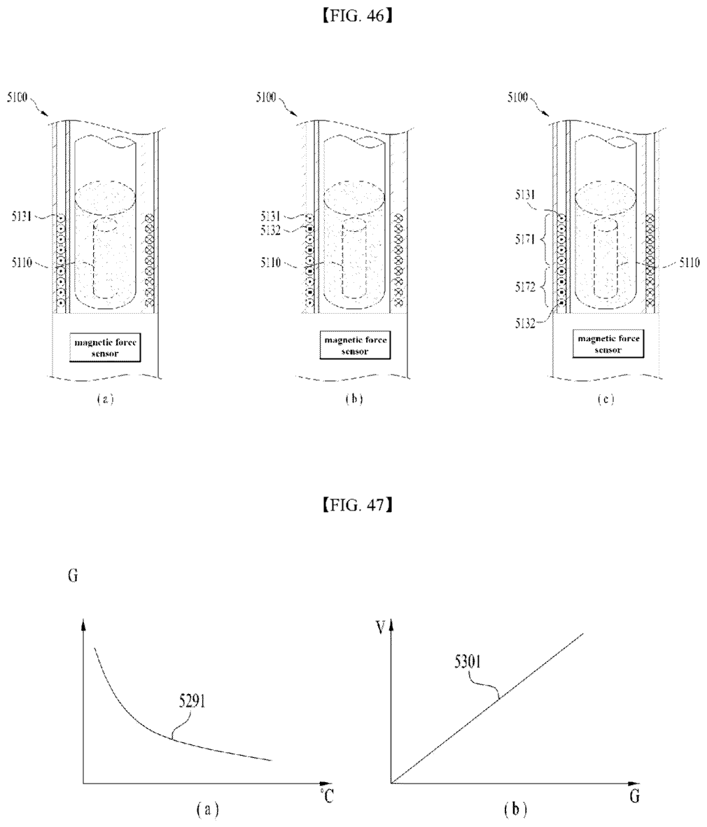

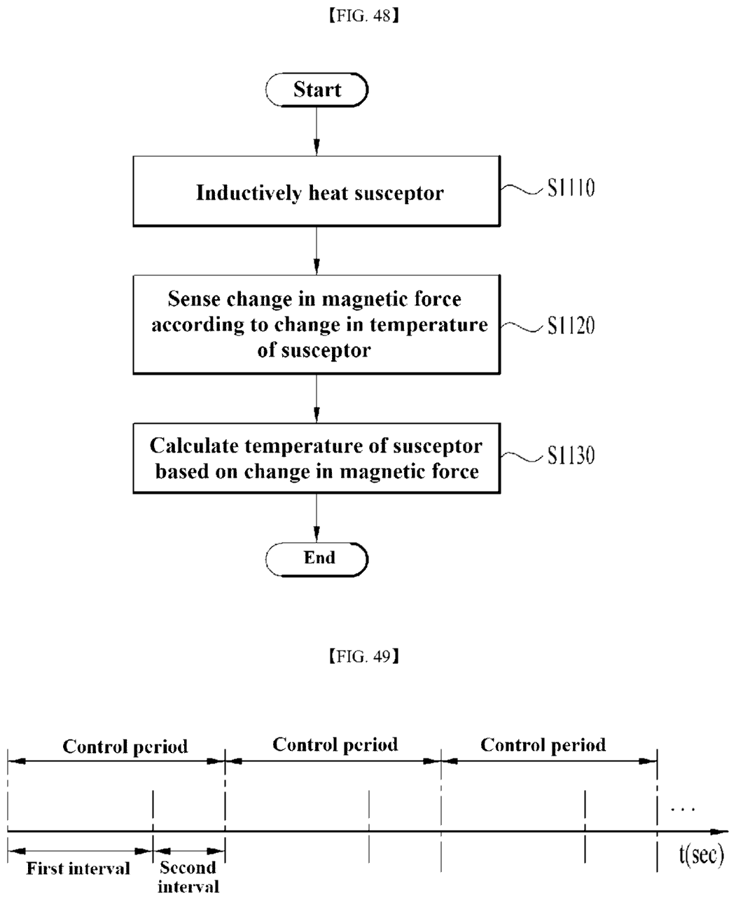

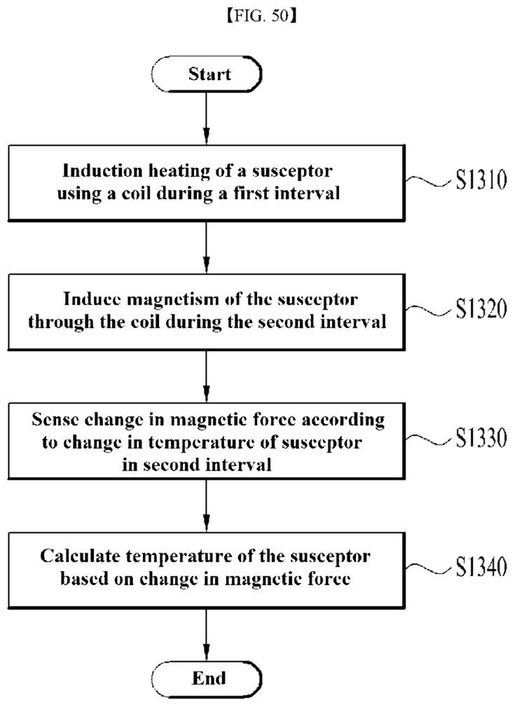

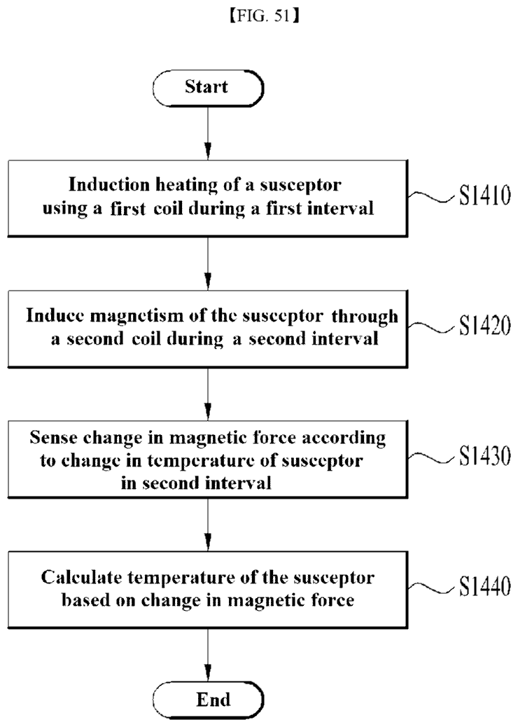

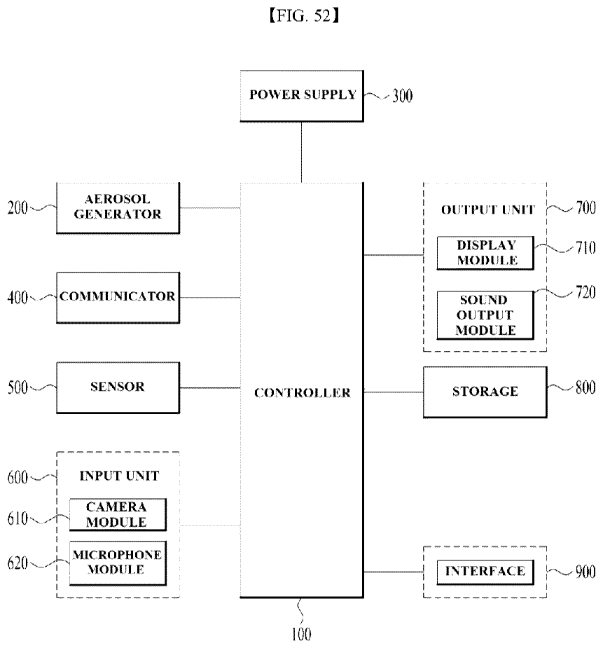

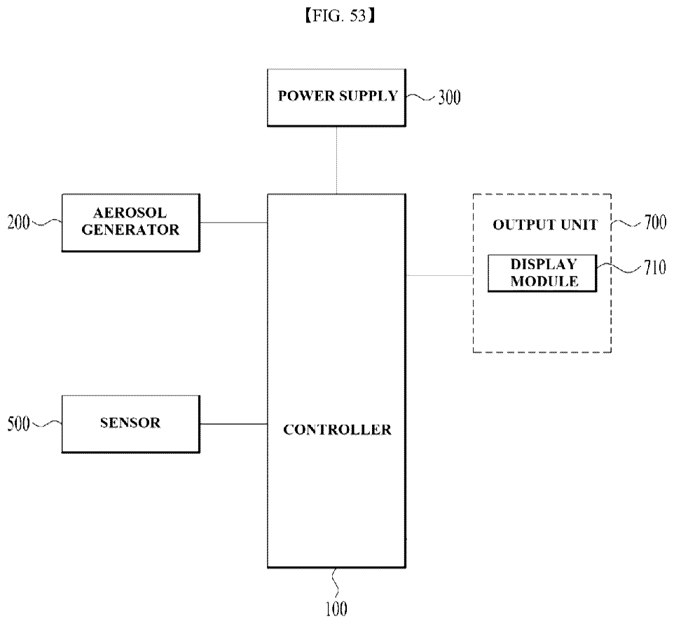

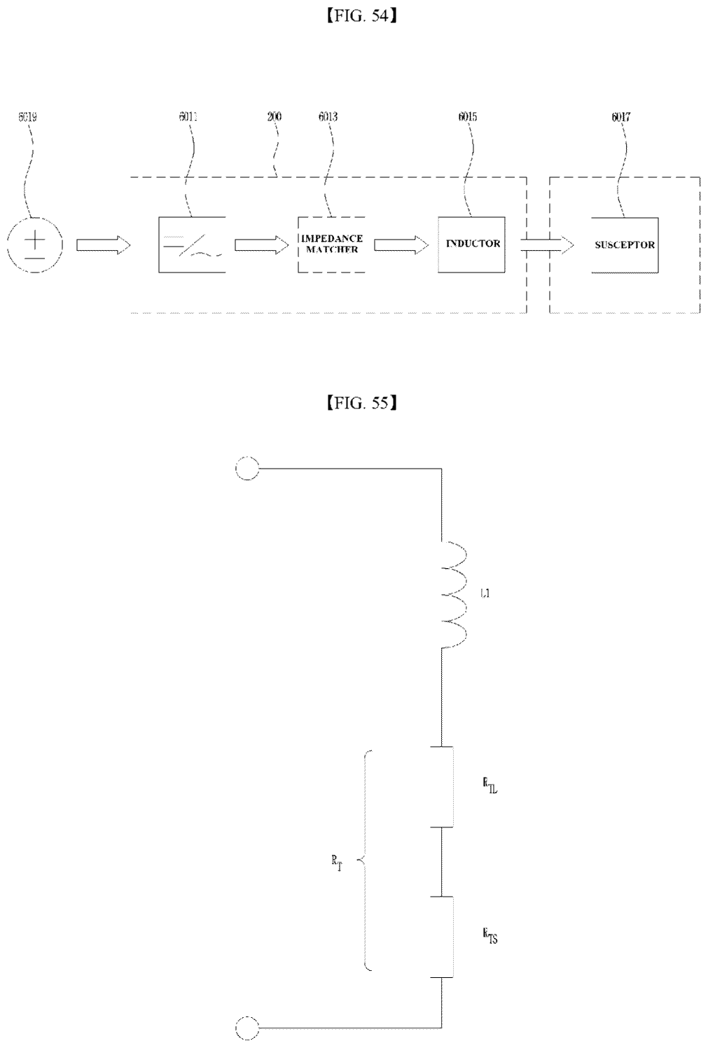

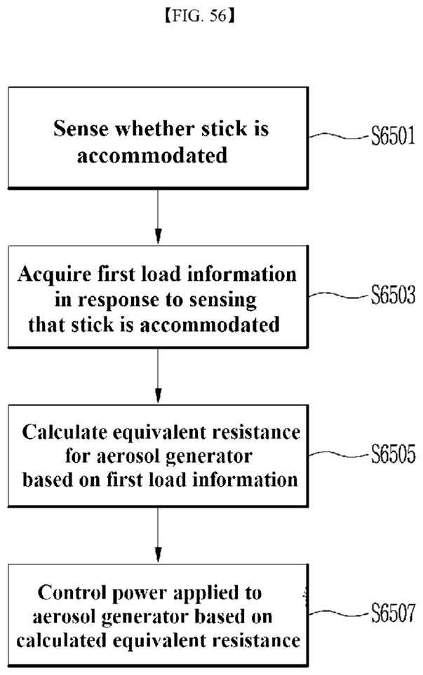

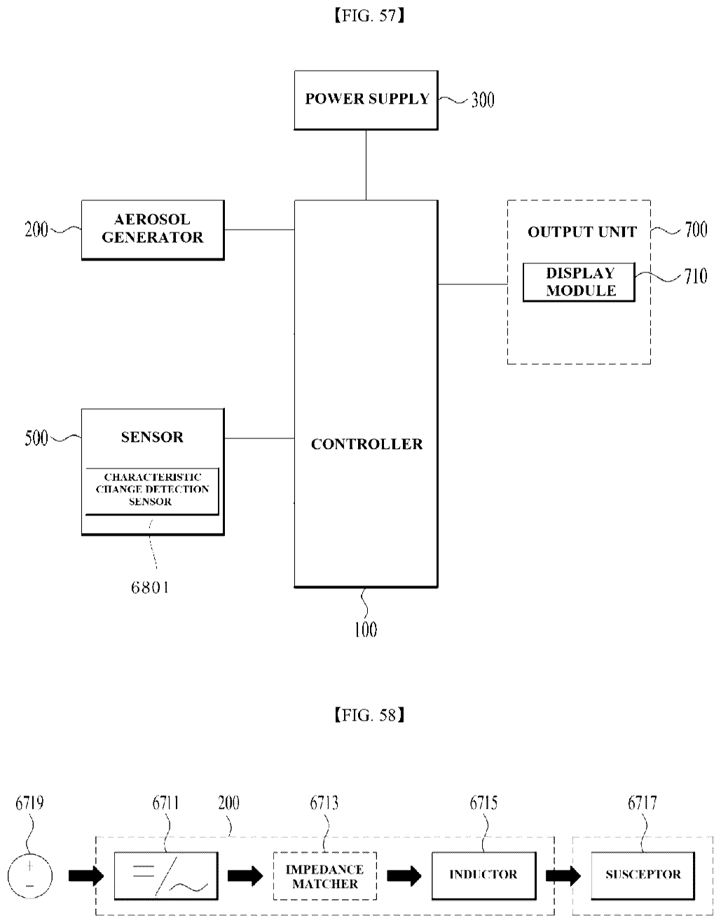

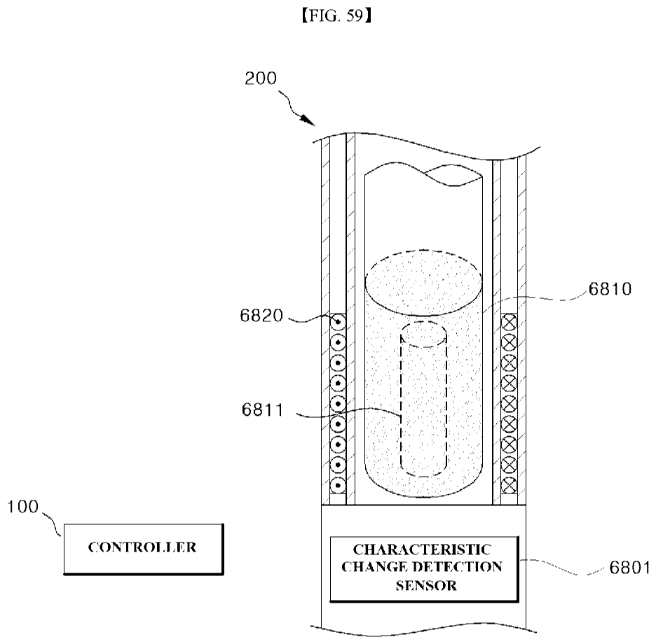

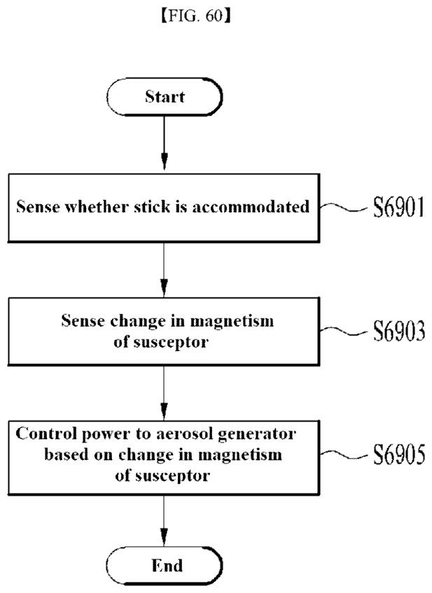

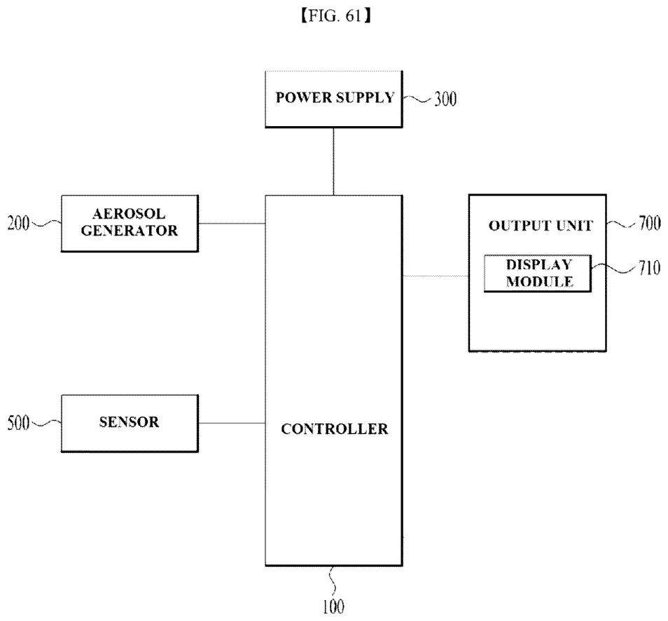

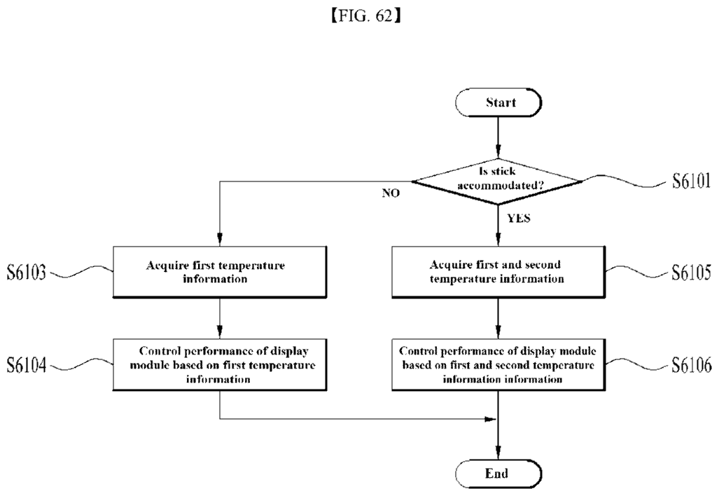

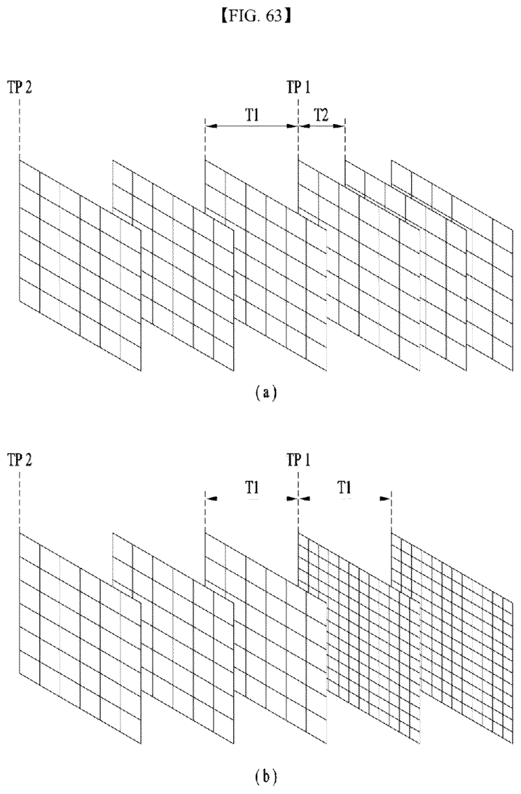

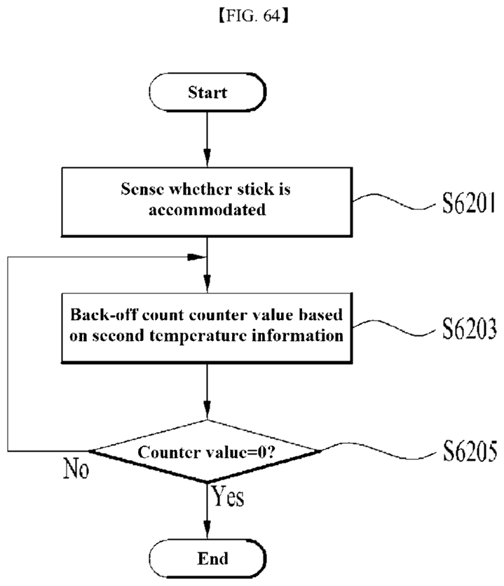

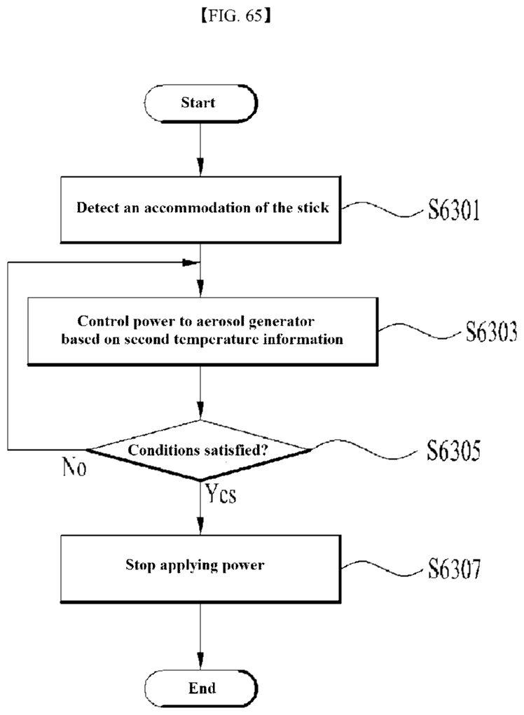

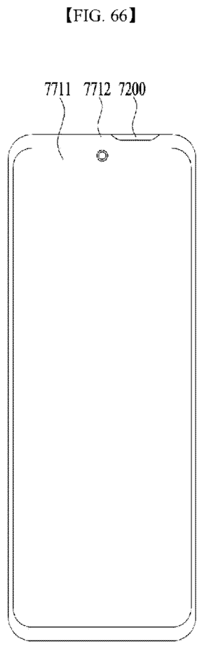

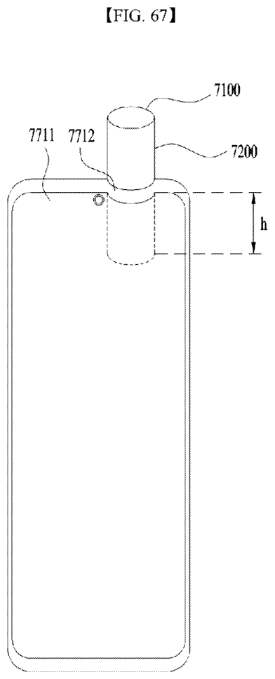

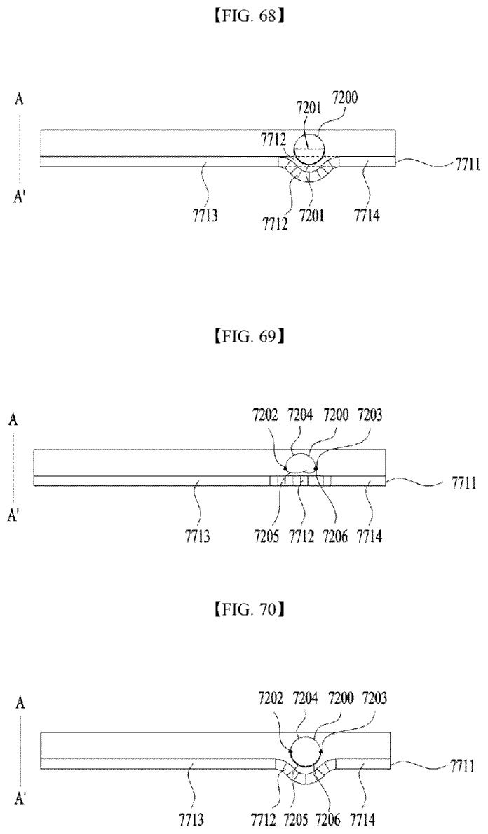

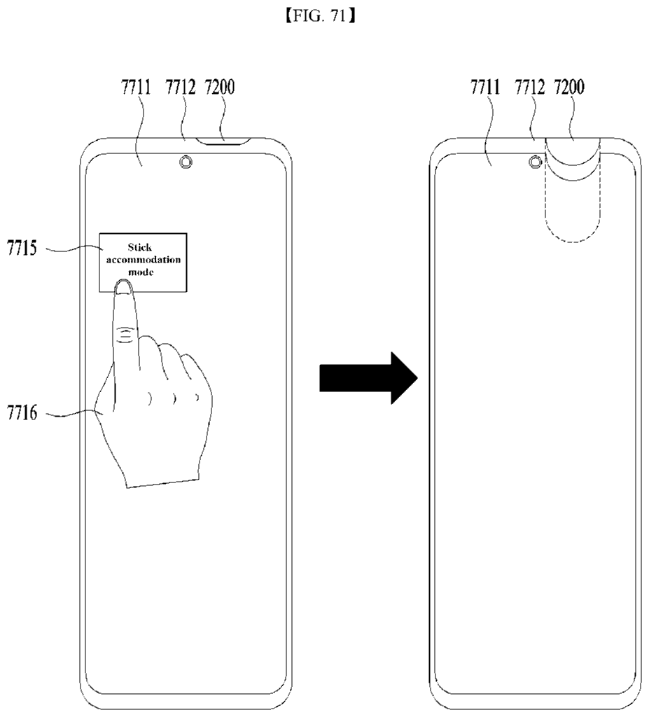

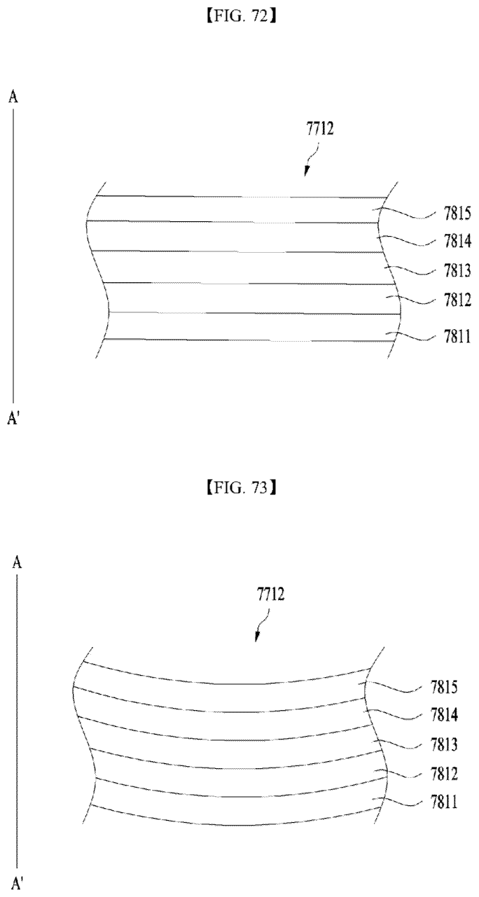

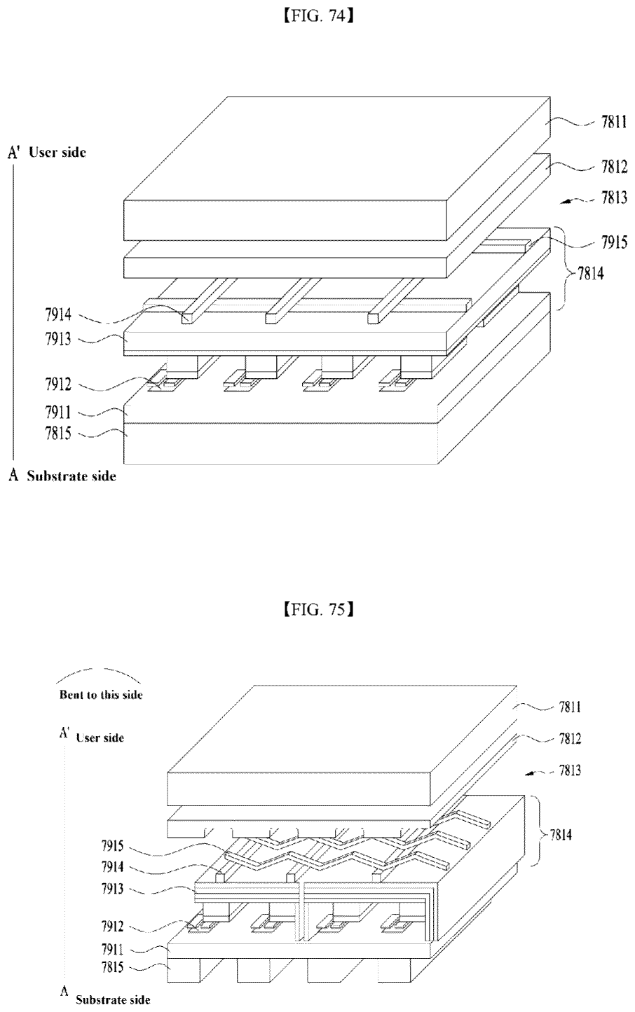

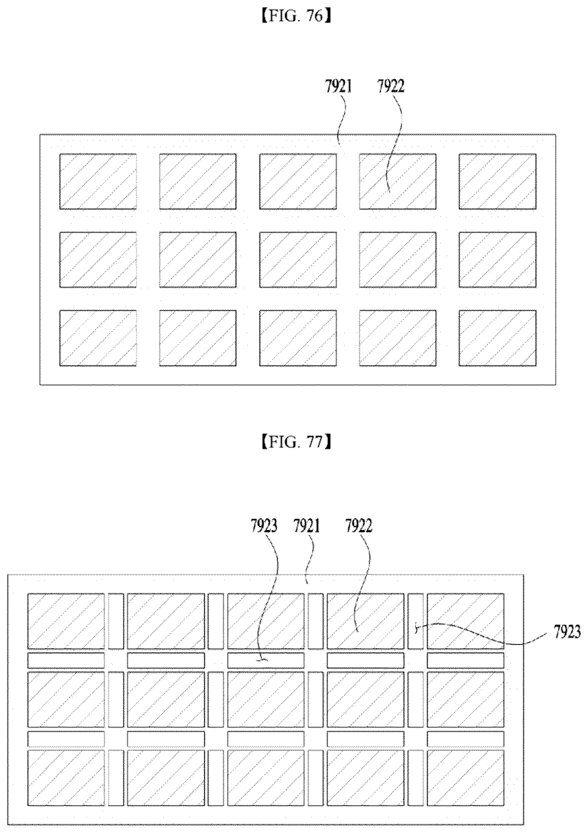

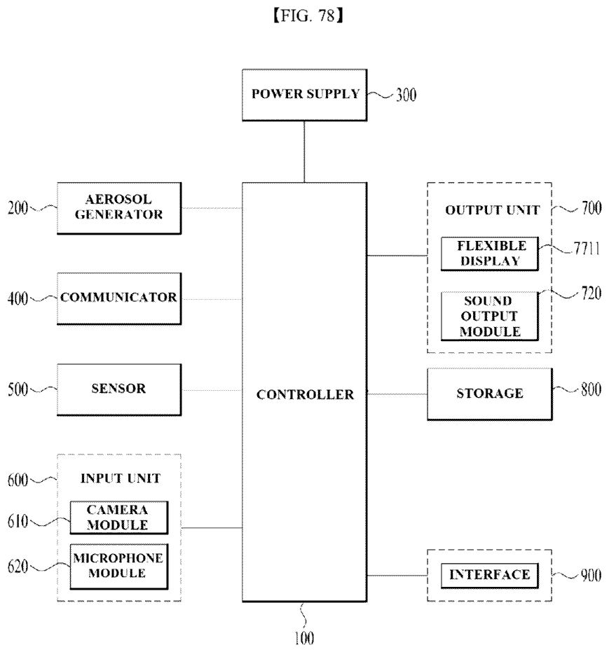

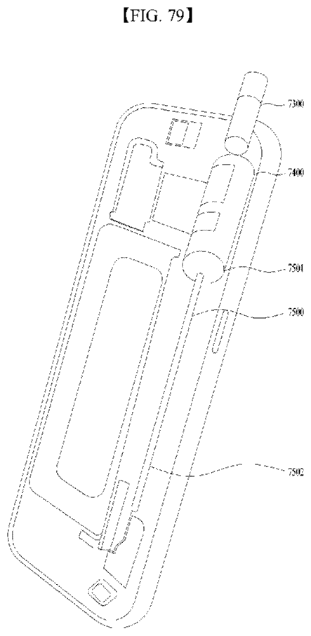

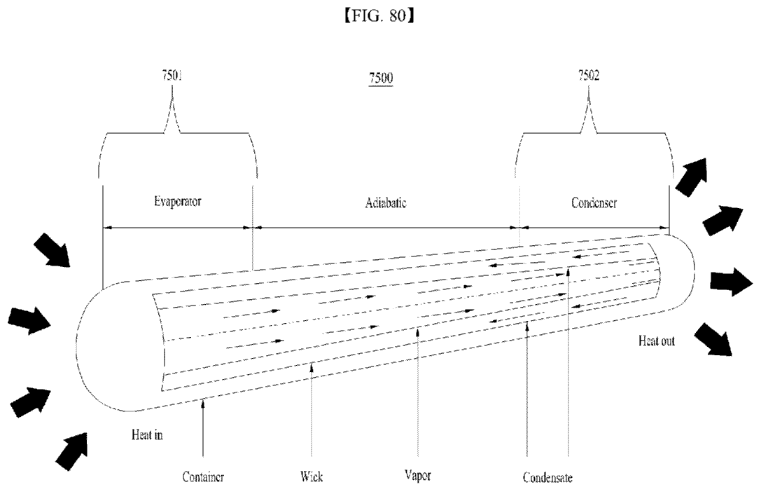

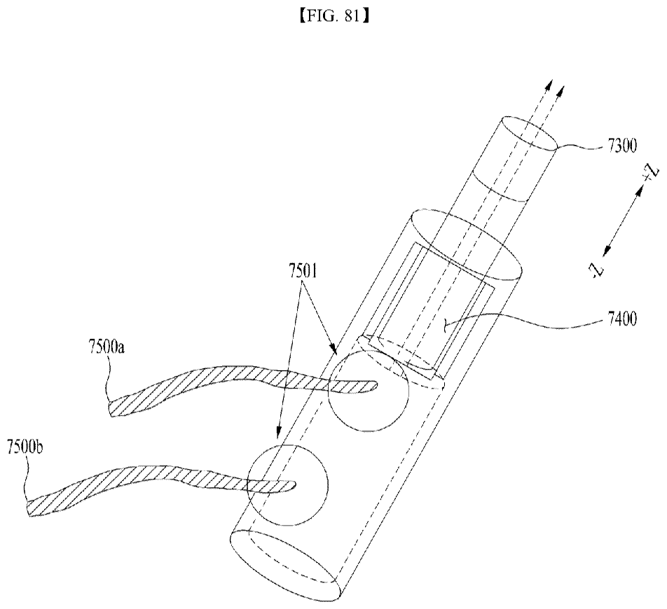

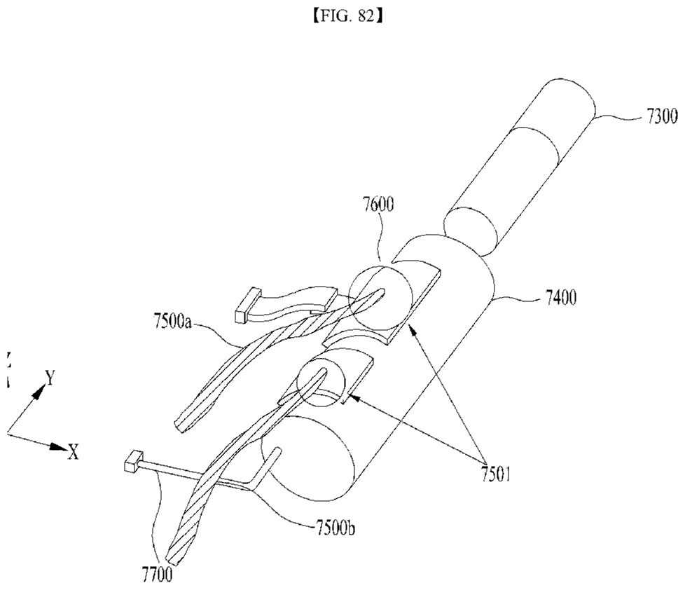

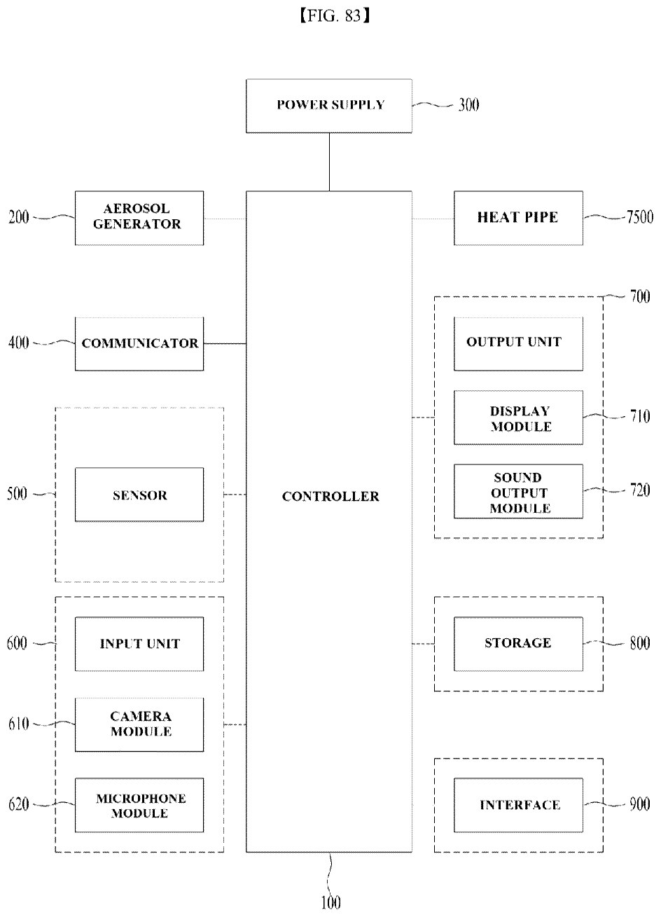

FIG. 8 discloses an example in which a stick is inserted into an aerosol generator of a mobile communication terminal according to an embodiment.

Referring to this figure, the aerosol generator 200 may include a heating assembly 2530, which is indicated by a dotted cylinder in the figure. The aerosol generator 200 may be connected to the controller 100 and power supply unit 300 of the mobile communication terminal disclosed above.

The aerosol generator 200 may provide an insertion space 2540. The insertion space 2540 may be open to the top side of the aerosol generator 200. The insertion space 2540 may have a cylindrical shape extending in a vertical direction. A stick 210 may be inserted into the insertion space 2540.

The heating assembly 2530 may be disposed around the insertion space 2540. The heating assembly 2530 may surround the insertion space 2540 and have a cylindrical shape having an open top and bottom.

The heating assembly 2530 may surround one side of the stick 210 inserted into the insertion space 2540.

The heating assembly 2530 may generate an aerosol by heating the insertion space and/or the stick 210 inserted into the insertion space 2540.

The power supply unit 300 of the mobile communication terminal may supply power to the controller 100 and the heating assembly 2530 to operate.

The controller 100 of the mobile communication terminal may control the overall operation of the aerosol generator 200. The controller 100 may control the operations of a display, a sensor, a motor, and the like that are installed on the aerosol generator 200. The controller 100 may check the status of each component of the aerosol generator 200 and determine whether the aerosol generator 200 is in an operable state.

A cartridge (not shown) may store liquid. The cartridge may generate an aerosol through the stored liquid. The aerosol generated from the cartridge may be delivered to the user by passing through the stick 210 inserted into the aerosol generator 200.

The cartridge may include a liquid chamber that stores liquid, and an atomization chamber through which an aerosol is generated and air passes. The cartridge may include a wick that is disposed inside the atomization chamber and is supplied with liquid from the liquid chamber. The cartridge 40 may include a heating coil configured to heat the wick to generate an aerosol. The air flowing into the inlet of the cartridge may carry an aerosol while passing through the liquid chamber, and may be discharged through the outlet of the cartridge.

The lower end of the stick 210 may be inserted into the insertion space 2540, and the upper end thereof may be exposed to the outside from the insertion space 2540. The user may hold the exposed upper end of the stick 210 in his or her mouth and inhale air. Air may pass through the aerosol generator 200 and be provided to the user while carrying the aerosol.

FIGS. 9 and 10 are views illustrating an example structure of an aerosol generator 200 capable of accommodating a stick according to an embodiment.

Referring to FIGS. 9 and 10, a lower pipe 2502 may be inserted into an upper pipe 2501 from the lower side of the upper pipe 2501. The heating assembly 2530 may be inserted into the upper pipe 2501. The heating assembly 2530 may be disposed between the upper end of the upper pipe 2501 and the upper end of the lower pipe 2502. The upper pipe 2501 and the lower pipe 2502 may be coupled to each other with the heating assembly 2530 disposed therebetween.

The heating assembly 2530 may have a pipe shape extending in the vertical direction. The heating assembly 2530 may have a cylindrical shape. The heating assembly 2530 may define a first insertion space 2541 therein. The first insertion space 2541 may have a cylindrical shape extending in the vertical direction. The first insertion space 2541 may be open at the top and bottom. The upper end of the first insertion space 2541 may be open to the outside.

The heating assembly 2530 may include a heating body 2410. The heating body 2410 may have a cylindrical shape extending in the vertical direction. The heating body 2410 may surround the first insertion space 2541. The heating body 2410 may be open at the top and bottom. The heating body 2410 may be formed of a material with good thermal conductivity. The heating body 2410 may support a heating element 2430.

The heating assembly 2530 may include a heating flange 2420. The heating flange 2420 may be integrated with the heating body 2410.

The heating flange 2420 may protrude radially outward from the upper end of the heating body 2410. The heating flange 2420 may extend in a circumferential direction. The heating flange 2420 may have a ring shape.

The heating assembly 2530 may include the heating element 2430. The heating element 2430 may have a cylindrical shape extending in the vertical direction. The heating element 2430 may surround the outer circumferential surface of the heating body 2410. The inner circumferential surface of the heating element 2430 may be attached in contact with the outer circumferential surface of the heating body 2410. The upper end of the heating element 2430 may be covered by the heating flange 2420. The heating element 2430 may generate heat to heat the first insertion space 2541. The heating element 2430 may be an electrically resistive heater. The heating element 2430 may be formed of conductive metal.

The heating assembly 2530 may include an insulation layer 2440. The heat insulation layer 2440 may have a cylindrical shape extending in the vertical direction. The insulation layer 2440 may surround the outer circumferential surface of the heating element 2430. The insulation layer 2440 may prevent heat generated from the heating element 2430 from dissipating to the outside rather than the first insertion space 2541.

A first connector 2450 may extend long downward from the lower end of the heating element 2430. The first connector 2450 may be integrated with the heating element 2430. The first connector 2450 may be formed of conductive metal. The first connector 2450 may be connected to a second connector 2460, and the second connector 2460 may be connected to the power supply unit 300 and/or the controller 100. The second connector 36 may transmit power to the first connector 2450. Thus, the heating element 2430 may be supplied with power.

FIGS. 11 and 12 are views illustrating some embodiments of an aerosol generating device using a film-type heater outside of an aerosol generating article.

Referring to FIGS. 11 and 12, the perimeter 2521 of the lower pipe 2502 may have a cylindrical shape extending in the vertical direction. The lower pipe 2502 may be disposed at a lower portion of the upper pipe 2501 inside the upper pipe 2501 (referring to FIGS. 9 and 10). The perimeter 2521 may be referred to as a sidewall.

The lower pipe 2502 may have a second insertion space 2562. The perimeter 2521 of the lower pipe 2502 may surround the second insertion space 2562. The second insertion space 2562 may have a cylindrical shape that is open at the top and bottom.

A light absorber 2523 may be formed on the outer circumferential surface of the upper perimeter 2521 of the lower pipe 2502. The light absorber 2523 may extend in the circumferential direction along the outer circumferential surface of the perimeter 2521. The light absorber 2523 may have a ‘C’ shape or an ‘O’ shape. The light absorber 2523 may face outward in the radial direction.

A first support rib 2525 may be formed on the upper portion of the outer circumferential surface of the perimeter 2521 of the lower pipe 2502. The first support rib 2525 may be formed around the light absorber 2523. The first support rib 2525 may protrude radially outward from the upper end and/or upper end of the light absorber 2523 to face upward. However, the location of the first support rib 2525 is not limited thereto. The first support rib 2525 may extend in the circumferential direction along the light absorber 2523. The first support rib 2525 may form a step on the perimeter 2521.

The top surface 2522 of the perimeter 2521 of the lower pipe 2502 may extend in the circumferential direction along the perimeter 2521. The top surface 2522 may face upward of the lower pipe 2502. The top surface 2522 may have a ‘C’ shape or an ‘O’ shape.

A heater support rib 2526 may be formed at the upper end of the perimeter 2521 of the lower pipe 2502. The heater support rib 2526 may be formed by recessing the upper end of the inner circumferential surface of the perimeter 2521 of the lower pipe 2502 radially outward. The heater support rib 2526 may form a step at the upper end of the inner circumferential surface of the perimeter 2521 of the lower pipe 2502. The heater support rib 2526 may be adjacent to the top surface 2522. The heater support rib 2526 may face the second insertion space 2562 in a radially inward direction.

One side of the perimeter 2521 of the lower pipe 2502 may be depressed radially inward to form a depressed groove 2584. The recessed groove 5244 may extend to the top surface 2522 of the perimeter 2521 of the lower pipe 2502. The depressed groove 2584 may be formed between the opposite ends of the ‘C’ shaped light absorber 2523. One side of the perimeter 2521 of the lower pipe 2502 may be opened to form a connecting hole 2573. The connecting hole 2573 may be disposed below the depressed groove 2584.

The first connector 2450 may be inserted into and disposed in the depressed groove 2584. The first connector 2450 and/or the second connector 2460 may be connected to each other through the connecting hole 2573.

A base 2528 may protrude radially outward from a lower end outer circumferential surface of the perimeter 2521 of the lower pipe 2502. The base 2528 may extend circumferentially along the perimeter 2521.

A support bar 2529 may extend long upward from the base 2528 along the perimeter 2521 of the lower pipe 2502. The support bar 2529 may protrude radially outward from the perimeter 2521. The support bar 2529 may be formed on opposite sides of the lower pipe 2502.

An inlet may be formed by opening a lower portion of one side of the perimeter 2521 of the lower pipe 2502. The inlet may communicate with a connection passage.

Described below is an embodiment of an aerosol generator that includes a film-type heat generation pattern heater as a heater to heat a stick containing an aerosol generating article, and a sensor pattern for temperature control.

The controller 100 may control the power supplied from the power supply unit 110 to a heater assembly 2630 based on the temperature measured using a sensor pattern disclosed below.

Here, the heater assembly 2630 performs the same heating function as the heating assembly 2530 described above. However, it is separately called the heater assembly 2630 to distinguish the heater type because it includes a heat generation pattern or sensor pattern.

The controller 100 may check the status of each component included in the aerosol generator 200 and determine whether the aerosol generator 200 is in an operable state.

The aerosol generator 200 may include a substrate on which a circuit for transmitting an electrical signal transmitted from the controller 100 is printed. The substrate may be arranged inside the body of the aerosol generator 200.

Accordingly, the heater assembly 2630 may be electrically connected via the controller 100, the power supply unit 110, and the substrate, or the controller 100 may include a substrate that performs the same function.

The substrate may connect the aerosol generator 200 and the controller 100 through a bridge. Depending on the implementation method, the bridge may be included in the aerosol generator 200, the controller 100, or the substrate connected to the controller 100.

The bridge may be arranged inside the body of the aerosol generator 200. Therefore, the bridge may electrically connect the heater assembly 2630 and the substrate.

The bridge may be disposed between the heater assembly 2630 and the substrate 121. The bridge may include an electrically conductive pattern. The bridge may be formed of a material with low thermal conductivity. The bridge may be formed of a material with lower thermal conductivity than that of the heater assembly 2630. The bridge may be formed of a material having a temperature coefficient of resistance (TCR) less than the TCR of the heater assembly 2630.

Accordingly, power may be transmitted to the heater assembly 2630 through the bridge, but the amount of heat generated from the heater assembly 2630 and transmitted to the substrate through the bridge may be reduced, and overheating, which may cause the substrate to malfunction or break down, may be prevented. Also, surrounding areas other than the heater assembly 2630 may be prevented from being heated.

FIG. 13 illustrates an aerosol generator according to another embodiment.

Referring to FIG. 13, a pipe 2601 constituting the body of the aerosol generator 200 may be hollow and have an insertion space 2604 therein. The insertion space 2604 may be open to one side and the other side of the pipe 2601.

The one side of the insertion space 2604 may be open to the outside. The stick 210 may be inserted into the pipe 2601 through the opening of the insertion space 2604. The insertion space 2604 may have a vertically elongated cylindrical shape.

In the disclosed example, the pipe 2601 constituting the body of the aerosol generator 200 includes an upper pipe and a lower pipe.

In order to distinguish a heater including a heat generation pattern or sensor pattern, the pipe 2601 constituting the body of the aerosol generator 200 is described as including a first pipe 2602 and a second pipe 2603.

The first pipe 2602 and the second pipe 2603 may be coupled or connected to each other to form the pipe 2601.

The first pipe 2602 may be disposed on top of the second pipe 2603. The inner circumferential surface of the first pipe 2602 may surround the upper portion of the insertion space 2604, and the inner circumferential surface of the second pipe 2603 may surround the lower portion of the insertion space 2604. The lower end of the second pipe portion 2603 may be open and thus be provided with an inlet 2605.

The inlet 2605 may communicate with the insertion space 2604. Air may flow into the insertion space 2604 through the inlet 2605.

The heater assembly 2630 may be disposed and fixed inside the pipe 2601.

The upper end perimeter of the heater assembly 2630 may be covered by the upper end perimeter of the pipe 2601.

The outer circumferential surface of the heater assembly 2630 may be covered by the inner circumferential surface of the pipe 2601. The heater assembly 2630 may surround at least a portion of the insertion space 2604. The inner circumferential surface of the heater assembly 2630 may define the insertion space 2604. The heater assembly 2630 may heat the insertion space 2604.

FIG. 14 is a cutaway view of a second layer 2722 in one embodiment of the aerosol generator.

An inner pipe 2710 may be formed of a thermally conductive material.

The inner pipe 2710 may be formed of a conductor or a non-conductor. It may be formed of various appropriate materials with good thermal conductivity.

The inner pipe 2710 may have appropriate strength to maintain the shape of the insertion space 2604, in which the stick 210 is accommodated, and may have an appropriate thickness to effectively transfer heat from a heat generation pattern 2730.

A first layer 2721 may cover the inside of the heat generation pattern 2730 and the sensor pattern 2740.

The first layer 2721 may have electrical insulation properties. The first layer 2721 may have heat resistance sufficient to withstand the heat generated from the heat generation pattern 2730.

The first layer 2721 may be made of paper, glass, ceramic, or coated metal.

The first layer 2721 may be made of various suitable materials and is not limited to the examples described above.

The second layer 2722 may cover the outside of the heat generation pattern 2730 and the sensor pattern 2740. The second layer 2722 may have electrical insulation properties. The second layer 2722 may have heat resistance sufficient to withstand the heat generated from the heat generation pattern 2730.

The second layer 2722 may have thermal insulation properties. The second layer 2722 may reduce loss of heat emitted to the outside from the heater assembly 2630.

The heater assembly 2630 may include the heat generation pattern 2730. The heat generation pattern 2730 may be integrally printed on the first layer 2721. The heat generation pattern 2730 may be formed between the first layer 2721 and the second layer 2722. The heat generation pattern 2730 may be implemented using an element having electrical resistance. An electrically resistive heating element may generate heat as power is supplied from the power supply unit 110 and thus current flows through the electrically resistive heating element. The heat generation pattern 2730 may be made of aluminum, tungsten, gold, platinum, silver, copper, nickel, palladium, or a combination thereof.

The heat generation pattern 2730 may include an alloy and is not limited to the above-described example. The resistance of the heat generation pattern 2730 may be set differently by the constituent material, length, width, thickness, or pattern of the electrically resistive element.

The heat generation pattern 2730 may be made of a material with a low TCR.

When the TCR is small, power loss during heating may be low and heat transfer efficiency may be high. For example, the heat generation pattern 2730 may be Constantan. Constantan may be an alloy of nickel and copper combined in a ratio of 45% and 55%. The TCR of Constantan is 0.000008, and may converge to 0.

Accordingly, the heat transfer efficiency of the heat generation pattern 2730 generating heat and transferring heat to the insertion space 2604 may be high.

The heater assembly 2630 may include the sensor pattern 2740. The sensor pattern 2740 may be integrally printed together with the heat generation pattern 2730 on the first layer 2721. The sensor pattern 2740 may be disposed between the first layer 2721 and the second layer 2722. The sensor pattern 2740 may be formed by printing a resistor having a TCR. The sensor pattern 2740 may be formed adjacent to the heat generation pattern 2730.

The sensor pattern 2740 may be formed of at least one of ceramic, semiconductor, metal, and carbon. Like the heat generation pattern 2730, the sensor pattern 2740 may be made of an electrically resistive element or an electrically conductive element.

The electrical resistance of the resistor of the sensor pattern 2740 may change depending on temperature. The change in resistance may be derived by measuring the change in voltage while a current flows through the resistor of the sensor pattern 2740. Accordingly, by measuring the change in electrical resistance of the sensor pattern 2740 according to the change in temperature, the temperature of the heater assembly 2630 may be measured. However, embodiments are not limited thereto. The change in resistance may be derived by applying a voltage to the resistor of the sensor pattern 2740 and measuring the change in current.

A first terminal 2731 may be formed at an end of the heat generation pattern 2730. The first terminal 2731 may electrically connect the heat generation pattern 2730 and the power supply unit 110. The first terminal 2731 may correspond to an electrical connection terminal that provides power supplied from the power supply unit 110 to the heat generation pattern 2730. The first terminal 2731 may be exposed to the outside from the heater assembly 2630.

A second terminal 2741 may be formed at an end of the sensor pattern 2740. The second terminal 2741 may electrically connect the sensor pattern 2740 and the power supply unit 110. The second terminal 2741 may correspond to an electrical connection terminal that provides power supplied from the power supply unit 110 to the sensor pattern 2740. The second terminal 2741 may be exposed to the outside from the heater assembly 2630.

A terminal part 2735 may extend to one side from the layer 2720. The terminal part 2735 may be exposed out of the layer 2720. The heat generation pattern 2730 may extend from the layer 2720 to the terminal part 2735 and be printed on the terminal part 2735. The first terminal 2731 may be formed at the end of the heat generation pattern 133 and disposed on the terminal part 2735. The sensor pattern 2740 may extend from the layer 2720 to the terminal part 2735 and be printed on the terminal part 2735. The second terminal 2741 may be formed at the end of the sensor pattern 2740 and disposed on the terminal part 2735.

FIGS. 15 to 17 illustrate coupling circuits and blocks of an aerosol generator.

Referring to FIGS. 15 to 17, the aerosol generator 200 may include a first substrate 2621. The first substrate 2621 may transmit electrical signals to control the operations of various components. A circuit pattern for transmitting electrical signals may be formed on the first substrate 2621. The first substrate 2621 may be electrically connected to the power supply unit 300 and the controller 100. The controller 100 may be mounted on the first substrate 2621. The first substrate 2621 may be called a main board.

The aerosol generator 200 may include a bridge 2650. The bridge 2650 may electrically connect the heater assembly 2630 and the first substrate 2621. One end of the bridge 2650 may be coupled to the terminal part 2735 of the heater assembly 2630. The opposite end of the bridge 2650 may be coupled to the first substrate 2621.

The bridge 2650 may include a second substrate 2651. The second substrate 2651 may be called a connection substrate. The second substrate 2651 may extend from the heater assembly 2630 to the first substrate 2621. The second substrate 2651 may be formed of a flexible printed circuit board (FPCB). The second substrate 2651 is flexible and may be easily installed inside the aerosol generator 200.

The bridge 2650 may include a connection pattern 2650 printed on the second substrate 2651. The connection pattern 2650 may extend from one end of the second substrate 2651 to the opposite end of the second substrate 2651. The connection pattern 2650 may be made of an electrically conductive element.

Multiple connection patterns 2650 may be formed to correspond to the first terminal 2731 and the second terminal 2741. The connection patterns 2650 may be covered with a layer having electrical and thermal insulation properties.

The bridge 2650 may include a connection terminal 2653. The connection terminal 2653 may be disposed at one end of the bridge 2650. The connection terminal 2653 may be formed at one end of each connection pattern 2650. Multiple connection terminals 2653 may be provided to correspond to the first terminal 2731 and the second terminal 2741. The connection terminals 2653 may be electrically connected to the first terminal 2731 and the second terminal 2741 of the terminal part 2735. The connection terminals 2653 may be coupled or bonded to the first terminal 2731 and the second terminal 2741. For example, the connection terminals 2653 may be bonded to the first terminal 2731 and the second terminal 2741 by soldering.

The bridge 2650 may include connector 2654. The connector 2654 may be formed at the opposite end of the connection pattern 2650. The connector 2654 may face away from the connection terminal 2653 with respect to the connection pattern 2650. The connector 2654 may be coupled to the first substrate 2621 to couple the connection pattern 2650 of the bridge 2650 and the first substrate 2621.

Accordingly, the first substrate 2621 and the heater assembly 2630 may be electrically connected to each other. The power supply unit 110 connected to the first substrate 2621 may supply power to the heater assembly 2630 through the bridge 2650.

The heater assembly 2630 may be made of a material having a TCR less than that of the bridge 2650. The heat generation pattern 2730 may be made of a material having a TCR less than that of the connection pattern 2650 of the bridge 2650.

For example, the heat generation pattern 2730 may be Constantan, whose TCR is 0.000008 and converges to 0, and the bridge 2650 may be nickel with a TCR of 0.006, or copper with a TCR of 0.00386.

The materials of the heat generation pattern 2730 and the connection pattern 2263 of the bridge 2650 are not limited to those described above. As the TCR decreases, the heat transfer efficiency may increase, and the loss of available power may be reduced. Additionally, as the TCR decreases, the temperature increase rate of the heating element provided with power may increase.

The connection pattern 2650 may have low thermal conductivity. The bridge 2650 may be made of a material with thermal conductivity lower than that of the heater assembly 2630. The connection pattern 2650 may be made of a material whose thermal conductivity is lower than that of the heat generation pattern 2730 of the heater assembly 2630. The heat generation rate of the connection pattern 2650 may be less than that of the heat generation pattern 2730.

The connection pattern 2650 may be covered with a thermally insulative layer.

Accordingly, the amount of heat that is generated from the heater assembly 2630 and conducted to the first substrate 2621 through the bridge 2650 may be reduced, and the first substrate 2621 may be prevented from being overheated and breaking down. Furthermore, other parts except the heater assembly 2630 may be prevented from becoming hot.

Hereinafter, another embodiment of the aerosol generator is disclosed.

Described below is an embodiment of an aerosol generator 200 inserted into a stick containing an aerosol generating article as an inductive heating type heater to heat the stick.

FIG. 18 is a view illustrating a portion of an embodiment of an aerosol generator inserted into a stick to implement an inductive heating method.

Referring to FIG. 18, a heater 2950 may be inserted into the hollow 2814 of a heater pin 2810. The heater 2950 may be elongated in the vertical direction. The heater 2950 may be a magnetic member and may generate heat by induced current. The heater 2950 may have a shape of a roll of thin plate.

A sensor 2850 may be inserted into the hollow 2814. The sensor 2850 may be disposed under the heater 2950. The sensor 2850 may sense the temperature of the heater 2950. A sensor lead wire 2859 may be connected to the sensor 2850. A pair sensor lead wires 2851 may be provided. The sensor lead wires 2851 may transmit power supplied from a power supply source to the sensor 2850. The sensor lead wires 2851 may transmit a control signal to the sensor 2850.

A reinforcing member 2840 may be inserted into the hollow 2814 of the heater pin 2810. The reinforcing member 2840 may be disposed under the sensor 2850. The reinforcing member 2840 may support the lower portion of the sensor 2850. The reinforcing member 2840 may be fixed in close contact with the inner circumferential surface of the heater pin 2810 in the hollow 2814. The reinforcing member 2840 may fill the hollow 2814. The sensor lead wire 2859 may be exposed to the outside of the heater pin 2810 through the reinforcing member 2840.

FIG. 19 is a view illustrating a portion of a heater in an embodiment of the aerosol generator.

Referring to FIG. 19, the heater 2950 may be vertically elongated. The heater 2950 may have a cylindrical shape. The heater 2950 may be flexible. The heater 2950 may be formed in a cylindrically rolled or bent shape of a thin plate. The bending direction BD in which the heater 2950 is bent may intersect the longitudinal direction LD of the heater 2950. For example, the bending direction BD of the heater 2950 may be orthogonal to the longitudinal direction LD of the heater 2950.

Referring to (a) of FIG. 19, the heater 2950 may be bent in the bending direction BD. One side of the heater 2950 may be cut away along the longitudinal direction LD of the heater 2950. The heater 2950 may be provided with a cut-away gap 2953 extending long in the longitudinal direction LD on one side of the cylindrical shape. The heater 2950 may have a C-shaped cross-section. The heater hole 2954 may be defined as a space formed inside the heater 2950. The heater 2950 may surround the side portion of the heater hole 2954. The heater hole 2954 may extend vertically inside the heater 2950. The heater hole 2954 may communicate with the cut-away gap 2953. The heater hole 2954 may be open at the top and bottom.

Referring to (b) of FIG. 19, as another example, the heater 2950 may have a cylindrical shape rolled in the circumferential direction. The heater 2950 may have a spiral-shaped cross-section. Even in this case, the heater hole 2954 may be formed inside the heater 2950. Even in this case, a cut-away gap 2953 extending long in the longitudinal direction LD may be formed on one side.

The curvature of the heater 2950 in a second position 2952 may be smaller than the curvature of the heater 2950 in a first position 2951. The heater 2950 in the second position 2952 may have a larger radius of curvature than the heater in the first position 2951. The heater hole 2954 and the cut-away gap 2953 of the heater 2950 in the second position 2952 may larger than those of the heater in the first position 2951.

The heater 2950 may be formed of an elastic material. When the heater 2950 is rolled up and in the first position 2951, it may be subjected to elastic force that tends to unfold the heater outward to restore the second position 2952. The heater 2950 may have restoring force or clastic force in a direction in which the curvature decreases. The heater 2950 may have restoring force or elastic force to increase the radius of curvature or radius of the heater 2950. The heater 2950 may have restoring force or elastic force to increase the size of the heater hole 2954 and the cut-away gap 2953.

FIG. 20 is a view illustrating a heater in an embodiment of the aerosol generator.

Referring to FIG. 20, the heater 2950 in the first position 2951 may be inserted into the hollow 2814 of the heater pin 2810. The diameter D1 of the outer circumferential surface of the heater 2950 in the first position 2951 may be smaller than the diameter D3 of the hollow 2814. The diameter D2 of the outer circumferential surface of the heater 2950 in the second position 2952 may be larger than the diameter D3 of the hollow 2814.

In the hollow 2814, the heater 2950 may have elastic or restoring force applied from the first position 2951 toward the second position 2952. In the hollow 2814, the diameter D1 of the outer circumferential surface of the heater 2950 may be equal to the diameter D2 of the hollow 2814. In the hollow 2814, the curvature of the outer circumferential surface of the heater 2950 may be equal to the curvature of the hollow 2814. In the hollow 2814, the heater 2950 may push the inner circumferential surface of the heater pin 2810 by elastic force and apply pressure to the inner circumferential surface of the heater pin 2810.

Accordingly, the outer circumferential surface of the heater 2950 may be fixed in close contact with the inner circumferential surface of the heater pin 2810 in the hollow 2814. Additionally, bonding work to secure the heater 2950 to the inside of the heater pin 2810 may be unnecessary, and a lead wire for the heater 2950 may not be required. Accordingly, the manufacturing process may be simplified. Also, issues such as twisting or breaking of the lead wire may be avoided.

The heater 2950 disclosed in this figure may be inserted into the heater pin 2810. When the heater 2950 is inserted into the heater pin 2810, the heater 2950 may be bent to the first position 2951. In this case, the heater 2950 in the first position 2951 may be inserted into the hollow 2814 of the heater pin 2810 through the opening. The heater 2950 may be inserted into the hollow 2814 by with the heater bent to the first position 2951. When the heater 2950 is into the heater pin 2810, the heater 2950 may come into close contact with the inner circumferential surface of the heater pin 2810 by pressure in the hollow 2814 and be fixed in the heater pin 2810. When the heater 2850 is inserted into the heater pin 2810, the heater 2950 may be disposed at a higher position than a cover part 2851.

FIG. 21 is a view illustrating a heater including an induction coil as an embodiment of the aerosol generator.

Referring to FIG. 21, the passage of the pipe 208 may be formed in a cylindrical shape. The passage of the pipe 208 may surround the sides around the pin body 2811 and the pin tip 2812.

The induction coil 2860 may be wound around the outer circumferential surface of the pipe 2821 in multiple turns to surround the outer circumferential surface. The induction coil 2860 may surround the heater 2950. The heater 2950 may generate heat by the induction coil 2860 in an inductive heating manner.

The hollow 2814 may communicate with a cover hole 254. The heater 2950 may extend vertically. The heater 30 may be inserted into the hollow 2814 through the cover hole 254 and fixed in the hollow 2814. The heater 2950 may be brought into close contact with the inner circumferential surface of the pin body 2811 in the hollow 2814. The heater 2950 may be disposed above the bottom of the insertion space 2824. The heater 2950 may be disposed above a first cover part 2831. The heater 2950 may be disposed above a first flange 2901. The first line L1-L1′ may be defined as an imaginary line in the same plane as the bottom of the insertion space 2824 or the top surface of the first cover part 2831. The second line L2-L2′ is in the same plane as the bottom of the heater 2950 and may be defined as an imaginary line parallel to the first line L1-L1′. The second line L2-L2′ may be spaced upward by a predetermined distance d from the first line L1-L1′. The predetermined distance d may be greater than or equal to 0 mm.

Accordingly, the influence of heat generated from the heater 2950 on the first cover part 2831 may be reduced. In addition, the first cover part 2831 may be prevented from being thermally deformed to form a gap occurring or widening the gap between the first cover part 2831 and the heater pin 2810, and foreign substances such as liquid may be prevented from leaking through the gap.

FIG. 22 is a view illustrating a heater including an induction coil as an embodiment of an aerosol generator.

Referring to FIG. 22, the sensor 2850 may be inserted into the heater hole 2954. The sensor 2850 may have a shape corresponding to the heater hole 2954. The sensor 2850 may be vertically elongated. For example, the sensor 2850 may have an elongated cylindrical shape. The heater 2950 may surround the sensor 2850. The sensor 2850 may sense the temperature of the heater 2950 inside the heater 2950.

The sensor lead wires 2851 may extend from the sensor 2850 downward of the heater 2950. The sensor lead wires 2851 may extend downward of the second cover part 2932 through the reinforcing member 2840.

The reinforcing member 2840 may overlap the top surface of the first flange 2901. The reinforcing member 2840 may extend vertically. The upper end of the reinforcing member 2840 may be disposed at a higher level than the top surface of the first flange 2901. The lower end of the reinforcing member 2840 may be disposed at a lower level than the top surface of the first flange 2901. The reinforcing member 2840 may reinforce the rigidity of the pin body 2811 around the top surface of the first flange 2901, inside the top surface of the first flange 2901.

Accordingly, the influence of heat generated from the heater 2950 on the first cover part 2831 may be reduced. In addition, the first cover part 2831 may be prevented from being thermally deformed to form a gap occurring or widening the gap between the first cover part 2831 and the heater pin 2810, and foreign substances such as liquid may be prevented from leaking through the gap.

Additionally, the reinforcing member 2840 may prevent the heater pin 2810 from breaking around the first flange 2901.

An aerosol generator 200 according to one aspect of the present disclosure may include a pipe 208 arranged to provide an insertion space 2824; a cover 2931, 2932 arranged to block one side of the insertion space 2824 and form a bottom, a heater pin 2810 extending long and having one side fixed to the cover 2931, 2932 and an opposite side disposed in the insertion space 2824, the heater pin 2810 providing an elongated hollow 2814 therein, and a heater 300 inserted into the hollow 2814 and disposed higher than the cover 2931, 2932.

According to another aspect of the present disclosure, the aerosol generator may further include an induction coil 2860 arranged around the heater pin 2810 to surround the pipe 208 and to cause the heater 2850 to generate heat.

Described below is another embodiment of an aerosol generator inserted into a stick containing an aerosol generating article as an inductive heating type heater to heat the stick.

FIG. 23 is a view illustrating another embodiment of the aerosol generator 200 that is inserted into a stick to implement an inductive heating method.

This embodiment of the aerosol generator may include a heater 3010 and a heater body 3011. The heater body 3011 may extend long in the vertical direction. The heater body 3011 may have a cylindrical shape.

The heater 3010 may be provided with a heater tip 3012. The heater tip 3012 may be formed at one end of the heater 3010. The heater tip 3012 may be connected to the heater body 3011 at the upper side of the heater body 3011. The heater tip 3012 may have a shape that gradually narrows as it extends upward. The heater tip 3012 may have a sharp end. A cigarette or stick can be fitted onto the heater 3010.

The embodiment of the aerosol generator includes a cover 3020, 3030 having a chamber defined therein.

For simplicity, the structure in which the heater 3010, the first cover 3020, and the second cover 3030 are coupled may be referred to as a heater assembly HA.

The cover 3020, 3030 is provided with a heater insertion hole through which the heater 3010 passes. The cover may include a first cover 3020 arranged to surround a first space on one side of the chamber C, and a second cover 3030 coupled to the first cover 3020 and arranged to surround a second space on the opposite side of the chamber C.

The first cover 3020 includes a first plate 3021 in which the heater insertion hole is formed. The second cover 3030 may include a second plate 3031 supporting the opposite end of the heater 3010 and extend from the second plate 3031 to closely contact the inner circumferential surface of the pipe 3041.

The first plate 3021 may cover the top side of a second peripheral portion 3032. The first plate 3021 may closely contact the top side of the second peripheral portion 3032. The first plate 3021 may cover the top side of the chamber C.

The second peripheral portion 3032 may have an open inlet hole 3324 and be arranged in close contact with the inner circumferential surface of the pipe 3041. Thus, it may be connected to a sealing member (not shown) inside the chamber C through the inlet hole 3324.

The pipe 3041 may be integrally connected to the sealing member 3134 inside the chamber C through the inlet hole 3324.

The first cover 3020 may be disposed on or coupled to the second cover 3030.

A hook may be inserted into a hook hole 3222 and caught on the second peripheral portion 3032. The hook may restrict the first cover 3020 from being separated upward from the second cover 3030. The first cover 3020 may protrude to support the side of the heater 3010.

A first positioning protrusion 3035 may be spaced inward from the edge of the second plate 3031 to form a spacing portion 3315. A second positioning protrusion 3036 may be spaced inward from the edge of the second plate 3031 to form the spacing portion 3315.

When the first positioning protrusion 3035 and the second positioning protrusion 3036 are inserted into a mold, the spacing portion 3315 may secure a tolerance margin, thereby ensuring manufacturing stability.

A positioning pin 3313 may protrude downward from the bottom of the second plate 3031. Multiple positioning pins 3313 may be provided. The positioning pins 3313 may have a cylindrical shape with a rounded end.

The hook may be inserted into the hook hole 3222 to fasten the first cover 3020 to the second cover 3030.

When the first cover 3020 and the second cover 3030 are coupled, the flange (not shown) may be disposed inside the chamber C.

The first lead wire 3161 and the second lead wire 3162 may be exposed to the outside under the second plate 3031.

The heater 3010 may be electrically connected to the first lead wire 3161 to receive power.

The second plate 3031 may not cover the lower side of the inlet hole 3324. The inlet hole 3324 may be open downward. The second plate 3031 may be recessed radially inward direction of the inlet hole 3324, and may thus be spaced radially inward from the bottom of the inlet hole 3324. The lower portion of the second peripheral portion 3032 disposed between the inlet holes 3324 may be called a recess portion 3321. The recess portion 3321 may be exposed to the lower side as an edge of the second plate 3031 is recessed radially inward.

FIGS. 24 and 25 are cross-sectional views of an embodiment of the aerosol generator seen from different sides when a heater assembly is included in the aerosol generator.

Referring to FIGS. 24 and 25, the first cover 3020 may be disposed on or coupled to the upper side of the second cover 3030. The hook may be inserted into the hook hole 3222 and caught on the second peripheral portion 3032. The hook may restrict the first cover 3020 from being separated upward from the second cover 3030.

The first plate 3021 may cover the top side of a second peripheral portion 3032. The first plate 3021 may closely contact the top side of the second peripheral portion 3032. The first plate 3021 may cover the top side of the chamber C. The first plate 3021 may be caught on the top side of the second peripheral portion 3032, and the first peripheral portion 3022 may be inserted into a second space 3034. The first peripheral portion 3022 may be disposed inside the second peripheral portion 3032. The outer circumferential surface of the first peripheral portion 3022 may be surrounded by the second peripheral portion 3032. The lower portion of the first peripheral portion 3022 may be spaced apart from the top of the second plate 3031.

The heater body 3011 may pass through the insertion hole (not shown) of The first plate 3021 and be press-fitted into The first plate 3021. The flange 3013 may be disposed in the first space 3224.

The first space 3224 is disposed under The first plate 3021, and The first plate 3021 may cover the top side of the first space 3224. The inner circumferential surface 223 of the first peripheral portion 3022 may surround the side portion of the first space 3224. The first space 3224 may be open downward.

A support guide 3226 may be formed by beveling the lower end of a support bar 3225. The support guide 3226 may be formed at the lower end of the support bar 3225 to be inclined upward toward the first space 3224.

The first positioning protrusion 3035 may be spaced inward from the edge of the second plate 3031 to form the spacing portion 3315. The second positioning protrusion 3036 may be spaced inward from the edge of the second plate 3031 to form the spacing portion 3315.

The flange 3013 may be supported or fixed by the support bar 3225. The flange 3013 may be spaced apart from the first peripheral portion 3022 by the support bar 3225. The flange 3013 may be spaced apart from the first peripheral portion 3022 and The first plate 3021 to form a gap in the first space 3224. The flange 3013 may be spaced upward from the second plate 3031. The lower end 3151 and the fixing part 3152 of the heater 3010 may be supported or fixed by the first plate 3031.

The sensor 3016 may sense the temperature of the heater 3010. The sensor 3016 may be installed inside the heater 3010. The heater 3010 may be formed in a hollow shape, and the sensor 3016 may be inserted into the heater 3010. The sensor 3016 may be elongated in one direction and disposed along the longitudinal direction of the heater body 3011. The sensor 3016 may be electrically connected to the second lead wire 3162 to receive power. The heater 3010 may be electrically connected to the first lead wire 3161 to receive power.

Accordingly, the first cover 3020 and the second cover 3030 may be stably coupled to each other, and a chamber C may be formed therein. Additionally, within the chamber C of the cover 3020, 3030, movement of the heater 3010 may be prevented or minimized, and the heater 3010 may be disposed long toward the top. Also, the first lead wire 3161 and the second lead wire 3162 may be prevented from contacting each other, being twisted with each other, or being disconnected.

A port portion 3213 may protrude downward from a portion of The first plate 3021 around the heater insertion hole 3214. The port portion 3213 may surround the bottom of the heater insertion hole 3214. The port portion 3213 may be inclined upward toward the heater insertion hole 3214.

FIGS. 26 and 27 are cross-sectional views from different sides of an embodiment of the aerosol generator when the heater assembly is provided as one embodiment of the aerosol generator.

Referring to FIGS. 26 and 27, the pipe 3041 may have a cylindrical shape. The pipe 3041 may define an insertion space 3044 therein with openings formed on both sides. The insertion space 3044 may have a cylindrical shape. The insertion space 3044 may be vertically elongated.

The top of the insertion space 3044 may communicate with the outside. The pipe 3041 may be coupled with the heater assembly HA. The heater assembly HA may block the lower portion of the pipe 3041. The first plate 3021 may be disposed between the insertion space 3044 and the first space 3224. The first plate 3021 may separate the insertion space 3044 from the first space 3224.

The pipe 3041 may be integrally connected to the sealing member 3134 in the heater assembly HA. The pipe 3041 and the sealing member 3134 may be integrally connected to each other through the inlet hole 3324.

The pipe 3041 and the sealing member 3134 may be integrally connected to each other through the hook hole 3222.

The flange 3013 may be surrounded and fixed by the sealing member 3134. When the heater 3010 passes through the heater insertion hole 3214, the flange 3013 may slide in contact with the support guide 3226 and the second support bar 3227, and may be guided into the first space 3224. The first support bar 3225 and the second support bar 3227 may support the side portion of the flange 3013 disposed in the first space 3224.

The heater body 3011 and the heater tip 3012 may be disposed in the insertion space 3044. A cigarette may be inserted into the insertion space 3044, and the lower portion thereof may be penetrated by the heater 3010. The heater 3010 may generate heat to heat the cigarette. The first lead wire 3161 and the second lead wire 3162 may be exposed to the lower portion of the pipe 3041.

A catch part 3415 integrated with the pipe 3041 may be provided. The catch part 3415 may protrude radially inward from the inner circumferential surface of the pipe 3041. The catch part 3415 may cover and support the top edge of The first plate 3021. The catch part 3415 may extend in the circumferential direction along the top edge of The first plate 3021. The catch part 3415 may restrict the heater assembly HA from moving upward.

A pipe bottom 3411 may be formed at the lower portion of the pipe 3041. The pipe bottom 3411 may cover the recess portion 3321 (see FIG. 6). The pipe bottom 3411 may contact the recess portion 3321 and support the lower portion of the second cover 3030. The pipe bottom 3411 may restrict the heater assembly HA from moving downward.

Accordingly, the gap between the components of the heater assembly HA may be completely filled. Also, the gap between a housing 3040 and the heater assembly HA may be completely filled.

Further, foreign substances such as liquid may be prevented from leaking through the gaps around the heater 3010.

Additionally, the heater assembly HA may be stably fixed or supported in the housing 3040. Also, the first lead wire 3161 and the second lead wire 3162 may be prevented from being twisted with each other or disconnected.

Further, the process of assembling the heater assembly HA may be simplified. Additionally, the process of coupling the heater assembly HA and the housing 3040 may be further simplified.

Hereinafter, an embodiment of a mobile communication terminal coupled to an aerosol generator is disclosed based on the detailed embodiments of the heater disclosed above.

The disclosed example of the aerosol generator can be coupled to a mobile communication terminal in various ways. Depending on the combination method, the arrangement and shape of the components of the mobile communication terminal may change.

Here, an example is disclosed in which an aerosol generator having a cylindrical pipe-shaped mounting part as described above is coupled to a mobile communication terminal. An aerosol generating article in the form of a cigarette or stick is inserted into the pipe-shaped mounting part. The cigarette inserted into the mounting body may be heated in various heating methods according to the embodiment of the heater or heating part disclosed above.

The embodiments discussed include in a case where the aerosol generator 200 and the antenna of the communicator 400 are combined according to the location of the aerosol generator in a mobile communication terminal.

The example of the combination of the aerosol generator 200 and the antenna of the communicator 400 may be referred to as a coupled module 4100 for simplicity.

FIG. 28 is an exemplary view showing the aerosol generator 200 and a portion of the communicator 400 coupled to each other in an embodiment of a mobile communication terminal.

The configuration of a coupled module in a mobile communication terminal is not required. Depending on where the aerosol generator 200 is located, the aerosol generator 200 and the communication 400 may each be present without a coupled module 4100. On the other hand, when the aerosol generator 200 is located in the vicinity of the communicator 400, a single coupled module 4100 may be provided. Hereinafter, an embodiment in which the aerosol generator 200 and the communicator 400 are coupled to each other is described in detail.

The coupled module 4100 may include a mounting part 4110 to which an aerosol generating article (hereinafter referred to as “article”) 4200 is removably coupled, a heating part 4120 configured to provide thermal energy to the article coupled to the mounting part 4110, and an antenna (first antenna) 4130 configured to enable transmission and reception of wireless signals to and from external devices.

FIG. 29 is a cross-sectional view and top view of the coupled module 4100 disclosed above.

As shown in FIG. 29, the aerosol generating article (or referred to as “stick”) 4200 includes an article body 4210 defining an outer appearance, a filter 4220 disposed inside the article body 4210, and an aerosol generating material (hereinafter “medium”) 4240 disposed inside the article body 4210.

The filter 4220 is arranged outside the mounting part 4110 when the article body 4210 is coupled to the mounting part 4110. The medium 4240 is arranged inside the mounting part 4110 when the article body 4210 is coupled to the mounting part 4110.

The medium 4240 is a material that releases volatile compounds that can form an aerosol when supplied with thermal energy. It may be a liquid or a granular solid. The medium 4240 may contain tobacco (a plant material), nicotine, and other volatile flavor compounds. The medium 4240 may include a plurality of granules, wherein the granules may have a size from 0.4 mm to 112 mm.

A cooling part 4230 may be provided between the filter 4220 and the medium 4240. The cooling part 4230 may have a hollow cylinder shape. Furthermore, to prevent the medium 4240 from being discharged from the article body 4210 or from being discharged into the cooling part 4230, a first cover 4241 may be provided on the bottom surface of the article body 4210, and a second cover 4242 may be provided between the medium 4240 and the cooling part 4230.

The first cover 4241 and the second cover 4242 may be formed of a porous material that allows air to move therethough but prevents the medium 4240 from being discharged. The article body 4210 may be formed of paper or the like that surrounds the first cover 4241, the medium 4240, the second cover 4242, the cooling part 4230, and the filter 4220.

As shown in FIGS. 28 and 29, the mounting part 4110 may include a mounting body 4111 having an accommodation space 4112 for the medium 4240. The mounting body 4111 may be formed in the shape of a cylinder having the accommodation space 4112 defined therein, and may be formed of a dielectric material.

The dielectric material may be a thermoplastic resin such as a polyester-based resin, a cellulose-based resin, a polycarbonate-based resin, an acrylic-based resin, a styrene-based resin, a polyolefin-based resin, a vinyl chloride-based resin, an amide-based resin, an imide-based resin, a polyethersulfone-based resin, a sulfone-based resin, a polyetheretherketone-based resin, a polyphenylene sulfide-based resin, a vinyl alcohol-based resin, a vinylidene chloride-based resin, a vinylbutyral-based resin, an allylate-based resin, a polyoxymethylene-based resin, or an epoxy-based resin. The mounting part 4110 may be formed of any one of the above-mentioned materials, or a combination of two or more thereof.

A top surface 4113 of the mounting body may be provided with an inlet 4116 for entry and exit of the article body 4210, and the antenna 4130 may be fixed to a circumferential surface 4114 of the mounting body. Also, a heating part wire 4126 for control of the heating part 4120 may be fixed to a bottom surface 4115 of the mounting body.

The heating part 4120 may be provided with a heat source of an internal heating type that supplies thermal energy from the inside of the article body 4210, or may be provided with a heat source of an external heating type that supplies thermal energy from the outside of the article body 4210.

FIG. 29 illustrates an example of the internal heating type heating part. According to this embodiment, the heating part 4120 may include a coil 4121 that inductively heats a conductor (e.g., a metal plate) 4250 disposed inside the medium 4240.

In this case, the coil 4121 may be arranged inside the mounting body 4111 so as to surround the accommodation space 4112. In other words, the coil 4121 may be wound along a height direction (Y-axis direction) of the mounting body to surround the accommodation space 4112.

The coil 4121 may be supplied with power via the heating part wire 4126. The embodiment shown in FIG. 29 illustrates an example where the heating part wire 4126 is connected to the coil 4121 through the bottom surface 4115 of the mounting body.

When current is supplied to the coil 4121 via the heating part wire 4126, the conductor 4250 disposed inside the medium 4240 is heated. Accordingly, when a user inhales external air through the filter 4220, the aerosol generated in the medium 4240 will be supplied to the user through the filter 4220.

FIG. 30 is a view illustrating other examples of the coupled module disclosed above.

FIG. 30-(a) illustrates another embodiment of the internal heating type heater. According to this embodiment, the heating part 4120 may include a heater 4123 that contacts the medium 4240 through the article body 4210 when the article body 4210 is inserted into the accommodation space 4112.

According to this embodiment, the heater 4123 may be a metal in the form of a bar or a plate fixed to the bottom surface 4115 of the mounting body and positioned inside the accommodation space 4112. In this case, when the article body 4210 is inserted into the accommodation space 4112, the free end of the heater 4123 will be disposed inside the medium 4240 through the first cover 4241 (the bottom surface of the article body).

FIGS. 30-(b) and 30-(c) illustrate embodiments of heating parts of an indirect heating type. The heating parts of FIGS. 30-(b) and 30-(c) are similar in that they include a pipe-shaped heater 4124 that surrounds the circumferential surface of the article body 4210 inserted into the accommodation space 4112. The pipe-shaped heater 4124 may be fixed to the mounting body 4111 so as to be positioned inside the accommodation space 4112.

While the heater 4124 of FIG. 30-(b) is supplied with power via the heater wire 4126, the heater 4124 of FIG. 30-(c) is heated via the coil 125 positioned inside the mounting body 4111.

As disclosed in the above embodiment, the antenna 4130 may include a patch (a first patch) 4131 fixed to the mounting body 4111 and disposed outside the accommodation space 4112, and a ground (a first ground) 4132 fixed to the mounting body 4111 and disposed outside the accommodation space 4112. The patch 4131 and the ground 4132 may be formed of a conductor, such as a metal plate, and may be fixed to the mounting body 4111 so as to be disposed at positions separated from each other.

The antenna 4130 may be supplied with current through a feeding line (a first feeding line) 4134, which is connected to the patch 4131, and an antenna wire 4133, connects the feeding line 4134 to a communicator 400. The feeding means the operation of applying current to the patch 4131.

To set the radiation direction of the antenna 4130, the patch 4131 and ground 4132 may be arranged in various ways. Specifically, when the mounting body 4111 is formed in a cylindrical shape, the patch 4131 and the ground 4132 may be arranged spaced apart from each other along a circumferential direction of the mounting body 4111, or may be arranged to be spaced apart from each other along the height direction (Y-axis direction) of the mounting body 4111.

In contrast with the illustration in the figures, the mounting body 4111 may be formed in a prismatic shape. In this case, the patch 4131 and the ground 4132 may be arranged to be spaced apart from each other along the circumferential direction of the mounting body 4111 (see FIG. 28), or may be arranged to be spaced apart from each other along the height direction of the mounting body 4111 (see FIG. 31).

The shape of the patch 4131, the size and thickness of the patch 4131, the spacing between the patch 4131 and the ground 4132, the material and thickness of the mounting body 4111, which is a dielectric, and the like should be set according to the desired frequency band for transmission and reception.

In the case where the mounting body 4111 is formed in a cylindrical shape and in the case where the mounting body 4111 is formed in a prismatic shape, the patch 4131 and the ground 4132 fixed on the outer peripheral surface of the mounting body 4111 will have a curved shape.

As shown in FIG. 29-(b) disclosed above, the patch 4131 and the ground 4132 have a curved shape according to the shape of the cross section of the mounting body 4111. Such a shape of the patch and the ground may increase the transmission and reception efficiency in some cases (depending on the set frequency band for transmission and reception).

The communication and aerosol generator 100 having the above-described structure may be provided in a communication terminal having a communicator and a power supply unit, thereby implementing a wireless communication function and an aerosol generation function.

In order to secure compatibility of the coupled module 4100 with a communication terminal, the heating part wire 4126 may be provided with a heating part connector 4127 removably connected to a circuit (substrate, etc.) of the communication terminal, and the antenna wire 4133 may be provided with an antenna connector (first antenna connector) 4135 removably connected to the circuit (substrate, etc.) of the communication terminal.

The coupled module 4100 may further include a control board 4160 configured to control operation of the heating part 4120, and a communicator 400 configured to control wireless communication through the antenna 4130.

The control board 4160 may be configured as a device to control power supplied to the coils 4121 and 4125 or the heaters 4123 and 4124 via the heating part wire 4126, and the communicator (communication module or communication circuit) 300 may be configured as a device to implement a wireless communication function adapted to the purpose of the communication terminal to which the coupled module 4100 is to be mounted.

To ensure compatibility of the communication and aerosol generator 100 having the control board 4160 and the communicator 400, the coupled module 4100 may further include a PCB 4140 on which the controller and communicator are fixed.

The PCB 4140 may be provided with a first connector 4141 to which the heating part connector 4127 is connected, a second connector 4142 to which the antenna connector 4135 is connected, and a third connector 4143 to which the controller (terminal controller or application processor) of the communication terminal is connected.

Thus, embodiments of the present disclosure may provide a coupled module having the communication and the aerosol generator that is capable of realizing both the wireless communication function and the aerosol generation function, and is applicable to various communication terminals.

FIG. 32 is a view illustrating another embodiment of the coupled module 4100.

The coupled module 4100 according to this embodiment differs from the previous embodiments in that it further includes an extension body 4117 extending from the mounting body 4111.

The extension body 4117 may be a plate protruding from the circumferential surface of the mounting body 4111 along a diameter direction (X-axis direction) of the mounting body. The extension body 4117 may be formed of a dielectric material, which may be the same as or different from that of the mounting body 4111.

When the extension body 4117 is provided, the feeding line 4134 provided to the patch 4131 may be provided to the extension body 4117. The antenna wire 4133 may be connected to the feeding line 4134 by bonding. In this case, the extension body 4117 may be a means to improve the durability of the coupled module 4100 by maintaining a stable coupling between the antenna wire 4133 and the feeding line 4134.

FIG. 32-(a) illustrates a case where the patch 4131 and the ground 4132 are spaced apart from each other along the circumferential surface of the mounting body 4111, and FIG. 32-(b) illustrates a case where the patch 4131 and the ground 4132 are spaced apart from each other along a height direction (Y-axis direction) of the mounting body 4111.

As shown in FIG. 32-(c), the patch 4131 may be fixed to the circumferential surface of the mounting body 4111, the feeding line 4134 may be fixed to the top surface of the extension body 4117, and the ground 4132 may be fixed to the bottom surface of the extension body 4117 (opposite to the surface on which the feeding line is fixed).

If necessary for setting the radiation direction of the antenna 4130, the coupled module 4100 of FIG. 32-(c) may be configured such that the ground 4132 is fixed on the same surface as the surface on which the feeding line 4134 is disposed (see the dotted line). Also, in contrast with the arrangement shown in FIG. 32-(c), the patch 4131 may be fixed to the extension body 4117, and the ground 4132 may be fixed to the mounting body 4111.

FIG. 33 is a view illustrating another embodiment of the coupled module 4100. In the coupled module 4100 according to this embodiment, the patch 4131 and the ground 4132 may be disposed on the extension body 4117.

As shown in FIG. 33-(a), the patch 4131 and the ground 4132 may be fixed to the extension body 4117 such that they are spaced apart from each other along the height direction (Y-axis direction) of the mounting body. The patch 4131 and the ground 4132 may be provided on the same plane provided by the extension body 4117. The figure illustrates an exemplary case where the patch and the ground are fixed to the top surface of the extension body 4117.

In contrast with the case illustrated in FIG. 33-(a), the patch 4131 and the ground 4132 may be fixed to the extension body 4117 so as to be spaced apart from each other along a diameter direction (e.g., Z-axis or X-axis direction) of the mounting body.

FIG. 33-(b) illustrates an embodiment in which one of the patch 4131 and the ground 4132 is fixed to the top surface of the extension body 4117, and the other of the patch and the ground is fixed to the bottom surface of the extension body 4117.

With the above-described structure of the communication and aerosol generator 100, when the article 200 is inserted into the accommodation space 4112, the dielectric permittivity of the mounting part 4110 may change, resulting in a degradation of the functionality set for the antenna 4130.

In order to address the above-mentioned issue, the coupled module 4100 may further include a second antenna 4170.

FIG. 34 is a view illustrating another embodiment of the coupled module in which the antenna of the communicator is coupled to the aerosol generator.

As shown in FIG. 34, the coupled module 4100 according to this embodiment also includes a mounting part 4110, a heating part 4120, and a first antenna 4130. The structure of the mounting part 4110, the heating part 4120, and the first antenna 4130 is similar as those in the previously described embodiments, and thus a detailed description thereof will be omitted.

The second antenna 4170 may include a dielectric body 4171 formed of a dielectric material and disposed at a point separated from the mounting part 4110, a second patch 4172 formed of a conductor and fixed to the dielectric body 4171, and a second ground 4173 formed of a conductor and fixed to the dielectric body 4171, the second ground 4173 being disposed at a point separated from the second patch 4172.

The dielectric body 4171 may be made of the same material as the mounting body 4111, or may be made of a different material than the mounting body 4111. The second patch 4172 and the second ground 4173 may be disposed on the same plane provided by the dielectric body 4171, or may be fixed to the dielectric body 4171 such that they face each other. In this embodiment, the latter case is illustrated as an example.

The coupled module 4100 according to this embodiment may include a PCB 4140 provided with circuitry for switching of the first antenna 4130 and the second antenna 4170, a control board 4160 provided on the PCB to control the operation of the heating part 4120, and a communicator 400 of FIG. 1 configured to supply current to the antennas 4130 and 4170.

The second patch 4172 may be provided with a second feeding line 4174. The second feeding line 4174 may be connected to the communicator 400 via a second antenna wire 4175. To this end, the PCB may be provided with a fourth connector 4144, and the second antenna wire 4175 may be provided with a second antenna connector that is coupled to the fourth connector 4144.

FIG. 35 is a view illustrating another embodiment of a coupled module in which the antenna of the communicator is coupled to the aerosol generator.

As shown in FIG. 35-(a), the PCB 4140 may be provided with a first circuit 4154 connecting the communicator 400 and the first antenna 4130, a second circuit 4156 connecting the communicator 400 and the second antenna 4170, and a switch 4153 configured to control the opening and closing of the two circuits 4154 and 4156.

The circuits 4154 and 4156 and switch 4153 may be implemented as various structures. FIG. 35-(a) illustrates an exemplary case where the first circuit 4154 and the second circuit 4156 into which one circuit (communicator circuit) 4151 connected to the communicator 400 branches at the switch 4153.

The communicator circuit 4151 may have an amplifier (a low noise amplifier or a linear power amplifier) 4152. The first circuit 4154 may be provided with a first matching network 4155 for impedance matching, and the second circuit 4156 may be provided with a second matching network 4157.

Another embodiment is disclosed by the structure of FIG. 35-(b). The embodiment of FIG. 35-(b) differs from the embodiment of FIG. 35-(a) in that the first circuit 4154 is provided with a first amplifier 4158 and the first matching network 4155, and the second circuit 4156 is provided with a second amplifier 4159 and the second matching network 4157.

For the coupled module 4100 in which the communicator and the aerosol generator shown in FIGS. 35-(a) and 35-(b) are coupled, when the aerosol generating article 4200 is not inserted into the accommodation space 4112, the switch 4153 operates to close the first circuit 4154 (to connect the communicator to the first antenna) and opens the second circuit 4156 (to disconnect the communicator from the second antenna). On the other hand, when the article 4200 is inserted into the accommodation space 4112, the switch 4153 closes the second circuit 4156 (to connect the communicator to the second antenna) and opens the first circuit 4154 (to disconnect the communicator from the first antenna).

Accordingly, according to embodiments of the present disclosure, an antenna to perform a wireless communication function may be selected among multiple antennas based on whether the aerosol generation function is executed, thereby minimizing the deterioration of the wireless communication function caused by a change in dielectric permittivity of the mounting part 4110.

The coupled module 4100 having the communicator and the aerosol generator disclosed above may be installed in a mobile communication terminal. In this case, the antennas 4130 and 4170 provided in the coupled module 4100 may be connected to the communicator 400 via the antenna wires 4133 and 4175, and the heating part 4120 of the coupled module 4100 may be connected to the controller 100 via the heating part wire 4126.

A coupled module 4100 having the communicator 400 and the control board 4160 may be included in a mobile communication terminal.

In the mobile communication terminal according to an embodiment, the communicator 400 and the control board 4160 may be mounted on the PCB 4140. In this case, the communicator 400 and the control board 4160 may be connected to the controller 100 by the third connector 4143 of the PCB.

The above-described communication and aerosol generator, and the structure and control method of the communication terminal including the module are illustrative of embodiments the present disclosure.

A method of heating an aerosol generating article or a cigarette containing the aerosol generating article has been described above. The heating method is classified into internal heating or external heating depending on whether heating is performed inside or outside the aerosol generating article or cigarette.

For external heating, the cigarette may be heated by inductive heating or by a capsule in the form of a patterned film. For internal heating, the cigarette may be heated directly by inserting a needle into the cigarette or by allowing the needle to serve as a receptor.

Hereinafter, embodiments will be disclosed in which an aerosol generator is positioned within a mobile communication terminal according to the heating types described above, and system control can be elaborately performed by sensing the temperature of the aerosol generator.

In controlling the temperature of the heating part of the aerosol generator, the temperature may be measured and sensed by directly attaching a temperature sensor inside or outside the aerosol generator. In this case, there is a possibility of damage to the temperature sensor. To avoid the damage, a non-contact temperature sensor may be disposed outside the heating part. However, in this case, power efficiency may decrease.

Hereinafter, an embodiment is disclosed in which the temperature of the aerosol generator of a mobile communication terminal is accurately measured while not causing damage to the sensor.

FIG. 36 is a view schematically illustrating an embodiment of the aerosol generator.

An aerosol generator 5100 of the mobile communication terminal may generate aerosol by heating a cigarette accommodated in the aerosol generator 5100 by inductive heating. The inductive heating may refer to a method of generating heat from a magnetic member by applying an alternating magnetic field with a periodically changing direction to the magnetic member configured to generate heat by an external magnetic field.

When an alternating magnetic field is applied to the magnetic member, the magnetic member may be subjected to energy loss such as eddy current loss and hysteresis loss, and the lost energy may be emitted from the magnetic member in the form of thermal energy. As the amplitude or frequency of the alternating magnetic field applied to the magnetic member increases, the thermal energy emitted from the magnetic member may increase.

The aerosol generator 5100 may cause thermal energy to be emitted from the magnetic member by applying an alternating magnetic field to the magnetic member, and may transfer the thermal energy emitted from the magnetic member to the cigarette.

The magnetic member that generates heat due to an external magnetic field may be a susceptor 5110. The susceptor 5110 may be formed in the shape of a slice, flake, or strip.

The susceptor 5110 may include metal or carbon. The susceptor 5110 may include at least one of ferrite, ferromagnetic alloy, stainless steel, and aluminum (Al).

The susceptor 5110 may also include at least one of graphite, molybdenum, silicon carbide, niobium, nickel alloy, metal film, ceramics such as zirconia, a transition metal such as nickel (Ni) or cobalt (Co), or a semi-metal such as boron (B) or phosphorus (P).

The aerosol generator 5100 may include an accommodation space 5120 for accommodating a cigarette. The accommodation space 5120 may include an opening that is formed to be open on the outside of the accommodation space 5120 to accommodate a cigarette in the aerosol generator 5100. The cigarette may be accommodated in the aerosol generator 5100 through the opening of the accommodation space 5120 in a direction from the outside of the accommodation space 5120 to the inside of the accommodation space 5120.

As shown in FIG. 36-(a), a susceptor 5110 may be disposed at the inner end of the accommodation space 5120. The susceptor 5110 may be attached to the bottom surface formed at the inner end of the accommodation space 5120. The cigarette may be fitted onto the susceptor 5110 from the upper end of the susceptor 5110 and may be received up to the bottom of the accommodation space 5120.

As shown in FIG. 36-(b), the aerosol generator 5100 may not include the susceptor 5110. In this case, the susceptor 5110 may be included in the cigarette.

The aerosol generator 5100 may include a coil unit 5130 that applies alternating magnetic fields to the susceptor 5110 and having a resonant frequency varies in response to a change in temperature of the susceptor 5110 caused by inductive heating of the susceptor 5110. The coil unit 5130 may include at least one coil.

The coil may be implemented as a solenoid. The coil may be a solenoid wound along the lateral surface of the accommodation space 5120, and a cigarette 5200 may be accommodated in the inner space of the solenoid. The material of the conductor constituting the solenoid may be copper (Cu).

However, the conductor is not limited thereto. Any one of silver (Ag), gold (Au), aluminum (Al), tungsten (W), zinc (Zn), and nickel (Ni), or an alloy comprising at least one of them may be used as a material having a low resistivity and allowing a high current to flow for the conductor constituting the solenoid.

The coil unit 5130 may be wound along the outer lateral surface of the accommodation space 5120 and may be disposed at a position corresponding to the susceptor 5110. The coil arrangement of the coil unit 5130 will be described in detail below.

The aerosol generator 5100 may supply power from the power supply unit of the mobile communication terminal to the coil unit 5130.

The power supply unit may be, but is not limited to, a lithium iron phosphate (LiFePO4) battery. For example, the battery may be a lithium cobalt oxide (LiCoO2) battery, a lithium titanate battery, or the like.

The controller may control the power supplied to the coil unit 5130. When the coil unit 5130 includes multiple coils, the controller may vary the driving frequencies of the coils.

The controller may inductively heat the susceptor 5110 by controlling the driving frequencies. Additionally, it may sense the resonant frequency of the coils changed by inductive heating of the susceptor 5110, and calculate the temperature of the susceptor based on the sensed resonant frequency.

Hereinafter, an embodiment in which the controller senses the resonant frequency will be described in detail.

FIG. 37 is a view illustrating an example of an aerosol generating article or cigarette that may be coupled to the aerosol generator of a mobile communication terminal.

A cigarette 5200 may include a tobacco rod 5210 and a filter rod 5220. While the filter rod 5220 is shown in FIG. 37 as being composed of a single region, it is not limited thereto. The filter rod 5220 may include multiple segments.

For example, the filter rod 5220 may include a first segment to cool the aerosol and a second segment to filter specific components included in the aerosol.

The filter rod 5220 may further include at least one segment to perform another function.

The cigarette 5200 may be wrapped by at least one wrapper 5240. The wrapper 5240 may be provided with at least one hole through which external air flows in or internal air flows out.

As an example, the cigarette 5200 may be wrapped by one wrapper 5240.

As another example, the cigarette 5200 may be wrapped by two or more wrappers 5240 in an overlapping manner. Specifically, the tobacco rod 5210 may be wrapped by a first wrapper, and the filter rod 5220 may be wrapped by a second wrapper. The cigarette rod 5210 and the filter rod 5220 wrapped by each of the wrappers may be combined, and the entire cigarette 5200 may be rewrapped by a third wrapper.

The tobacco rod 5210 may contain an aerosol generating material. For example, the aerosol generating material may include, but is not limited to, at least one of glycerin, propylene glycol, ethylene glycol, dipropylene glycol, diethylene glycol, triethylene glycol, tetraethylene glycol, and oleyl alcohol. The tobacco rod 5210 may contain other additives such as a flavoring agent, a humectant, and/or an organic acid.

A flavoring agent such as menthol or moisturizer may be added to the tobacco rod 5210 by spraying the same on the tobacco rod 5210.

The tobacco rod 5210 may be manufactured in various ways. For example, the tobacco rod 5210 may be formed of a sheet or a strand. Alternatively, the tobacco rod 5210 may be formed of a tobacco sheet cut made into small pieces.

As illustrated in FIG. 37-(b), the cigarette 5200 may further include the susceptor 5110. In this case, the susceptor 5110 may be disposed in the cigarette rod 5210, as shown in FIG. 37-(b). The susceptor 5110 may extend from an end of the cigarette rod 5210 toward the filter rod 5220.

The tobacco rod 5210 may be surrounded by a heat-conducting material. For example, the heat-conducting material may be a metal foil such as aluminum foil, but is not limited thereto. The heat-conducting material surrounding the tobacco rod 5210 may evenly distribute the heat transferred to the tobacco rod 5210 to improve the heat conductivity applied to the tobacco rod 5210, thereby enhancing the flavor of the aerosol.

The filter rod 5220 may be a cellulose acetate filter. The filter rod 5220 may be formed in various shapes. For example, the filter rod 5220 may be a cylindrical rod or a tubular rod including a hollow formed therein. Alternatively, the filter rod 220 may be a recess-type rod including a cavity formed therein.

When the filter rod 5220 includes multiple segments, the multiple segments may be formed in different shapes.

The filter rod 5220 may be formed such that flavor is generated from the filter rod 5220.

For example, a flavoring liquid may be sprayed onto the filter rod 5220, and a separate fiber to which the flavoring liquid is applied may be inserted into the filter rod 5220.

The filter rod 5220 may include at least one capsule 5230. The capsule 5230 may generate flavor and may also generate aerosol. For example, the capsule 5230 may be formed in a structure that surrounds a liquid containing fragrance with a film.

The capsule 5230 may have a spherical or cylindrical shape, but is not limited thereto.

When a cooling segment to cool the aerosol is included in the filter rod 5220, the cooling segment may be made of a polymeric material or a biodegradable polymeric material. For example, cooling segment may be made entirely from pure polylactic acid.

Alternatively, the cooling segment may be made of a cellulose acetate filter containing multiple perforations. However, embodiments are not limited thereto. The cooling segment may be composed of a structure and material that cool the aerosol.

FIG. 38 illustrates an example of a cigarette being inserted into the aerosol generator of the mobile communication terminal.

FIG. 38-(a) shows an example of the cigarette 5200 inserted into the aerosol generator when the susceptor 5110 is disposed in the aerosol generator 5100.

FIG. 38-(b) shows an example of the cigarette 5200 inserted into the aerosol generator 5100 when the susceptor 5110 is disposed in the cigarette 5200.

First, referring to FIG. 38-(a), the cigarette 5200 may be accommodated in the accommodation space along the longitudinal direction of the cigarette 5200. The susceptor 5110 may be inserted into the cigarette 5200 accommodated in the aerosol generator 5100.

As the cigarette 5200 is fitted onto the susceptor 5110, the tobacco rod 5210 may contact the susceptor 5110. The susceptor 5110 may extend in the longitudinal direction of the aerosol generator 5100 so as to be inserted into the cigarette 5200.

The susceptor 5110 may be disposed at the center of the accommodation space 5120 so as to be inserted into the center of the cigarette 5200.

While FIG. 38-(a) illustrates that a single susceptor 5110 is provided, embodiments are not limited thereto. In other words, the aerosol generator of the present disclosure may include multiple susceptors 5110 that extend in the longitudinal direction of the aerosol generator and are arranged parallel to each other such that the susceptors may be inserted into the cigarette 5200.

The coil unit 5130 may include at least one coil. The coil may be wound around the outer lateral surface of the accommodation space 5120 to extend in the longitudinal direction. The coil extending in the longitudinal direction may be disposed on the outer lateral surface of the accommodation space 5120. The coil may extend along the longitudinal direction by a length corresponding to the susceptor 5110 and may be disposed at a position corresponding to the susceptor 5110.

Referring to FIG. 38-(b), the cigarette 5200 may be accommodated in the accommodation space 5120 along the longitudinal direction of the cigarette 5200. As the cigarette 5200 is inserted into the accommodation space 5120, the susceptor 5110 may be surrounded by the coil unit 5130.

The susceptor 5110 may be disposed at the center of the tobacco rod 5210 for uniform heat transfer. While FIG. 38-(b) illustrates that a single susceptor 5110 is provided, embodiments are not limited thereto.

In other words, the aerosol generator 5100 of the present disclosure may include multiple susceptors 5110 disposed in the cigarette 5200.

The coil unit 5130 may include at least one coil. The coil may be wound around the outer lateral surface of the accommodation space 5120 to extend in the longitudinal direction. The coil extending in the longitudinal direction may be disposed on the outer lateral surface of the accommodation space 5120. The coil may extend along the longitudinal direction by a length corresponding to the susceptor 5110 and may be disposed at a position corresponding to the susceptor 5110.

FIG. 39 illustrates an example of a method of winding a coil in an aerosol generator.

FIG. 39-(a) illustrates a coil winding method used when the coil unit 5130 includes only one coil, and FIGS. 39-(b) and 39-(c) illustrate coil winding methods used when the coil unit 5130 includes multiple coils.

While FIG. 39 illustrates a case where a cigarette containing the susceptor 5110 is accommodated in the accommodation space in the aerosol generator 5100, the following embodiments are applicable even in the case where the susceptor 5110 is fixedly disposed in the aerosol generator 5100 in the form of a needle.

In FIGS. 39-(a), 39-(b), and 39-(c), the inner lateral surface of the accommodation space 5120 refers to the region in contact with the region where the cigarette 5200 is inserted, and the outer lateral surface of the accommodation space 5120 refers to the side facing away from the lateral inner surface. The longitudinal direction of the aerosol generator may refer to a direction perpendicular to the end surface of the accommodation space into which the cigarette 5200 is inserted.

Referring to FIG. 39-(a), the coil unit 5130 may include a first coil 5131. The first coil 5131 may surround the outer lateral surface of the accommodation space.

The first coil 5131 may be wound around the outer lateral surface of the accommodation space along the longitudinal direction of the aerosol generator 5100.

The first coil 5131 may be wound around the outer lateral surface of the accommodation space along the longitudinal direction to correspond to the susceptor 5110.

In FIG. 39-(a), the aerosol generator 5100 includes only one coil, and thus the first coil 5131 may be called a coil 5131.

In the case where the aerosol generator 5100 inductively heats the susceptor 5110 with only one coil 5131 and measures the temperature of the susceptor 5110 as shown in FIG. 39-(a), manufacturing convenience may be increased.

In FIG. 39-(b), the coil unit 5130 may further include a second coil 5132. The first coil 5131 and the second coil 5132 may be alternatingly wound around the outer lateral surface of the accommodation space along the longitudinal direction.

In FIG. 39-(c), the coil unit 5130 may further include the second coil 5132. The first coil 5131 may be wound around a first region 5171 on the outer lateral surface of the accommodation space 5120, and the second coil 5132 may be wound around a second region 5172 that is different from the first region.

When the aerosol generator 5100 includes multiple coils 5131 and 5132 as shown in FIGS. 39-(b) and 39-(c), the aerosol generator 5100 may continuously heat the susceptor 5110 through the first coil 5131 while measuring the temperature of the susceptor 5110 in real time through the second coil 5132.

Hereinafter, a detailed embodiment of measuring the temperature of the susceptor 5110 in real time will be disclosed.

FIG. 40 is a flowchart illustrating an example of measuring a temperature of a heating part of an aerosol generator.

In the embodiment of the aerosol generator disclosed above, the temperature of the heating part may be measured as follows.

In operation S910, when power is supplied to the aerosol generator or insertion of a cigarette into the aerosol generator is sensed, the controller of the mobile communication terminal may cause the aerosol generator to drive the first coil 5131 in a first frequency range.

For example, when the first coil 5131 is driven in the first frequency range, the current applied to the first coil 5131 is maximized at a first resonant frequency.

In other words, the current may vary depending on the driving frequency applied to the coil, and the controller may control the aerosol generator based on information about the frequency response characteristics. This will be described in detail below with reference to the drawings illustrating the relationship between the applied frequency of the coil and the frequency response characteristics.

In operation S920, the controller may sense a change in the resonant frequency of the second coil based on a second frequency range.

When the temperature of the susceptor changes, the frequency response of the second coil may change from a first frequency response to a second frequency response.

As the temperature of the susceptor changes, the control may cause the second resonant frequency of the second coil to be sensed in the second frequency range.

The controller may sense the change in resonant frequency according to the change in temperature of the susceptor in the aerosol generator using a detection sensor in the aerosol generator or an NFC antenna of the mobile communication terminal.

The NFC antenna may include a loop antenna module including a loop coil. The loop antenna module of the NFC antenna of the mobile communication terminal according to the embodiment may sense the frequency according to the change in temperature of the susceptor heated by magnetic induction.

Details will be described with reference to the drawings illustrating the relationship between the resonant frequency and the response characteristics according to the change in temperature of the susceptor.

In operation S930, the controller may calculate the temperature of the susceptor based on the change in resonant frequency of the second coil.

As the temperature of the susceptor changes, the controller may calculate the temperature of the susceptor based on the difference in frequency response characteristics.

The controller may sense the frequency difference using a frequency detection sensor in the aerosol generator or the NFC antenna of the mobile communication terminal and calculate the temperature of the susceptor based on the difference.

If there is a difference in frequency characteristics according to the temperature of the susceptor that is heated by magnetic induction in the aerosol generator, the loop antenna coil of the NFC antenna receives the corresponding frequency response characteristics and provides information about the response characteristics to the controller.

Accordingly, the controller may control the temperature of the susceptor in the aerosol generator by varying the driving frequency applied to the coil for aerosol generation.

A specific example of logic in which the controller calculates the temperature of the susceptor according to the frequency response characteristics of the coil will be described in detail below with reference to the drawings related to the difference in resonant frequency and change in frequency response characteristics.

FIG. 41 is a diagram depicting a relationship between a driving frequency applied to a coil and a frequency response characteristic.

In this figure, the horizontal axis represents frequency and the vertical axis represents the strength of the frequency signal.

The current applied to the first coil 5131 may depend on the first driving frequency for driving the first coil 5131.

When it is assumed that the frequency response characteristics of the first coil 5131 are maximized at a first resonant frequency fo1, the current applied to the first coil 5131 may be maximized at the first resonant frequency fo1.

The first resonant frequency fo1 may be determined by the first coil 5131 and a first capacitor connected in series to the first coil 5131.

Additionally, the response characteristics of the first coil 5131 may gradually decrease as the frequency increases, based on the first resonant frequency fo1.

For example, the magnitude h1 of the response characteristic of the first coil 5131 at a first frequency f1 higher than the first resonant frequency fo1 may be greater than the magnitude h2 of the response characteristic of the first coil 5131 at the second frequency f2 higher than the first frequency f1.

The controller may control the current applied to the first coil 5131 by varying the first driving frequency in a preset first frequency range.

When the current applied to the first coil 5131 varies, the temperature of the susceptor 5110 provided in the aerosol generator may also vary.

The aerosol generating article may be the cigarette disclosed above. For example, the controller may supply maximum power to the first coil 5131 by setting the first driving frequency to the first resonant frequency fo1. Thereby, the susceptor 5110 may be heated to the maximum temperature.

As another example, the controller may supply first power that is less than the maximum power to the first coil 5131 by setting the first driving frequency to the first frequency f1 that is higher than the first resonant frequency fo1.

Thereby, the susceptor 5110 may be heated to a first temperature that is lower than the maximum temperature.

As another example, the controller may supply second power less than the first power to the first coil 5131 by setting the first driving frequency to a second frequency f2 that is higher than the first frequency f1. Thereby, the susceptor 5110 may be heated to a second temperature that is lower than the first temperature.

FIG. 42 is a diagram depicting the relationship between a change in resonant frequency and a response characteristic according to a change in temperature of a susceptor.

Specifically, FIG. 42 depicts frequency responses 1120, 1110, 1130 of the second coil 5132 according to the change in temperature of the susceptor 5110.

When the susceptor 5110 is at the first temperature, the response characteristic of the second coil 5132 may be maximized at the second resonant frequency fo2. The second resonant frequency fo2 may be determined by the second coil 5132 and a second capacitor connected in series to the second coil 5132.

Additionally, the second resonant frequency fo2 of the second coil 5132 may increase as Fo2″ or decrease as Fo2′ as the temperature of the susceptor 5110 increases.

As the second resonant frequency fo2 varies, the frequency at which the maximum current is output may also vary. The controller 5150 may sweep the second driving frequency of the second coil 5132 within the second frequency range and obtain information sensing the second resonant frequency fo2 of the second coil 5132 based on the result of frequency sweeping.

For example, the controller 5150 may sweep the second driving frequency of the second coil within the second frequency range, and determine the driving frequency at the maximum current applied to the second coil 5132 as the second resonant frequency.

When the second frequency range overlaps the first frequency range, the susceptor 5110 may be inductively heated by the second coil 5132. Since heating by the second coil 5132 corresponds to unexpected heating, it may result in inaccurate control of the temperature of the susceptor 5110. Accordingly, the second resonant frequency fo2 may be set lower than the first resonant frequency fo1.

Further, the second frequency range may be set differently from the first frequency range. For example, a lower limit of the first frequency range may be set greater than an upper limit of the second frequency range. In another example, at the lower limit of the first frequency range, the temperature of the susceptor 5110 may be increased to a first heating temperature. At the upper limit of the second frequency range, the temperature of the susceptor 5110 may be increased to a second heating temperature that is lower than the first heating temperature. The second heating temperature may be a temperature at which no aerosol is generated.

Further, if the upper limit of the second frequency range affects the change in temperature of the susceptor 5110, the temperature of the susceptor 5110 may vary even during the sweeping of the frequency of the second coil 5132. Accordingly, the upper limit of the second frequency range may be set to a frequency that does not affect the change in temperature of the susceptor 5110. For example, when the first frequency range is 2 MHz to 4 MHZ, the second frequency range may be set to, for example, 0.1 MHz to 0.3 MHz, however the present disclosure is not limited thereto.

FIG. 43 is a diagram depicting a difference in resonant frequency and a change in frequency response characteristic.

Specifically, the figure shows the frequency responses 1210 and 1220 of the second coil 5132 according to the change in temperature of the susceptor 5110. As the temperature of the susceptor 5110 changes, the frequency response of the second coil 5132 changes from the first frequency response 1210 to the second frequency response 1220.

The controller may calculate a temperature of the susceptor 5110 based on a frequency difference fo2d between a third resonant frequency fo2a of the second coil sensed at a first time after initiation of heating of the susceptor 5110 and a fourth resonant frequency fo2b at a second time that is a preset time later than the first time.

The controller may calculate the temperature of the susceptor 5110 based on the data of matching between the resonant frequency difference fo2d and the temperature of the susceptor 5110. The matching data about the resonant frequency difference fo2d and the temperature of the susceptor 5110 may be pre-stored in a memory in the storage 800 in the form of a lookup table.

FIG. 44 shows a flowchart illustrating another example of a method of operating an aerosol generator and a diagram illustrating a control period thereof.

FIG. 44-(a) is a flowchart illustrating another example of an operation method of the aerosol generator, wherein the aerosol generator 200 heats the susceptor 5110 with only one coil and calculates the temperature of the susceptor 5110.

FIG. 44-(b) illustrates control periods according to the flowchart disclosed in FIG. 44-(a).

The controller 100 may control the coil of the aerosol generator in preset control periods. Each control period may include a heating period and a sensing period. The controller 100 may heat the aerosol generating article or the receptor 5110 using the coil of the aerosol generator in the heating period and calculate the temperature of the receptor 5110 using the coil in the sensing period.

Specifically, in operation S1310, the controller 100 may drive the coil of the aerosol generator based on the first frequency range in the heating period.

The method of driving the coil of the aerosol generator in the heating period may be the same as the method described above. The controller 100 may control the current applied to the coil of the aerosol generator by varying the driving frequency in the preset frequency range. When the current applied to the coil of the aerosol generator is varied, the temperature of the aerosol generating article or the susceptor 5110 may also be varied.

In operation S1320, the controller 100 may sense a change in the resonant frequency of the coil of the aerosol generator based on the second frequency range in the sensing period.

The method of sensing a change in the resonant frequency of the coil 5131 in the sensing period may be similar to the sensing method exemplarily described above. The controller 100 may sweep the driving frequency of the coil of the aerosol generator within the second frequency range and sense the resonant frequency of the coil of the aerosol generator based on the result of frequency sweeping.

For example, the controller 100 may sweep the driving frequency of the coil of the aerosol generator within the second frequency range and determine the driving frequency at the maximum current applied to the coil of the aerosol generator as the resonant frequency.

In this embodiment, the controller heats the susceptor 5110 using only one coil in the aerosol generator and calculates the temperature of the susceptor 5110. Accordingly, the first frequency range and the second frequency range may be set to be the same. For example, the first frequency range and the second frequency range may be set to 2 MHz to 4 MHZ, but are not limited thereto.

The heating period may be set longer than the sensing period. By setting the heating period longer than the sensing period, the controller may accurately measure the temperature of the susceptor 5110 while minimizing the change in temperature of the susceptor 5110.

In operation S1330, the controller 100 may calculate the temperature of the susceptor 5110 based on a change in the resonant frequency of the coil of the aerosol generator.

The method of calculating the temperature of the susceptor 5110 in the sensing period may be similar to the method used given two coils as described above.

The controller 100 may calculate the temperature of the susceptor 5110 based on the frequency difference between a fifth resonant frequency of the coil 5131 sensed at a first time after initiation of the sensing period and a sixth resonant frequency at a second time that is a preset time later than the first time.

The controller 100 may calculate the temperature of the susceptor 5110 based on matching data about the resonant frequency difference and the temperature of the susceptor 5110. The matching data about the resonant frequency difference and the temperature of the susceptor 5110 may be pre-stored in the storage 800 in the form of a lookup table.

FIG. 45 is a block diagram of one example of a mobile communication terminal capable of facilitating control of the temperature and system of an aerosol generator.

Referring to FIG. 45, a mobile communication terminal according to an embodiment may include a controller 100, an aerosol generator 200, a power supply unit 300, and a storage 800.

Although not shown in this figure, a susceptor is included in the aerosol generator 200 or a cigarette coupled to the aerosol generator 200.

The power supply unit 300 may supply power to internal components of the aerosol generator 200. The power supply unit 300 may provide direct current power, and a power converter (not shown) of the aerosol generator 200 may convert the direct current provided by the power supply unit 300 into alternating current and supply the alternating current to the aerosol generator 200. The aerosol generator 200 may heat the susceptor by magnetic induction according to alternating current.

The heating part of the aerosol generator 200 may include at least one coil. In one embodiment, the heating part of the aerosol generator 200 may include a first coil.

In another embodiment, the heating part of the aerosol generator 200 may include a first coil 5131 and a second coil 5132.

The heating part of the aerosol generator 200 may further include a capacitor connected in series or parallel to the coil. In one embodiment, the heating part of the aerosol generator 200 may include a first capacitor connected in series or parallel to the first coil.

In another embodiment, the heating part of the aerosol generator 200 may include a first capacitor connected in series or parallel to the first coil and a second capacitor connected in series or parallel to the second coil. In the description below, it is assumed that the capacitors are connected in series to the coils. However, the description below is applied even when the capacitors are connected in parallel with the coils.

The controller 100 may control the driving frequency of the heating part of the aerosol generator 200. In a series resonant circuit, the current flowing through the first coil and/or the second coil (if the second coil is present) may be maximized at the resonant frequency. The controller 100 may heat the susceptor of the aerosol generator 200 by controlling the driving frequency of the heating part of the aerosol generator 200 and obtain information about the temperature of the susceptor sensed using a frequency detection sensor.

The frequency detection sensor may use the NFC antenna of the communicator 400 or may include a detection sensor in the aerosol generator 200.

The controller 100 may obtain information about the change in resonant frequency according to the change in temperature of the susceptor in the aerosol generator 200 from a frequency detection sensor such as the NFC antenna of the communicator 400.

The controller 100 heats the susceptor through the first coil, and may obtain information corresponding to the change in temperature of the susceptor through the NFC antenna or a separate frequency detection sensor according to a change in the resonant frequency of the second coil. Alternatively, the controller 110 may heat the susceptor with only the first coil and obtain resonant frequency change information corresponding to the temperature of the susceptor through the NFC antenna or a separate frequency detection sensor.

The storage 800 may store matching data about the resonant frequency and the temperature of the susceptor or matching data about the resonant frequency change and the temperature of the susceptor in the form of a lookup table, and the controller 100 may calculate the temperature of the susceptor based on the lookup table.

The controller 100 may reliably control the entire system including proportional-integral-differential (PID) control of the mobile communication terminal including the aerosol generator 200, based on the calculated temperature.

An example in which the controller 100 controls the first coil and the second coil or controls the temperature using only the first coil 5131 has been described in detail above.

Disclosed below is another embodiment in which the temperature of the susceptor in the aerosol generator of the mobile communication terminal may be sensed to control the system of the mobile communication terminal.

In an embodiment, the susceptor may be heated by controlling the alternating current supplied to the coil unit.

In another embodiment, the susceptor may be heated by controlling the alternating current supplied to the first coil, and then the direct current supplied to the first coil may be controlled to induce a change in the magnetism of the susceptor to calculate the temperature of the susceptor.

In another embodiment, the susceptor may be heated by controlling the alternating current supplied to the first coil, and then the direct current supplied to the second coil may be controlled to induce a change in the magnetism of the susceptor to calculate the temperature of the susceptor.

The mobile communication terminal may sense a change in magnetism within the coil using a magnetic force sensor of the aerosol generator or a magnetic sensor of the sensor in the mobile communication terminal.

Based on the sensed change in magnetism, the controller of the mobile communication terminal may calculate the temperature of the susceptor and control the system. Detailed embodiments of this operation are disclosed below.

FIG. 46 illustrates embodiments of a method of winding a coil in an aerosol generator.

While FIG. 46 illustrates that a cigarette containing the susceptor 5110 is accommodated in the accommodation space in the aerosol generator 5100, the embodiments disclosed below are applied even in the case where the susceptor 5110 is fixed to the aerosol generator 5100 in the form of a needle, or the like.

FIG. 46-(a) illustrates a coil winding method used when the coil unit 5130 includes only one coil, and FIGS. 46-(b) and 46-(c) illustrate coil winding methods used when the coil unit 5130 includes multiple coils.

The magnetic force sensor may sense changes in the magnetic force of the susceptor.

Here, the magnetic force sensor may be separately provided in the aerosol generator, or may refer to the magnetic sensor of the sensor in the mobile communication terminal or the magnetic sensor in the camera module.

For simplicity, this embodiment illustrates that the magnetic force sensor is disposed in the aerosol generator. However, the same embodiment may also be applied when the magnetic sensor of the sensor of the mobile communication terminal or the magnetic sensor of the camera module in the input unit is used. Herein, they are similarly referred to as the magnetic force sensor.

The magnetic force sensor may include at least one Hall sensor, and the controller may measure the temperature of the susceptor based on the change in magnetic force sensed by the magnetic force sensor.

The Hall sensor measures the magnitude of the magnetic field according to the voltage (Hall voltage) generated by the current and magnetic field in the coil, which are orthogonal to each other. Accordingly, when the magnetic force sensor measures the change in magnetism that occurs due to magnetic induction in the aerosol generator, the controller may receive information corresponding to the corresponding temperature of the susceptor to perform a control operation.

In FIG. 46-(a), the coil unit 5131 includes a coil wound around the outer lateral surface of the accommodation space along the longitudinal direction of the aerosol generator 5100.

The controller may control alternating current in the coil unit 5131 to heat the susceptor 5110 and induce a change in magnetism.

As another example, the controller may heat the susceptor 5110 by controlling the alternating current supplied to the coil unit 5131, and induce magnetism in the susceptor 5110 by controlling the direct current supplied to the coil unit 5131.

The magnetic force sensor may sense the magnetism induced in the susceptor 5110 and transmit the information related thereto to the controller, and the controller may calculate and control the temperature of the susceptor 5110 based on the changed magnetism.

In FIG. 46-(b), the coil unit 5130 includes a first coil 5131 and a second coil 5132 wound alternately around the outer lateral surface of the accommodation space along the longitudinal direction.

I In FIG. 46-(c), the coil unit 5130 includes a first coil 5131 wound around a first region 5171 on the outer lateral surface of the accommodation space 5120, and a second coil 5132 wound around a second region 5172 that is different from the first region on the outer lateral surface.

In this case, the controller may heat the susceptor 5110 by controlling the alternating current supplied to the first coil 5131, and induce magnetism in the susceptor 5110 by controlling the direct current supplied to the second coil 5132.

The magnetic force sensor may sense the magnetism induced in the susceptor 5110 and transmit the information related thereto to the controller, and the controller may calculate and control the temperature of the susceptor 5110 based on the changed magnetism.

FIG. 47 depicts a change in magnetic force and an output voltage according to a change in temperature of a susceptor.

FIG. 47-(a) depicts a change in magnetic force 5291 according to the temperature of the susceptor. The horizontal axis represents temperature and the vertical axis represents magnetic force. As illustrated in this figure, as the temperature of the susceptor increases, the magnetic force decreases. The storage 800 of the mobile communication terminal may store data representing the change in magnetic force according to the temperature of the susceptor as a lookup table.

Therefore, the relationship between the change in temperature of the susceptor and the change in magnetic force of the susceptor may be identified. When the magnetic force sensor senses a change in the magnetic force of the susceptor, the magnetic force sensor may output an output value corresponding to the magnetic force of the susceptor. The output value may be set to voltage, current, or frequency.

FIG. 47-(b) depicts an output voltage 5301 according to the magnetic force of the susceptor. That is, the horizontal axis represents the magnitude of the change in magnetic force and the vertical axis represents the output voltage. It may be seen that as the value of the change in magnetic force of the susceptor increases, the output voltage also increases. Thus, the storage 800 of the mobile communication terminal may store the output value according to the change in magnetic force as a lookup table. When the controller receives the output value from the magnetic force sensor, the corresponding value of the change in magnetic force of the susceptor may be obtained based on the lookup table stored in the storage unit, and the temperature information about the susceptor may be obtained accordingly.

Based on the information, the controller may control the temperature of the susceptor.

FIG. 48 illustrates an example of controlling the temperature of a susceptor with a coil in an aerosol generator of a mobile communication terminal.

The figure is a flowchart illustrating a method for sensing the temperature of the susceptor 5110 according to a change in magnetic force of the susceptor 5110 when the susceptor 5110 is formed of a permanent magnet material.

When the susceptor 5110 is formed of a permanent magnet material, there is no need to induce magnetism in the susceptor 5110. That is, the first coil 5131 of the aerosol generator is used only for the purpose of heating the susceptor 5110.

Thus, for simplicity, the first coil 5131 will be referred to as a coil 5131.

In operation S1110, the controller 100 may inductively heat the susceptor 5110. The susceptor 5110 may be provided in an aerosol generating article or the aerosol generator 200. The aerosol generating article may be the cigarette illustrated above and the susceptor 5110 may be formed of a permanent magnetic material.

The controller 100 may control the alternating current supplied to the coil 5131. When alternating current is supplied to the coil 5131, the direction of the magnetic field formed inside the coil 5131 may change periodically. When the susceptor 5110 is exposed to an alternating magnetic field formed by the coil 5131, the susceptor 5110 may be inductively heated.

The controller 100 may control the temperature of the susceptor 5110 by varying the amplitude, frequency, or the like of the alternating current supplied to the coil 5131 according to a preset temperature profile.

In operation S1120, the magnetic force sensor may sense a change in magnetic force according to a change in temperature of the susceptor 5110.

In one embodiment, the magnetic force sensor may output a magnetic force value corresponding to the temperature of the susceptor 5110 as information such as a voltage.

In operation S1130, the controller 100 may calculate the temperature of the susceptor 5110 or acquire stored temperature information based on the magnetic force change information output by the magnetic force sensor.

For example, the controller 100 may acquire the temperature of the susceptor 5110 corresponding to the output value output by the magnetic force sensor from the lookup table stored in the storage 800.

As another example, the controller 100 acquire the magnetic force difference between a first magnetic force of the susceptor 5110 sensed at a first time after initiation of heating and a second magnetic force at a second time that is a preset time later than the first time.

The controller 100 may also acquire the temperature of the susceptor 5110 corresponding to the magnetic force difference from the lookup table stored in the storage 800.

Referring to this figure, when the susceptor 5110 is formed of a permanent magnet material, the susceptor 5110 has magnetism. Therefore, the controller 100 does not need to induce magnetism in the susceptor 5110.

In this case, the design of the aerosol generator 200 of the mobile communication terminal may be simpler, and the controller 100 of the mobile communication terminal may easily control the temperature of the aerosol generator 200.

In the embodiments in which the susceptor 5110 is limited to a permanent magnet, many design considerations may arise due to the electrical or mechanical properties of the permanent magnet. Therefore, when the susceptor 5110 of the aerosol generator 200 of the present disclosure is not formed of a permanent magnet material, the temperature of the susceptor 5110 may be measured by inducing magnetism in the susceptor 5110.

Hereinafter, embodiments of a method of measuring the temperature of the susceptor 5110 when the susceptor 5110 is not formed of a permanent magnet material will be described.

FIG. 49 is a diagram illustrating a relationship between a control period and intervals according to an example of controlling a susceptor of an aerosol generator.

The controller 100 may control the coil unit 5130 on a basis of a preset control period. Each control period may include a first interval for heating the susceptor 5110 and a second interval for inducing magnetism in the susceptor 5110.

The controller 100 may heat the susceptor 5110 in the first interval and calculate the temperature of the susceptor 5110 in the second interval.

The controller 100 may inductively heat the susceptor 5110 using only the first coil 5131 and induce magnetism in the susceptor 5110. Alternatively, the controller 100 may heat the susceptor 5110 using the first coil 5131 and induce magnetism in the susceptor 5110 using the second coil 5132.

A method of measuring the temperature of the susceptor 5110 by the controller 100 using only the first coil 5131, and a method of measuring the temperature of the susceptor 5110 using the first coil 5131 and the second coil 5132 are described in detail below.

FIG. 50 illustrates an example of controlling a susceptor when the coil unit of the aerosol generator is configured as a single coil unit.

Referring to FIG. 50, in operation S1310, the controller 100 may inductively heat the susceptor 5110 using the coil 5131 in the first interval. The inductive heating of the susceptor 5110 using the coil 5131 in the first interval may be the same as the inductive heating disclosed above. That is, the controller 100 may control the alternating current supplied to the coil 5131 in the first interval.

When alternating current is supplied to the coil 5131, the direction of the magnetic field formed inside the coil 5131 may change periodically. When the susceptor 5110 is exposed to an alternating magnetic field formed by the coil 5131, the susceptor 5110 may be inductively heated.

The susceptor 110 may be provided in a cigarette or the aerosol generator 200, which is an aerosol generating article.

The controller 100 may control the temperature of the susceptor 5110 by varying the amplitude, frequency, or the like of the alternating current supplied to the coil 5131 according to a preset temperature profile.

In operation S1320, the controller 100 may induce magnetism of the susceptor 5110 through the coil during the second interval.

The controller 100 may control the direct current supplied to the coil 5131 in the second interval. When the direct current is supplied to the coil 5131, a magnetic field may be formed outside the coil 5131. When the susceptor 5110 is exposed to the magnetic field, a magnetic moment reacts inside the susceptor 5110, and thus the susceptor 5110 may be magnetized.

In operation S1330, the magnetic force sensor may sense a change in magnetic force according to a change in temperature of the susceptor 5110 in the second interval.

The method of sensing the magnetic force of the susceptor 5110 in the second interval may be the same as the magnetic force sensing method disclosed above. That is, the magnetic force sensor may output a magnetic force value corresponding to the temperature of the susceptor 5110 in the form of voltage.

The first interval may be set to be longer than the second interval. In this case, the temperature of the susceptor 5110 may be accurately measured while minimizing the change in temperature of the susceptor 5110.

In operation S1340, the controller 100 may calculate the temperature of the susceptor 5110 based on the change in magnetic force.

The temperature calculation method of the controller 100 in the second interval may be the same as the temperature calculation method disclosed above. In other words, the controller 100 may acquire, from the lookup table stored in the storage 800, the temperature of the susceptor 5110 corresponding to the output value output by the magnetic force sensor. As another example, the controller 100 acquire the magnetic force difference between a first magnetic force of the susceptor 5110 sensed at a first time after initiation of heating and a second magnetic force at a second time that is a preset time later than the first time.

The controller 100 may also acquire the temperature of the susceptor 5110 corresponding to the magnetic force difference from the lookup table stored in the storage 800.

FIG. 51 illustrates an example of controlling a susceptor when the coil unit of the aerosol generator includes two or more coils.

This figure is a flowchart illustrating a method of measuring the temperature of the susceptor 5110 through the first coil 5131 and the second coil 5132.

In operation S1410, the controller 100 may inductively heat the susceptor 5110 using the first coil 5131 in the first interval. The method of inductive heating of the susceptor 5110 using the first coil 5131 in the first interval has been disclosed above. That is, the controller 100 may control the alternating current supplied to the first coil 5131 in the first interval.

When alternating current is supplied to the first coil 5131, the direction of the magnetic field formed inside the first coil 5131 may change periodically. When the susceptor 5110 is exposed to an alternating magnetic field formed by the first coil 5131, the susceptor 5110 may be inductively heated. The susceptor 110 may be provided in a cigarette or the aerosol generator 200.

The controller 100 may control the temperature of the susceptor 5110 by varying the amplitude, frequency, or the like of the alternating current supplied to the first coil 5131 according to a preset temperature profile.

In operation S1420, the controller 100 may induce magnetism in the susceptor 5110 using the second coil 5132 in the second interval.

The controller 100 may control the direct current supplied to the second coil 5132 in the second interval. At this time, the controller 100 may not supply power to the first coil 5131. When the direct current is supplied to the second coil 5132, a magnetic field may be formed outside the second coil 5132. When the susceptor 5110 is exposed to the magnetic field, a magnetic moment reacts inside the susceptor 5110, and thus the susceptor 5110 may be magnetized.

In operation S1430, the magnetic force sensor may sense a change in magnetic force according to a change in temperature of the susceptor 5110 in the second interval.

The method of sensing the magnetic force of the susceptor 5110 in the second interval is the same as that disclosed above. That is, the magnetic force sensor may convert a magnetic force value corresponding to the temperature of the susceptor 5110 into a voltage and output the voltage.

The first interval may be set to be longer than the second interval. This is intended to accurately measure the temperature of the susceptor 5110 while minimizing the change in temperature of the susceptor 5110.

In operation S1440, the controller 100 may calculate the temperature of the susceptor 5110 based on the change in magnetic force.

The temperature calculation method of the controller 100 in the second interval may be similar to that disclosed above. In other words, the controller 100 may acquire, from the lookup table stored in the storage 800, the temperature of the susceptor 5110 corresponding to the output value output by the magnetic force sensor.

As another example, the controller 100 acquire the magnetic force difference between a first magnetic force of the susceptor 5110 sensed at a first time after initiation of heating and a second magnetic force at a second time that is a preset time later than the first time.

The controller 100 may also acquire the temperature of the susceptor 5110 corresponding to the magnetic force difference from the lookup table stored in the storage 800.

As disclosed above, the magnetic force sensor may be provided separately in the aerosol generator, or may use the sensor of the mobile communication terminal or the magnetic sensor in the camera module.

FIG. 52 illustrates an embodiment of a mobile communication terminal capable of easily controlling the temperature and system of an aerosol generator.

To facilitate description of the embodiment, a block diagram is disclosed according to the logical configuration, and the disclosed blocks may correspond to the physical components disclosed above.

Referring to FIG. 52, a mobile communication terminal according to an embodiment may include a controller 100, an aerosol generator 200, a power supply unit 300, a sensor 500, and a storage 800.

Although not shown in this figure, a susceptor is included in the aerosol generator 200 or a cigarette coupled to the aerosol generator 200.

The coil unit of the aerosol generator 200 may include at least one coil. The coil unit may include a first coil and a second coil that are alternately wound or wound in different regions.

The power supply unit 300 may supply power to internal component blocks of the aerosol generator 200. The power supply unit 300 may provide direct current power, and a power converter (not shown) of the aerosol generator 200 may convert the direct current provided by the power supply unit 300 into alternating current and supply the alternating current to the aerosol generator 200. The aerosol generator 200 may heat the susceptor of the aerosol generator 200 by magnetic induction according to alternating current.

The controller 100 may control the power supplied to the coils of the aerosol generator 200.

For example, the controller 100 may heat the susceptor by controlling the alternating current supplied to the first coil. In another embodiment, the controller 100 may heat the susceptor by controlling the alternating current supplied to the first coil or induce magnetism in the susceptor by controlling the direct current supplied to the first coil.

In yet another embodiment, the controller 100 may heat the susceptor by controlling the alternating current supplied to the first coil, and induce magnetism in the susceptor by controlling the direct current supplied to the second coil.

When the controller 100 heats the susceptor of the aerosol generator 200 and induces magnetism, the magnetic force sensor or magnetic sensor of the sensor 500 may sense the change in magnetic force of the susceptor of the aerosol generator 200.

In an embodiment, the magnetic force sensor or magnetic sensor of the sensor 500 may be physically included in a complex sensor chip of a mobile communication terminal or may be included in a camera module.

The controller 100 may calculate the temperature of the susceptor of the aerosol generator 200 based on the change in magnetic force sensed by the magnetic force sensor or magnetic sensor. The relationship between the change in magnetic force of the susceptor and the temperature has been disclosed above.

The storage 800 may store matching data or a lookup table about the relationship between the change in magnetic force of the susceptor the change in magnetic force of the susceptor and the temperature.

The controller 100 may calculate the temperature of the susceptor based on the matching data and lookup table stored in the storage 800.

Hereinafter, another embodiment of sensing the temperature of the susceptor in the aerosol generator and controlling the system of the mobile communication terminal based on the temperature is disclosed.

FIG. 53 is a block diagram illustrating a mobile communication terminal including an aerosol generator. In the description below, redundant description of the above-described details will be omitted.

Referring to FIG. 53, the mobile communication terminal may include a controller 100, an aerosol generator 200, a power supply unit 300, a sensor 500, and an output unit 700.

As described above, the controller 100 may perform overall control operations related to the operation of the mobile communication terminal. Furthermore, the controller 100 may perform control operations related to aerosol generation by the aerosol generator 200. For example, the controller 100 may perform control operations such as controlling power applied to the aerosol generator 200 and back counting (or counting) a counter related to the aerosol generator 200. In addition, the controller may control the performance of the display module 710 configured to generate output related to visual, auditory, or tactile sensations and included in the output unit 700.

When a stick is accommodated, the aerosol generator 200 may generate an aerosol by heating the stick as described above. In regards to heating the stick, the aerosol generator 200 may include an external inductive heater, and an internally inserted inductive heater as described above with reference to FIGS. 4 to 27. In particular, the aerosol generator 200 may perform operations related to generation of the aerosol based on the external inductive heater described above with reference to FIGS. 4 to 17 that inductively heats the susceptor included in the stick.

The power supply unit 300 may include a rechargeable battery capable of supplying DC power to the mobile communication terminal. The power supply unit 300 may be electrically connected to the aerosol generator 200 to supply DC power to the aerosol generator 200.

As described above, the sensor 500 may include one or more sensors configured to sense at least one of information in the mobile communication terminal, information about the surrounding environment around the mobile communication terminal, and user information. The sensor 500 may also include a sensor capable of sensing voltage, current, or the like to the components included in the mobile communication terminal.

As described above, when the aerosol generator 200 is based on an external inductive heater, it is difficult to directly measure the temperature of the physically separated susceptor. Accordingly, the controller 100 needs to estimate the temperature of the susceptor using an indirect temperature measurement method in order to control the power to the aerosol generator 200.

Specifically, the controller 100 may estimate the temperature of the susceptor by considering the relationship between the equivalent resistance and temperature of the susceptor. To this end, the sensor 500 may be configured to generate first load information by separately sensing current, voltage, and power to the aerosol generator 200 among the components included in the mobile communication terminal. In this case, the controller 100 may acquire the first load information from the sensor 500 and indirectly estimate the temperature of the susceptor by estimating the equivalent resistance of the susceptor based on the first load information. The controller 100 may control the power applied to the aerosol generator 200 based on the estimated temperature of the susceptor.

Alternatively, the mobile communication terminal or the controller 100 may measure or estimate the temperature of the susceptor or the aerosol generator 200 by further considering at least one of a change in resonant frequency (see FIGS. 36 to 45), a change in magnetism (see FIGS. 46 to 52), and a change in the characteristic of the susceptor (see FIGS. 57 to 60). Alternatively, for example, the controller 100 may directly measure or estimate the temperature of the susceptor or the aerosol generator 200 via a sensor (included in the sensor) configured to sense the temperature of the included display module 710. Alternatively, the controller 100 may measure or estimate the temperature of the susceptor or the aerosol generator 200 based on at least one of a change in the resonant frequency (see FIGS. 36 to 45), a change in magnetism (see FIGS. 46 to 52), an equivalent resistance (see FIGS. 53 to 56), and a change in the characteristic of the susceptor (see FIGS. 57 to 60) calculated or sensed by the sensor 500.

Alternatively, the mobile communication terminal or the controller 100 may control the performance of the display module 710 based on the estimated or measured temperature of the susceptor or the aerosol generator 200 and/or the temperature of the display module (see FIGS. 61 to 65). For example, the mobile communication terminal may estimate second temperature information based on the equivalent resistance or change in equivalent resistance of the susceptor or the aerosol generator 200, and control the performance of the display module based on the estimated second temperature information and the first temperature information measured for the display module 710.

Alternatively, the display module 710 may include a flexible display including a first region that contacts a first surface of the aerosol generator 200 (see FIGS. 66 to 78). The first region of the flexible display may be deformed into a curved surface when a stick is sensed to be accommodated in the aerosol generator 200. Further, as described above, in response to the change of the first region to the curved surface, the mobile communication terminal or the controller 100 may calculate an equivalent resistance (or, a change in magnetism or a change in resonant frequency) of the aerosol generator 200 or the susceptor, and estimate the temperature of the susceptor.

Alternatively, the mobile communication terminal may further include a heat pipe that is internally vacuumed and contains a fluid (see FIGS. 79 to 83). One region of the heat pipe may be connected to the first region of the aerosol generator, and another region of the heat pipe may be connected to a second region of the mobile communication terminal. The controller 100 may predict a change in temperature of the aerosol generator 200 by further considering the thermal conductivity according to the heat pipe, and may control the power to the aerosol generator 200 or control the performance of the display module 710 based on the predicted change in temperature.

Alternatively, the mobile communication terminal may include an antenna provided with a patch formed of a conductor and a ground spaced apart from the patch. The antenna may be coupled to the aerosol generator and disposed on the body of the aerosol generator (see FIGS. 28 to 35).

Hereinafter, a method of estimating, by the controller 100, the equivalent resistance of the susceptor for estimating the temperature of the susceptor will be described in detail.

FIG. 54 is a diagram illustrating an aerosol generator based on an external inductive heating method.

Referring to FIG. 54, the aerosol generator 200 may include a DC/AC converter 6011, an impedance matcher 6013, and an inductor 6015.

The aerosol generator may receive DC and/or DC power from a DC power source 6019, and convert the DC into AC through the DC/AC converter 6011. Here, the DC power source 6019 may be the power supply unit 300 included in the mobile communication terminal. The AC may be applied to the inductor 6015 after impedance matching through the impedance matcher (or transformer) 6013. The inductor 6015 may generate an alternating magnetic field whose polarity changes according to the frequency of the AC when the AC is applied. The alternating magnetic field may generate heat in the susceptor 6017 included in the stick. Here, the inductor 6015 may be in the form of a spirally wound cylindrical coil, but is not limited thereto. It may be composed of various types of coils capable of generating the alternating magnetic field.

The stick may include an aerosol generating material and a susceptor 6017. The susceptor 6017 may include a conductor that may be inductively heated by the inductor 6015. Specifically, the susceptor 6017 may include a conductor from which heat is generated by the alternating magnetic field generated by the inductor 6015. For example, the conductor may include stainless steel or the like from which heat is generated by the alternating magnetic field. The susceptor 6017 may have various shapes such as rectangular, circular, and oval shapes. The heat generated by inductive heating of the susceptor 6017 is transferred to the aerosol generating material included in the stick, and an aerosol may be generated from the material by the transferred heat.

As described above, the sensor may generate the first load information described above by measuring the voltage of the DC power source and the DC applied to the DC/AC converter 6011 or the aerosol generator. For example, the sensor may sense the DC and DC voltage applied to the aerosol generator through electrical connection with the DC power source and/or the DC/AC converter 6011.

The controller may receive the first load information from the sensor and calculate the equivalent resistance for the aerosol generator based on the first load information. The controller may control the DC/AC converter 6011 of the aerosol generator to control the power applied to the aerosol generator based on the calculated equivalent resistance.

Hereinafter, the equivalent resistance that the controller calculates based on the first load information will be described in more detail.

FIG. 55 is a diagram illustrating an equivalent resistance of an aerosol generator accommodating a stick including a susceptor.

Referring to FIG. 55, the equivalent resistance R_{T} for the aerosol generator may correspond to the sum of a first resistance RTL of the inductor and a second resistance R_{TS} of the susceptor. Here, the resistance of the DC/AC converter described with reference to FIG. 55 may have a negligibly low resistance compared to the resistance of the susceptor and inductor. Here, the second resistance R_{TS} of the susceptor may vary with temperature.

For example, the second resistance R_{TS} of the susceptor may increase in response to an increase in the temperature of the susceptor, or may decrease in response to a decrease in the temperature of the susceptor. Since the second resistance R_{TS} of the susceptor changes according to the change in temperature, the equivalent resistance R_{T} including the second resistance R_{TS} of the susceptor may also change with the temperature. In this case, the temperature of the susceptor corresponding to the equivalent resistance R_{T} may have a single value. The equivalent resistance R_{T} and the temperature of the susceptor may have a relationship of a monotonic function with each other. That is, since the equivalent resistance R_{T} and the temperature of the susceptor are in a one-to-one relationship, a lookup table for the correspondence between the equivalent resistance R_{T} and the temperature of the susceptor may be pre-configured by pre-analyzing the correspondence between the equivalent resistance R_{T} and the temperature of the susceptor. In this case, the controller may estimate the temperature of the susceptor corresponding to the calculated equivalent resistance based on the correspondence between the predefined equivalent resistance R_{T} and the temperature of the susceptor.

Hereinafter, a detailed description will be given of a method of controlling the power to the aerosol generator by the controller based on the correspondence between the temperature and the equivalent resistance R_{T} of the susceptor described above.

FIG. 56 is a flowchart illustrating a method of controlling the power of the aerosol generator based on the equivalent resistance calculated by a controller.

Referring to FIG. 56, the controller may sense or monitor whether a stick is accommodated in the aerosol generator (S6501). For example, the controller may sense whether the stick is accommodated in the aerosol generator based on an optical sensor, a pressure sensor, or the like included in the aerosol generator.

When a stick is accommodated in the aerosol generator, the controller may start applying power to the aerosol generator and acquire first load information from the sensor (S6503). Here, the first load information may include information about the voltage applied to the aerosol generator and the current to the aerosol generator, as described above. As described above, the voltage and/or current included in the first load information may be DC voltage and/or DC.

The controller may calculate the equivalent resistance for the aerosol generator based on the first load information (S6505). For example, the controller may calculate the equivalent resistance for the aerosol generator based on the relationship between the voltage and current included in the first load information according to Ohm's law. For example, the controller may calculate the equivalent resistance based on a value obtained by dividing the voltage by the current. As described above, the equivalent resistance may increase or decrease with the change in temperature of the susceptor. For example, when the temperature of the susceptor increases, the equivalent resistance may increase. When the temperature of the susceptor decreases, the equivalent resistance may decrease. The controller may calculate the equivalent resistance based on the rate of change of voltage.

Additionally, the controller may acquire the first load information from the sensor periodically or aperiodically, and calculate a change value of the equivalent resistance based on the first load information acquired periodically or aperiodically. In this case, the controller may estimate whether the temperature of the susceptor has increased or decreased, based on the change value of the equivalent resistance. For example, if the change value of the equivalent resistance is negative, the controller may estimate that the temperature of the susceptor has decreased. If the change value of the equivalent resistance is positive, the controller may estimate that the temperature of the susceptor has decreased.

The controller may control the power or amount of power applied to the aerosol generator based on the equivalent resistance calculated based on the first load information (S6507). Specifically, the controller may estimate the temperature of the susceptor corresponding to the calculated equivalent resistance based on the correspondence between the predefined equivalent resistance and the temperature of the susceptor (e.g., a preconfigured lookup table) as described above. In this case, the controller may determine whether the estimated temperature of the susceptor reaches a first threshold temperature. When the estimated temperature of the susceptor reaches or exceeds the first threshold temperature, the controller may stop applying power to the aerosol generator. Alternatively, when the estimated temperature of the susceptor reaches or exceeds the first threshold temperature, the controller may apply a preset minimum amount of power to the aerosol generator.

Thereafter, the controller may continuously (or periodically) calculate the equivalent resistance based on the first load information, and may increase the amount of power applied to the aerosol generator (or resume power application) based on the change value of the equivalent resistance or reduce the amount of power applied to the aerosol generator. Thereby, the controller may maintain the temperature of the susceptor within a certain range from the first threshold temperature. Alternatively, the controller may calculate a temperature change value that is the difference between the temperature of a susceptor corresponding to a first equivalent resistance calculated at a first time and the temperature of a susceptor corresponding to a second equivalent resistance calculated at a second time (a time immediately following the first time) based on the first load information acquired periodically or aperiodically. In this case, the controller may increase or decrease the amount of power applied to the aerosol generator based on the temperature change value.

For example, the controller may control the amount of power applied to the aerosol generator by adjusting the cycle (switching cycle) of the DC/AC converter included in the aerosol. For example, if the change value of the equivalent resistance is negative, the controller may increase the power applied to the aerosol generator by decreasing the cycle of the DC/AC converter (increasing the AC frequency). If the change value of the equivalent resistance is positive, the power applied to the aerosol generator may be reduced by increasing the cycle of the DC/AC converter (reducing the AC frequency).

Also, the controller may perform control operations related to the aerosol generator based on the equivalent resistance. Specifically, the controller may back-off count (or count) the counter value of the counter related to the aerosol generator based on the change value of the equivalent resistance. Here, the counter value may be set to a default value of the maximum number of times that the aerosol generator may generate an aerosol (or the maximum number of puffs) after receiving the stick. For example, when the change value of the equivalent resistance is greater than or equal to a first threshold change value, the controller may back-off count the counter value of the counter by 1. Further, the first threshold change value may be a value preset based on the amount of decrease in the equivalent resistance of the aerosol generator (or the amount of decrease in the temperature of the susceptor) that is reduced by the inflow of external air in response to the inhalation of the aerosol by the user of the mobile communication terminal or the aerosol generator. For example, when the temperature of the susceptor is reduced by a first temperature on average in response to the introduction of outside air, the first threshold change value may be preset as an amount of change in the equivalent resistance corresponding to the decrease by the first temperature, or as a value corresponding to the first temperature.

The controller may output the back-off counted counter value through the above-described display module. Additionally, when the counter value of the counter becomes 0, the controller may stop applying power to the aerosol generator and initialize or reset the counter value of the counter to an initial value.

Alternatively, the controller may acquire first temperature information about the display module from the sensor, and determine an increase rate and/or decrease rate of the power applied to the aerosol generator based on the first temperature information. For example, the rate of increase of the amount of power when the first temperature information is higher than or equal to a predetermined threshold temperature may be preset to be lower than the rate of increase of the amount of power when the first temperature information is lower than the predetermined threshold temperature. Alternatively, the rate of decrease of the amount of power when the first temperature information is higher than or equal to the predetermined threshold temperature may be preset to be higher than the rate of decrease of the amount of power when the first temperature information is lower than the predetermined threshold temperature. In this case, when the first temperature information is higher than or equal to the predetermined threshold temperature, the controller may increase the amount of power at a slower rate or decrease the amount of power at a faster rate as compared to when the first temperature information is lower than the predetermined threshold temperature, so as to delay the increase of the temperature of the display module to the maximum allowable temperature as much as possible, as described above. Here, the predetermined threshold temperature may be set to a temperature that is lower than the maximum allowable temperature, but at which the first temperature information (or the temperature of the display module) is likely to reach the maximum allowable temperature within a predefined first time interval due to the temperature of the susceptor. For example, the first time interval may be determined based on an average operating time from the time the stick is received in the aerosol generator until the generation of the aerosol is terminated, or a preset duration.

Alternatively, the controller may limit the performance of a mobile communication terminal including the aerosol generator when a stick is accommodated in the aerosol generator. For example, when a stick is accommodated in the aerosol generator, the controller may switch the mobile communication terminal to a standby mode (e.g., a terminal mode having minimum standby power by turning off the display of the display module), thereby minimizing the power consumption of the internal components of the mobile communication terminal. In this case, the internal equivalent resistance of the mobile communication terminal (internal equivalent resistance excluding the equivalent resistance of the aerosol generator) may be kept constant. Accordingly, the controller may sense a change in equivalent resistance of the susceptor according to a change in temperature of the susceptor based on the equivalent resistance for the mobile communication terminal, and may estimate the temperature of the susceptor based on the sensed change.

Hereinafter, another embodiment will be described in which the temperature of the susceptor in the aerosol generator can be sensed and used to control the system of the mobile communication terminal.

FIG. 57 is a block diagram illustrating a mobile communication terminal including an aerosol generator. In the description below, redundant description of the above-described details will be omitted.

Referring to FIG. 57, the mobile communication terminal may include a controller 100, an aerosol generator 200, a power supply unit 300, a sensor 500, and an output unit 700.

As described above, the controller 100 may perform overall control operations related to the operation of the mobile communication terminal. Furthermore, the controller 100 may perform control operations related to aerosol generation by the aerosol generator 200. For example, the controller 100 may perform control operations such as controlling power applied to the aerosol generator 200 and back counting (or counting) a counter related to the aerosol generator 200. In addition, the controller may control the performance of the output unit 700, including the display module 710, configured to generate output related to visual, auditory, or tactile sensations.

When a stick is accommodated, the aerosol generator 200 may generate an aerosol by heating the stick as described above. In regards to heating the stick, the aerosol generator 200 may include an external inductive heater, and an internally inserted inductive heater as described above with reference to FIGS. 4 to 27. In particular, the aerosol generator 200 may perform operations related to generation of the aerosol based on the external inductive heater described above with reference to FIGS. 4 to 17 that inductively heats the susceptor included in the stick.

The power supply unit 300 may include a rechargeable battery capable of supplying DC power to the mobile communication terminal. The power supply unit 300 may be electrically connected to the aerosol generator 200 to supply DC power to the aerosol generator 200.

As described above, the sensor 500 may include one or more sensors configured to sense at least one of information in the mobile communication terminal, information about the surrounding environment around the mobile communication terminal, and user information. The sensor 500 may further include a characteristic change detection sensor 6801 configured to sense a change in magnetism related to the aerosol generator 200 or the susceptor included in the stick. Alternatively, the characteristic change detection sensor 6801 may measure or estimate a power loss related to the aerosol generator 200 based on the voltage and current related to the aerosol generator 200, and sense a change in magnetism related to the susceptor based on the estimated power loss.

Even if the susceptor of the stick accommodated in the aerosol generator 200 based on the external inductive heater is physically separated from the aerosol generator 200, the controller 100 may measure or estimate the temperature of the susceptor indirectly in a certain way using the characteristic change detection sensor 6801. For example, as will be described later, the controller 100 may estimate the temperature of the susceptor by sensing a change in a characteristic (change in magnetism and/or change in power loss) related to the susceptor due to a change in the temperature of the susceptor, and control the power applied to the aerosol generator 200 based on the estimated temperature of the susceptor.

Alternatively, the mobile communication terminal or the controller 100 may measure or estimate the temperature of the susceptor or the aerosol generator 200 by further considering at least one of a change in resonant frequency (see FIGS. 36 to 45), a change in magnetism (see FIGS. 46 to 52), and an equivalent resistance (see FIGS. 53 to 56). Alternatively, for example, the controller 100 may directly measure or estimate the temperature of the susceptor or the aerosol generator 200 via a sensor (included in the sensor) configured to sense the temperature of the included display module 710. Alternatively, the controller 100 may measure or estimate the temperature of the susceptor or the aerosol generator 200 based on at least one of a change in the resonant frequency (see FIGS. 36 to 45), a change in magnetism (see FIGS. 46 to 52), an equivalent resistance (see FIGS. 53 to 56), and a change in the characteristic of the susceptor (see FIGS. 57 to 60) calculated or sensed by the sensor 500.

Alternatively, the mobile communication terminal or the controller 100 may control the performance of the display module based on the estimated or measured temperature of the susceptor or the aerosol generator 200 and/or the temperature of the display module (see FIGS. 61 to 65). For example, the mobile communication terminal may estimate second temperature information based on a change in magnetism or characteristic of the susceptor, and control the performance of the display module 710 based on the estimated second temperature information and the first temperature information measured for the display module.

Alternatively, the display module 710 may include a flexible display including a first region that contacts a first surface of the aerosol generator 200 (see FIGS. 66 to 78). The first region of the flexible display may be deformed into a curved surface when a stick is sensed to be accommodated in the aerosol generator 200. Further, as described above, in response to the change of the first region to the curved surface, the mobile communication terminal or the controller 100 may sense a change in characteristic or magnetism (or a change in equivalent resistance, magnetism, or resonant frequency) of the susceptor, and determine that the susceptor has reached a specific temperature.

Alternatively, the mobile communication terminal may further include a heat pipe, which is internally vacuumed and contains a fluid (see FIGS. 79 to 83). One region of the heat pipe may be connected to the first region of the aerosol generator, and another region of the heat pipe may be connected to a second region of the mobile communication terminal. The controller 100 may predict a change in temperature of the aerosol generator 200 by further considering the thermal conductivity according to the heat pipe, and may control the power to the aerosol generator 200 or control the performance of the display module 710 based on the predicted change in temperature.

Alternatively, the mobile communication terminal may include an antenna provided with a patch formed of a conductor and a ground spaced apart from the patch. The antenna may be coupled to the aerosol generator and disposed on the body of the aerosol generator (see FIGS. 28 to 35).

Hereinafter, an embodiment of a method of sensing a change in characteristic of the susceptor (or a change in magnetism of the susceptor) will be described in detail.

FIG. 58 is a diagram illustrating how an aerosol generator inductively heats a susceptor included in a stick.

Referring to FIG. 58, the aerosol generator 200 may include a DC/AC converter 6711, an impedance matcher 6713, and an inductor 6715.

The aerosol generator 200 may receive DC and/or DC power from a DC power source 6719, and convert the DC into AC through the DC/AC converter 6711. Here, the DC power source 6719 may be the power supply unit 300 included in the mobile communication terminal. The AC may be applied to the inductor 6715 after impedance matching through the impedance matcher (or transformer) 6713. The inductor 6715 may generate an alternating magnetic field whose polarity changes according to the frequency of the AC when the AC is applied. The alternating magnetic field may generate heat in the susceptor 6717 included in the stick. Here, the inductor 6715 may be in the form of a spirally wound cylindrical coil, but is not limited thereto. It may be composed of various types of coils capable of generating the alternating magnetic field.

The susceptor 6717 may be adjacent to a material capable of generating an aerosol and be included in a stick. The susceptor 6717 is physically separated from the inductor 6715. The susceptor 6717 may be inductively heated by an alternating magnetic field generated by the inductor 6715. For example, the susceptor 6717 may include a conductor such as stainless steel from which heat is generated by the alternating magnetic field generated by the inductor 6715. The susceptor 6717 may have various shapes such as rectangular, circular, and oval shapes.

Further, the susceptor 6717 may include a ferromagnetic material or ferromagnetic materials whose magnetism changes from ferromagnetic to paramagnetic when heated to a specific temperature (or Curie temperature). In this case, the susceptor 6717 may lose its ferromagnetic properties and have paramagnetic properties when heated to the specific temperature. Here, the specific temperature may be an optimal temperature suitable for the material capable of generating the aerosol to generate the aerosol. Further, when the susceptor 6717 is heated to the specific temperature, the power loss may be significantly reduced to a level below a predetermined level due to a change in the magnetism of the susceptor 6717.

FIG. 59 is a diagram illustrating how a characteristics change sensor senses a change in characteristic of a susceptor.

Referring to FIG. 59, the mobile communication terminal may include a characteristic change detection sensor 6801 and an aerosol generator 200. Here, the characteristic change detection sensor 6801 may be disposed at a position to sense the magnetism of the susceptor 6810, and may be included in the aerosol generator 200 if necessary.

The aerosol generator 200 may include an inductor 6820. The aerosol generator 200 may accommodate a stick including the susceptor 6810. The inductor 6820 may include a coil wound around the outer lateral surface of the accommodation space along the longitudinal direction of the aerosol generator 200. When an alternating current is applied to the inductor 6831, the inductor 6831 may generate an alternating magnetic field to heat the susceptor 6810.

The magnetism of the susceptor 6810 included in the stick may change from ferromagnetic to paramagnetic when the susceptor 6810 is heated above a specific temperature, or may change from paramagnetic to ferromagnetic when cooled below the specific temperature. Further, the susceptor 6810 may experience a sharp increase or decrease in power loss due to a change in the magnetism. For example, when the susceptor 6810 is heated above the specific temperature and the magnetism changes from ferromagnetic to paramagnetic, the power loss of the susceptor 6810 may decrease significantly. On the other hand, when the susceptor 6810 is cooled below the specific temperature and the magnetism changes from paramagnetic to ferromagnetic, the power loss of the susceptor 6810 may increase significantly.

The characteristic change detection sensor 6801 may transmit information about the sensed change in the magnetism of the susceptor 6810 to the controller 100 based on the change in the magnetism of the susceptor 6810. For example, when the magnetism of the susceptor 6810 sensed at a first time is not sensed at a second time, which is the next sensing time (e.g., because the susceptor 6810 is heated above a specific temperature), the characteristic change detection sensor 6801 may transmit first information about the change in magnetism of the susceptor 6810 to the controller 100. In this case, the controller 100 may determine that the magnetism of the susceptor has changed from ferromagnetic to paramagnetic based on the first information. Alternatively, when the magnetism of the susceptor 6810 not sensed after the second time (e.g., because the susceptor 6810 is cooled below the specific temperature) is sensed again at a third time, the characteristic change detection sensor 6801 may transmit second information about the change in magnetism of the susceptor to the controller 100. In this case, the controller 100 may determine that the magnetism of the susceptor has changed from paramagnetic to ferromagnetic. The characteristic change detection sensor 6801 may be a geomagnetic field sensor included in the mobile communication terminal. Alternatively, the characteristic change detection sensor 6801 may provide only the first information between the first information and the second information to the controller 100.

Alternatively, the characteristic change detection sensor 6801 may transmit information about whether the magnetism of the susceptor 6810 has changed to the controller 100 based on the power loss measured for the susceptor 6810 or the aerosol generator 200. For example, when the measured power loss for the susceptor 6810 or the aerosol generator 200 is reduced by a preset magnitude or more, the characteristic change detection sensor 6801 may transmit the first information about the change in magnetism of the susceptor 6810 to the controller 100. Alternatively, when the measured power loss for the susceptor 6810 or the aerosol generator 200 increases above the preset magnitude, the characteristic change detection sensor 6801 may transmit the second information about the change in the magnetism of the susceptor 6810 to the controller100.

Hereinafter, an embodiment will be described in detail in which the controller 100 estimates the temperature of the susceptor 6810 based on the first information and the second information of the characteristic change detection sensor 6801, and controls the power of the aerosol generator 200 based on the estimated temperature of the susceptor 6810.

FIG. 60 is a diagram illustrating a method of controlling power to the aerosol generator by a controller based on an estimated temperature of the susceptor.

Referring to FIG. 60, the controller may sense whether a stick is accommodated in the aerosol generator (S6901). When the controller senses the stick accommodated in the aerosol generator, it may start applying power to the aerosol generator to inductively heat the susceptor.

Next, the controller may estimate the temperature of the susceptor based on the information acquired from the characteristic change sensor (S6903). Specifically, the controller may receive first information from the characteristic change sensor when the magnetism of the susceptor changes from ferromagnetic to paramagnetic. In this case, the controller may estimate that the temperature of the susceptor is a specific temperature (or Curie temperature) or higher than the specific temperature based on the first information. Alternatively, the controller may receive second information from the characteristic change sensor when the magnetism of the susceptor changes from paramagnetic to ferromagnetic. In this case, the controller may estimate that the temperature of the susceptor is lower than a specific temperature (or Curie temperature) based on the second information.

Next, the controller may control power to the aerosol generator based on the estimated temperature of the susceptor (S6905). Specifically, the controller may estimate that the temperature of the susceptor has reached the first temperature or Curie temperature based on the first information. In this case, the controller may stop applying power to the aerosol generator (or reduce the amount of power applied). That is, the controller may cool the susceptor by stopping power to the aerosol generator. Alternatively, the controller may estimate that the temperature of the susceptor is lower than the second temperature or the Curie temperature based on the second information. In this case, the controller may resume applying power to the aerosol generator (or increase the amount of power) to heat the susceptor to the specific temperature or above the specific temperature. In this way, the controller may maintain the temperature of the susceptor within a specific range from the specific temperature or Curie temperature.

Alternatively, the controller may control power to the aerosol generator based on the first information received from the characteristic change sensor. In other words, the controller may receive only the first information between the first information and the second information from the characteristic change sensor. For example, the controller may estimate that the temperature of the susceptor is higher than or equal to the specific temperature based on the first information and stop applying power to the aerosol generator. In this case, the controller may stop applying power for a preset time, and resume applying power to the aerosol generator when the preset time elapses. Here, the preset time may be set based on temperature information about the display module included in the mobile communication terminal. In contrast, for example, when the temperature of the display module is lower than a first threshold temperature, the preset time may be set to a time set as a default value. When the temperature of the display module is higher than the first threshold temperature, the preset time may be set or adjusted to a value less than the default value.

Alternatively, the controller may back-off count the counter value of the counter related to the aerosol generator based on sensing a change in magnetism of the susceptor. For example, when the controller receives the second information from sensing of the characteristic change, it may back-off count the counter value of the counter by 1. Further, the controller may output the back-off counted counter value using the display module described above.

FIG. 61 is a block diagram schematically illustrating an embodiment of a mobile communication terminal including an aerosol generator. In the description below, redundant description of the above-described details will be omitted.

Referring to FIG. 61, the mobile communication terminal may include a controller 100, an aerosol generator 200, an output unit 700, and a sensor 500.

The output unit 700 may include a display module 710 and be configured to generate output related to visual, auditory, or tactile sensations. The sensor 500 may include an environmental sensor capable of generating first temperature information by sensing the temperature of the display module 710.

The controller 100 may acquire first temperature information including the sensed temperature of the display module 710 using the sensor 500. The controller 100 may control the performance of the display module 710 based on the first temperature information. Here, the performance of the display module 710 may be related to brightness, frame rate, resolution, etc.

For example, the controller 100 may decrease or increase the performance of the display module 710 based on the first temperature information. Here, decreasing the performance of the display module 710 may be decreasing the brightness, the frame rate, or the resolution. Increasing the performance of the display module 710 may be increasing the brightness, the frame rate, or the resolution. The controller 100 may prevent the temperature of the display module 710 from rising to a maximum allowable temperature of the display module 710 by controlling the performance of the display module 710 based on the first temperature information. Here, the maximum allowable temperature may be the maximum temperature at which the display module 710 can operate normally. Alternatively, control parameters related to the performance of the display module 710 corresponding to the first temperature information may be preset. For example, a lookup table mapping the control parameters corresponding to the first temperature information may be pre-stored in the mobile communication terminal, and the controller 100 may control the performance of the display module 710 using the control parameters for the performance corresponding to the first temperature information based on the lookup table.

Alternatively, the controller 100 may additionally consider the second temperature information measured for the aerosol generator 200 as temperature information for controlling the performance of the display module 710 based on whether a stick is accommodated in the aerosol generator 200. For example, when the stick is not accommodated in the aerosol generator 200, the controller 100 may control the performance of the display module 710 based on the first temperature information about the display module 710 from the sensor 500. On the other hand, when the stick is accommodated in the aerosol generator 200, the performance of the display module 710 may be controlled by further considering the second temperature information about the aerosol generator 200 acquired from the sensor 500. Here, the second temperature information is temperature information about the aerosol generator 200 and may include, more specifically, an airflow pass temperature for the airflow introduced into and discharged from the aerosol generator 200.

Alternatively, the electrical connection for temperature sensing between the sensor 500 and the display module 710 and/or the aerosol generator 200 may be turned on/off under the control of the controller 100. For example, when the stick is not accommodated in the aerosol generator 200, the electrical connection for temperature sensing between the sensor 500 and the display module 710 may be turned off and the electrical connection for temperature sensing between the sensor 500 and the aerosol generator 200 may be turned off. In contrast, when the stick is accommodated in the aerosol generator 200, the electrical connection for temperature sensing between the sensor 500 and the aerosol generator 200 may be turned on.

Alternatively, the mobile communication terminal or the controller 100 may measure or estimate the temperature of the susceptor or the aerosol generator by further considering at least one of a change in resonant frequency (see FIGS. 36 to 45), a change in magnetism (see FIGS. 46 to 52), an equivalent resistance (see FIGS. 53 to 56), and a change in characteristic of the susceptor (see FIGS. 57 to 60). For example, the controller 100 may measure or estimate the temperature of the susceptor or the aerosol generator 200 based on at least one of a change in the resonant frequency (see FIGS. 36 to 45), a change in magnetism (see FIGS. 46 to 52), an equivalent resistance (see FIGS. 53 to 56), and a change in the characteristic of the susceptor (see FIGS. 57 to 60) calculated or sensed by the sensor 500.

Alternatively, the display module 710 may include a flexible display including a first region that contacts a first surface of the aerosol generator 200 (see FIGS. 66 to 78). The first region of the flexible display may be deformed into a curved surface when a stick is sensed to be accommodated in the aerosol generator 200. Further, as described above, in response to the change of the first region to the curved surface, the mobile communication terminal or the controller 100 may start measuring second temperature information about the aerosol generator 200.

Alternatively, the mobile communication terminal may further include a heat pipe, which is internally vacuumed and contains a fluid (see FIGS. 79 to 83). One region of the heat pipe may be connected to the first region of the aerosol generator, and another region of the heat pipe may be connected to a second region of the mobile communication terminal. The controller 100 may predict a change in temperature of the aerosol generator 200 by further considering the thermal conductivity according to the heat pipe, and may control the power to the aerosol generator 200 or control the performance of the display module 710 based on the predicted change in temperature.

Alternatively, the mobile communication terminal may include an antenna provided with a patch formed of a conductor and a ground spaced apart from the patch. The antenna may be coupled to the aerosol generator and disposed on the body of the aerosol generator (see FIGS. 28 to 35).

Hereinafter, an embodiment of a method of controlling the performance of the display module 710 based on temperature information acquired by the controller 100 based on whether a stick is accommodated in the aerosol generator 200 will be described in detail.

FIGS. 62 and 63 illustrate a method of controlling the performance of a display module by a controller based on whether a stick is accommodated in the aerosol generator.

Referring to FIG. 62, the controller may sense whether a stick is accommodated in the aerosol generator (S6101). Whether the stick is accommodated may be sensed based on a pressure sensor, an optical sensor, or the like included in the aerosol generator.

Based on the stick not being sensed by the aerosol generator, the controller may acquire first temperature information by controlling the sensor (S6103). Here, the first temperature information may include a temperature measured for the display module as described above.

The controller may control the performance of the display module based on the first temperature information (S6104). For example, based on the first temperature information including the first value, the controller may control the performance of the display module with a first performance corresponding to the first value (or preset control parameters corresponding to the first performance). Based on the first temperature information including the second value, the controller may control the performance of the display module with a second performance corresponding to the second value (or preset control parameters corresponding to the second performance). In this case, when the second value is greater than the first value, the second performance may be lower than the first performance. For example, the resolution and/or frame rate of the display module according to the second performance may be lower than the resolution and/or frame rate of the display module according to the first performance.

For example, referring to FIG. 63-(a), the controller may acquire the first temperature information including the second value (TP2) at a first time, and may control the performance of the display module to have a frame rate (1/T1) according to the second performance corresponding to the second value (TP2). At a second time, which is later than the first time, the controller may acquire the first temperature information including the first value (TP1), which is less than the second value (TP2), and may control the performance of the display module to have a frame rate (1/T2) according to the first performance corresponding to the first value (TP1). In this case, the performance of the display module is increased as T2 is less than T1.

Alternatively, referring to FIG. 63-(b), the controller may acquire the first temperature information including the second value (TP2) at a first time, and may control the performance of the display module to have a first resolution according to the second performance corresponding to the second value (TP2). At a second time, which is later than the first time, the controller may acquire the first temperature information including the first value (TP1), which is less than the second value (TP2), and may control the performance of the display module to have a second resolution according to the first performance corresponding to the first value (TP1). Here, the second resolution is higher than the first resolution. Additionally, the controller may control the performance of the display module by controlling the resolution and frame rate of the display module simultaneously based on the first temperature information.

Based on the stick being sensed to be accommodated in the aerosol generator, the controller may acquire a first temperature information and second temperature information by controlling the sensor (S6105). As described above, the sensor may be configured to sense not only the temperature of the display module but also the temperature of the aerosol generator. The controller may control the sensor to acquire the second temperature information in response to sensing the stick accommodated in the aerosol generator. Alternatively, the controller may acquire only the second temperature information from the sensor.

Then, the controller may control the performance of the display module based on the first temperature information and the second temperature information (S6106).

Specifically, the controller may correct the first temperature information based on the second temperature information and control the performance of the display module based on the corrected first temperature information. For example, considering the temperature difference between the first temperature information and the second temperature information, the thermal conductivity between the display module and the aerosol generator, and the like, an expected temperature increment related to the first temperature information according to the temperature difference may be predefined. For example, a second lookup table in which the expected temperature increment is defined for the temperature difference may be preconfigured. The controller may correct the first temperature information to further reflect the expected temperature increment determined based on the second lookup table, and control the performance of the display module based on the corrected first temperature information. Alternatively, the second lookup table may have a temperature increase rate predefined instead of the expected temperature increment according to the temperature difference.

In other words, when a stick is accommodated in the aerosol generator, the controller may control the performance of the display module based on the first temperature information corrected to reflect an expected temperature increment determined based on the temperature difference between the first temperature information and the second temperature information, rather than the current first temperature information about the display module.

For example, when the first temperature information includes the first value and the second temperature information includes the second value, the controller may calculate a first temperature difference, which is the difference between the first value and the second value, and determine an expected temperature increment corresponding to the first temperature difference (based on the second lookup table). The controller may correct the first value to a third value by reflecting the expected temperature increment in the first value, and may control the performance of the display module based on the third value (or the temperature corresponding to the third value). For example, the controller may control the performance of the display module based on a first performance corresponding to the first value when no stick is accommodated in the aerosol generator. However, when a stick is accommodated in the aerosol generator, the controller may control the performance of the display module based on a third performance corresponding to the third value rather than the first value. In this case, the first value may be corrected to the third value, which is a greater value, and the third performance corresponding to the third value may be set to a lower resolution and/or frame rate than the first performance corresponding to the first value. In this case, the controller may control the performance of the display module in advance by taking into account the expected temperature increment of the display module due to the temperature of the aerosol generator, thereby minimizing damage to the display module caused by a high temperature of the aerosol generator.

Furthermore, the controller may perform operations related to the aerosol generator as well as the display module based on the second temperature information. Related details will be described below.

FIGS. 64 and 65 illustrate embodiments of methods of performing, by the controller, operations related to the aerosol generator based on the second temperature information.

The controller may control operations related to the aerosol generator based on second temperature information. Here, the operations may include control of the operating status of the aerosol generator and power applied to the aerosol generator, and back-off counting of a counter value of a counter related to the aerosol generator.

First, referring to FIG. 64, the controller may perform back-off counting of the counter value of the counter related to the aerosol generator based on the second temperature information. Here, the counter may be preset to a counter value corresponding to the maximum number of times of aerosol generation (or the maximum number of puffs of an electronic cigarette) provided through the aerosol generator.

Specifically, the controller may sense whether a stick is accommodated in the aerosol generator (S6201). When the stick is accommodated, the controller may acquire second temperature information from the sensor. Here, the second temperature information may be an airflow pass temperature in the aerosol generator as described above.

The controller may back-off count a counter related to the aerosol generator based on the second temperature information (S6203). Specifically, when the stick is accommodated in the aerosol generator, the controller may periodically acquire the second temperature information about the aerosol generator, and may sense whether the temperature of the aerosol generator decreases by a first threshold temperature or more based on the periodically acquired second temperature information. The controller may back-off count the counter value by 1 when the temperature of the aerosol generator decreases by the first threshold temperature or more based on the second temperature information. Alternatively, the controller may output the back-counted counter value through the display module to provide the user of the aerosol generator or the user of the mobile communication terminal with information about the remaining number of aerosol generations (or the remaining number of puffs).

When the counter value of the counter becomes 0, the controller may reset or initialize the counter value of the counter (i.e., set the counter to the maximum number of times of generating aerosol) (S6205).

Additionally, the controller may control the amount of power applied to the aerosol generator based on the second temperature information.

Referring to FIG. 65, the controller may apply power to the aerosol generator in response to sensing the stick accommodated in the aerosol generator (S6301).

The controller may acquire the second temperature information about the aerosol generator by controlling the sensor described above, and may control the amount of power applied to the aerosol generator based on the second temperature information (S6303).

For example, when a stick is accommodated in the aerosol generator, the controller may apply power to the aerosol generator such that the second temperature information reaches a second threshold temperature. Thereafter, when a decrease in the temperature of the aerosol generator is sensed based on the periodically acquired second information, the controller may increase the amount of power applied to the aerosol generator. Alternatively, when an increase in the temperature of the aerosol generator is sensed based on periodically acquired second information, the second controller may reduce the amount of power applied to the aerosol generator.

Alternatively, the controller may control the amount of power applied to the aerosol generator by further considering the first temperature information. Specifically, the controller may increase or decrease the amount of power to the aerosol generator based on the second temperature information, and the rate of increase and rate of decrease of the amount of power may be determined based on the first temperature information. For example, the rate of increase of the amount of power when the first temperature information is higher than or equal to a predetermined threshold temperature may be preset to be lower than the rate of increase of the amount of power when the first temperature information is lower than the predetermined threshold temperature. Alternatively, the rate of decrease of the amount of power when the first temperature information is higher than or equal to the predetermined threshold temperature may be preset to be higher than the rate of decrease of the amount of power when the first temperature information is lower than the predetermined threshold temperature. In this case, when the first temperature information is higher than or equal to the predetermined threshold temperature, the controller may increase the amount of power slower or decrease the amount of power faster than when the first temperature information is lower than the predetermined threshold temperature, so as to delay as much as possible the increase of the temperature of the display module to the maximum allowable temperature described above. Here, the predetermined threshold temperature may be set to a temperature that is lower than the maximum allowable temperature, but at which the first temperature information (or the temperature of the display module) is likely to reach the maximum allowable temperature within a predefined first time interval due to the temperature of the susceptor. For example, the first time interval may be determined based on an average operating time from the time the stick is received in the aerosol generator until the generation of the aerosol is terminated, or based on a preset duration.

Alternatively, when the first temperature information is higher than or equal to the predetermined threshold temperature, the controller may adjust the second threshold temperature based on the first temperature information. For example, when the first temperature information is lower than the predetermined threshold temperature, the controller increases the temperature of the aerosol generator to the second threshold temperature. However, when the first temperature information is higher than or equal to the predetermined threshold temperature, the controller may increase the temperature of the aerosol generator only to a third threshold temperature that is lower than the second threshold temperature. For example, whether to adjust the second threshold temperature based on the first temperature information may be determined based on the first temperature information acquired when accommodation of the stick is sensed.

Next, the controller may determine whether at least one of preset conditions is satisfied (S6305). Here, the preset conditions may include a condition that the counter value is 0, a condition that a preset time elapses after the stick is accommodated in the aerosol generator, a condition that the stick is removed from the aerosol generator, or a condition that the first temperature information is higher than or equal to a specific threshold temperature. Here, the specific threshold temperature may be predetermined to be lower than the maximum allowable temperature and higher than the predetermined threshold temperature. When any of the preset condition is not satisfied, the controller may continue to control power to the aerosol generator based on the second temperature information.

When at least one of the preset conditions is satisfied, the controller may stop applying power to the aerosol generator (S6307). In this operation, the controller may control the sensor to block the electrical connection for measurement of the second temperature information about the aerosol generator. Alternatively, as described above, the controller may reset the counter value of the counter when at least one of the preset conditions is satisfied.

FIG. 66 is a front view of a mobile communication terminal without a stick accommodated according to one embodiment of the present disclosure. In the description below, redundant description of the above-described details will be omitted.

The mobile communication terminal may include an aerosol generator 7200 and a flexible display 7711 including a first region 7712 that contacts a first surface of the aerosol generator 7200.

This figure shows a front view of a mobile communication terminal in which a stick (not shown) is not accommodated in the aerosol generator 7200. That is, because the stick is not accommodated in the aerosol generator 7200, the first region 7712 of the flexible display 7711 remains flat.

In one embodiment, at least one region of the flexible display 7711 of the present disclosure may be transformed into a flat or curved surface depending on whether the stick is accommodated in the aerosol generator 7200.

To this end, the flexible display 7711 may include multiple layers such that the at least one region is transformed into a flat or curved surface. Related details will be described below with reference to the drawings.

FIG. 67 is a front view of a mobile communication terminal with a stick accommodated according to one embodiment of the present disclosure. In the description below, redundant description of the above-described details will be omitted.

The mobile communication terminal may include an aerosol generator 7200 and a flexible display 7711 including a region 7712 that contacts the first surface of the aerosol generator 7200. Here, the aerosol generator 7200 may be formed to have a first length h. Here, the first length h may be determined based on the length of a stick 7100.

This embodiment shows a front view of the mobile communication terminal in which the stick 7100 is accommodated in the aerosol generator 7200. Here, the stick 7100 is merely an example and may include any aerosol generating articles that can generate aerosol.

Specifically, as the stick 7100 is accommodated in the aerosol generator 7200, at least a portion of one region of the flexible display 7711 is transformed into a curved surface. That is, unlike conventional curved displays, which remain flat or curved, the first region 7712 of the flexible display 7711 may be transformed into a curved surface having various curvatures or a flat surface. In this case, the curvature of the first region 7712 to form a curved surface is set not to cause physical damage to the flexible display 7711.

Furthermore, since the length of the aerosol generator 7200 is the first length h, the flexible display 7711 may form the curved portion of the first region 7712 of the flexible display 7711 only as long as the first length h.

Hereinafter, various elements necessary for the first region 7712 of the flexible display 7711 to be transformed into a curved surface will be described in detail.

FIG. 68 is a top view of a mobile communication terminal without a stick accommodated according to one embodiment of the present disclosure. In the description below, redundant description of the above-described details will be omitted.

Here, the first region 7712, the second region 7713, and the third region 7714 may be in contact with a support member on side A, and may be in contact with a panel for displaying images in side A′. Here, side A represents the rear surface of the mobile communication terminal, and direction A′ represents the front surface of the mobile communication terminal. The same may be applied to the subsequent figures.

In one embodiment, when the stick is not accommodated in the aerosol generator 7200, a first surface 7201 of the aerosol generator 7200 may remain flat.

To this end, a first surface 7201 (dotted line) of the aerosol generator 7200 may be made of a ductility material (e.g., a soft plastic or polymer) or a flexible material. In this case, the first surface 7201 and the surface of the aerosol generator 7200 other than the first surface 7201 (dotted line) may be made of different materials. Accordingly, when the stick is inserted, the surface other than the first surface 7201 may maintain a fixed shape, and the first surface 7201 may change from a flat surface to a curved surface. Hereinafter, an embodiment in which the first surface 7201 of the aerosol generator 7200 is transformed into a curved surface will be described in detail.

Likewise, the first region 7712 (dotted line), second region 7713, and third region 7714 of the flexible display 7711 may remain flat as the stick is not accommodated.

The mobile communication terminal of this embodiment may include an aerosol generator 7200 and a flexible display 7711 including a first region 7712 that contacts the first surface 7201 of the aerosol generator 7200.

The aerosol generator 7200 may accommodate a stick (not shown) that generates an aerosol. In one embodiment, the controller of the mobile communication terminal may sense that the stick is accommodated in the aerosol generator 7200. As the stick is accommodated in the aerosol generator 7200, the first region 7712 may be transformed into a curved surface. In one embodiment, the first region 7712 of the flexible display 7711 may be transformed into a curved surface due to the pressure of the stick being accommodated. Related details will be described later.

On the other hand, the second region 7713 and the third region 7714 that do not contact the first surface 7201 of the aerosol generator 7200 may remain flat.

Hereinafter, a detailed description will be provided of the flexible display 7711 composed of multiple layers such that at least a portion of the first region 7712 that contacts the first surface 7201 is transformed into a curved surface as the stick is accommodated in the aerosol generator 7200.

FIG. 69 is a top view of a mobile communication terminal without a stick accommodated according to one embodiment of the present disclosure. In the description below, redundant description of the above-described details will be omitted.

In one embodiment, the aerosol generator 7200 may include a first hinge 7202, a second hinge 7203, a first portion 7204, a second portion 7205, and a third portion 7206. The first hinge 7202 and the second hinge 7203 may be formed symmetrically to correspond to each other in the aerosol generator 7200. In addition, the first portion 7204 may correspond to a member portion disposed on a surface of the aerosol generator 7200 that contacts the support member of the mobile communication terminal, and the second portion 7205 and the third portion 7206 may correspond to member portions disposed on the surface of the aerosol generator 7200 that contacts the flexible display 7711 of the mobile communication terminal.

The first hinge 7202 may be formed in a structure that connects the first portion 7204 and the second portion 7205 of the aerosol generator 7200, and the second hinge 7203 may be formed in a structure that connects the first portion 7204 and the third portion 7206 of the aerosol generator 7200.

In one embodiment, the first hinge 7202 may allow the second portion 7205 to be folded and unfolded, and the second hinge 7203 may allow the third portion 7206 to be folded and unfolded. To this end, the first hinge 7202 and the second hinge 7203 may be fixed to the first portion 7204. FIG. 70 shows the second portion 7205 and the third portion 7206 in a folded position.

FIG. 70 is a top view of a mobile communication terminal with a stick accommodated according to one embodiment of the present disclosure. In the description below, redundant description of the above-described details will be omitted.

In FIG. 70, when a stick (not shown) is inserted, the second portion 7205 and the third portion 7206 respectively connected to the first hinge 7202 and the second hinge 7203 of the aerosol generator 7200 may be transformed into an unfolded shape. At this time, the first portion 7204 may remain fixed because it is the portion of the aerosol generator 7200 that contacts the support member (i.e., the rear) of the mobile communication terminal.

As a user forces the stick to be inserted into the aerosol generator 7200, the second portion 7205 connected to the first hinge 7202 and the third portion 7206 connected to the second hinge 7203 may be unfolded. In another embodiment, the second portion 7205 connected to the first hinge portion 7202 and the third portion 7206 connected to the second hinge portion 7203 may be unfolded by control of the mobile communication terminal in accordance with a figure described hereinafter.

To this end, the first portion 7204, the second portion 7205, and the third portion 7206 of the aerosol generator 7200 may be formed of different materials. For example, the first portion 7204, the second portion 7205, and the third portion 7206 of the aerosol generator 7200 may be formed of plastic, metal, or ceramic.

Accordingly, by unfolding the second portion 7205 connected to the first hinge 7202 and the third portion 7206 connected to the second hinge 7203, the aerosol generator 7200 may provide a space in which the stick can be accommodated.

That is, the angle at which the second portion 7205 unfolds around the first hinge 7202 and the third portion 7206 unfolds around the second hinge 7203 may correspond to an angle for accommodating the stick.

Furthermore, as the second portion 7205 and the third portion 7206 of the aerosol generator 7200 unfold, the first region 7712 of the flexible display 7711 expands toward the front of the mobile communication terminal. Related details will be with reference to the other figures.

FIG. 71 is a view illustrating an embodiment of operation of a mobile communication terminal in a stick accommodation mode according to one embodiment of the present disclosure. In the description below, redundant description of the above-described details will be omitted.

The mobile communication terminal may output various applications on the flexible display 7711. In one embodiment, the mobile communication terminal may display an application icon 7715 related to the stick accommodation mode.

Here, the stick accommodation mode corresponds to a mode in which a user can use the mobile communication terminal as an electronic cigarette by generating an aerosol using the aerosol generator 7200 included in the mobile communication terminal.

To this end, the mobile communication terminal may output an application icon 7715 for providing the stick accommodation mode. In one embodiment, the mobile communication terminal may receive a control signal 7716 for selecting the application icon 7715 related to the stick accommodation mode. For example, the control signal 7716 corresponds to a control signal generated when the user touches the application icon 7715 output on the flexible display 7711 of the mobile communication terminal.

In response to receiving the control signal for selecting the application icon 7715 related to the stick accommodation mode, the mobile communication terminal may transform the aerosol generator 7200 into a shape that can accommodate a stick.

In this case, reference can be made to the figures described above to illustrate how the aerosol generator 7200 is transformed into a shape that can accommodate a stick. As the aerosol generator 7200 is transformed into a shape that can accommodate the stick, the first region 7712 of the flexible display 7711 is bent or curved. For details, reference will be made to the figure described below.

FIG. 72 is a view illustrating a first region of a flexible display of a mobile communication terminal according to one embodiment of the present disclosure. In the description below, redundant description of the above-described details will be omitted.

The flexible display 7711 of this embodiment may include a cover window 7811, a polarizing panel 7812, a touch panel 7813, a flexible display panel 7814 that displays images, and a base film 7815 disposed on an outer side of the flexible display panel 7814. For case of illustration, the first region 7712 of the flexible display 7711 that can be transformed into a flat and curved surface will be described by way of example. However, it should be appreciated that the second region (not shown) and third region (not shown) of the flexible display 7711 can include the same components. The second and third regions that remain flat may be formed in a different shape or have a different structure than the multiple layers included in the first region 7712 that can be transformed into a flat and curved surface.

Hereinafter, each layer in the first region 7712 of the flexible display 7711 according to one embodiment will be described.

The flexible display 7711 may be made of multiple stacked layers. Each of the multiple layers may be included in the first region 7712, the second region, and the third region.

More specifically, the cover window 7811 may be disposed on the front of the flexible display 7711 (on side A′). It may protect the flexible display 7711 from external impact. The cover window 7811 may include a material having physical flexibility. Additionally, the cover window 7811 may include a transparent material to provide a high light transmittance.

In one embodiment, the cover window 7811 included in the first region 7712 of the flexible display 7711 and the cover window 7811 included in the second region or third region may be made of different materials. In one embodiment, the cover window 7811 included in the second or third region may be made of a rigid material, while the cover window 7811 included in the first region 7712 may be made of a relatively soft material. To this end, the cover window 7811 included in the second region or third region may include an additional window layer because the cover window 7811 included in the second region or third region requires more mechanical rigidity than the cover window 7811 included in the first region 7712.

In particular, since the second region or third region is more exposed to the front of the mobile communication terminal, the cover window 7811 included in the second region or third region may include multiple sublayers to ensure mechanical reliability, such as impact resistance. In one embodiment, the cover window 7811 may include a double cover window.

The cover window 7811 included in the first region 7712 may be thinner or include fewer layers than the second region or third region to ensure flexibility of the first region 7712 of the flexible display 7711.

The polarizing panel 7812 may be bonded to the touch panel 7813. The polarizing panel 7812 may prevent extraneous light reflections to ensure a black view of the flexible display 7711. For example, user visibility may be improved by blocking reflection of light incident through the cover window 7811 disposed on the polarizing panel 7813.

In one embodiment, the polarizing panel 7812 may include a polyethylene terephthalate (PET) film, a tri-acetyl cellulose (TAC) film, a cycle-olefin polymer (COP) film, or a poly-vinyl alcohol (PVA) film. According to another embodiment, to ensure the flexibility of the flexible display 7711 the polarizing panel 7812 may be formed of a thin film, as opposed to the polarizing layer in a conventional display. Further, the polarizing panel 7812 may be disposed between the touch panel 7813 and the cover window 7811.

The touch panel 7813 may be disposed between the polarizing panel 7812 and the flexible display panel 7814. In one embodiment, the touch panel 7813 may be formed to have multiple touch electrodes arranged thereon. The touch electrodes may be controlled by a touch sensor IC. For example, the touch electrodes may sense a touch input or hovering input to a particular location by measuring a change in a signal (e.g., voltage, light intensity, resistance, or amount of charge) to the particular location on the flexible display 7711, and provide information (e.g., location, area, pressure, or time) related to the sensed touch input or hovering input to the controller of the mobile communication terminal. In one embodiment, at least a portion of the touch panel 7813 (e.g., the touch sensor IC) may be included as a display driver IC, as part of the display, or as part of another component (e.g., a coprocessor) outside of the display.

In one embodiment, the touch panel 7813 may be formed of a thin film. The thin film may have a touch electrode in the form of a thin film.

The flexible display panel 7814 may include a liquid crystal display (LCD) panel, a light emitting diode (LED) display panel, an organic light emitting diode (OLED) display panel, a microelectromechanical system (MEMS) display panel, or an e-paper display panel. For example, it may have an OLED structure. The OLED panel may have a structure in which an organic light emitting layer disposed between a top substrate and a bottom substrate. The polarizing panel 7812 may be disposed on the top substrate, from which light is emitted. The flexible display 7711 may further include the touch panel 7813 as an input means.

The base film 7815 may be disposed on the rear surface of the flexible display panel 7814 to protect the flexible display panel 7814. In this case, the base film 7815 may be made of a flexible material (e.g., PI).

In one embodiment, the base film 7815 may be made of a flexible material. A typical display may include a base substrate made of glass disposed under the display panel. The glass is not suitable for displays that are continuously bent or curved, such as the flexible display 7711 according to various embodiments. Accordingly, the base film 7815 may include an emboss layer and/or a cushion layer. However, depending on the flexibility of the flexible display 7711, the emboss layer or cushion layer may be omitted.

In one embodiment, the cover window 7811, the polarizing panel 7812, the touch panel 7813, the flexible display panel 7814, and the base film 7815 may be bonded to each other by an optically clear adhesive layer (OCA) (not shown).

In one embodiment, the flexible display 7711 may further include various optical panels or optical films.

The first region 7712 of the flexible display 7711 formed in this structure may be transformed into a flat or curved surface depending on whether a stick is accommodated in the aerosol generator (not shown).

FIG. 73 is a view illustrating a first region of a flexible display of a mobile communication terminal according to another embodiment of the present disclosure. In the description below, redundant description of the above-described details will be omitted.

Multiple layers included in the first region 7712 of the flexible display 7711 are shown to be curved as the stick is accommodated in the aerosol generator.

Accordingly, the cover window 7811, the polarizing panel 7812, the touch panel 7813, the display panel 7814, and the base film 7815 included in the first region 7712 may be transformed based on the shape of the stick in the aerosol generator (not shown).

More specifically, the curvature formed by the cover window 7811, the polarizing panel 7812, the touch panel 7813, the display panel 7814, and the base film 7815 included in the first region 7712 may be determined based on the shape of the stick. For example, when the shape of the stick is a perfect circle, each of the component modules included in the first region 7712 may be transformed to a curvature that can surround the stick of a circular shape. When the shape of the stick is oval, each of the component modules included in the first region 7712 may be transformed into a curvature that can surround the oval-shaped stick. In this case, each of the component modules included in the first region 7712 may form a curvature to surround the stick, but maintain a minimal curvature to prevent damage to the component modules.

FIG. 74 is a view illustrating a flexible display of a mobile communication terminal according to one embodiment of the present disclosure. In the description below, redundant description of the above-described details will be omitted.

As described above, the flexible display 7711 may include multiple layers. In the flexible display 7711, the flexible display panel 7814 may include a substrate 7911, a pixel array 7912 formed on the substrate 7911, and a thin film encapsulation (TFE) layer 7913 covering the pixel array 7912.

The pixel array 7912 is composed of multiple pixels, and each of the pixels may include a LED. Here, the LED may be an OLED. The multiple LEDs may be electrically connected to a display driving circuit and emit light according to electrical signals. The display driving circuit may include a driver IC, wherein the driver IC may transmit power or image signals to the multiple LEDs through conductive wires.

The TFE layer 7913 may be formed on the pixel array 7912 to encapsulate the multiple LEDs. Since OLED devices are very vulnerable to moisture and oxygen, the TFE layer 7913 is used to prevent water and oxygen from penetrating into the LEDs. The TFE layer 7913 may protect the multiple LEDs from moisture or oxygen by forming multiple organic or inorganic layers. In this case, the TFE layer 7913 may have a structure in which composite layers including organic layers and inorganic layers are alternately stacked. Additionally, the TFE layer 7913 may further include a thin film evaporation film.

In one embodiment, the pixel array 7912 may include subpixels. The subpixel may include an anode electrode formed on the substrate 7911, an organic material formed on the anode electrode and capable of representing R, G, and B colors, and a cathode electrode formed on the organic material. Here, the anode electrode may be formed in a single layer, or include multiple anode electrodes electrically connected to the flexible display panel 7814.

The TFE layer 7913 may cover the cathode electrode. The cathode electrode may be electrically connected to the pixels. The cathode electrode may be configured in the form of a layer disposed on top of the multiple pixels. The cathode electrode may be disposed on top of the pixel array 7912.

In one embodiment, the flexible display 7711 may include a first region 7712, a second region 7713, and a third region 7714. FIG. 74 illustrates multiple layers included in the second region 7713 and third region 7714 of the flexible display 7711. That is, the structure, shape, or form of the multiple layers included in the second region 7713 and third region 7714, which remain flat, may be different from the first region 7712, which can be transformed into a curved surface.

Unlike the first region 7712, the base film 7815 in the second region 7713 or the third region 7714 may be formed to be flat.

In addition, the touch panel 7813 in the second region 7713 or the third region 7714 includes multiple touch electrodes arranged on the substrate 7911 and a touch panel circuit electrically connected to control each of the touch electrodes. Here, the touch panel circuit formed on the touch panel 7813 may include conductive wires 7914 and 7915 extending in the column and row directions of the touch panel 7813. Here, the conductive wires may be formed as a conductive pattern printed on the substrate 7911.

The conductive wires may include a first conductive wire 7914, which is a column conductive wire, and a second conductive wire 7915, which is a row conductive wire. Additionally, one of the first conductive wire and the second conductive wire may be connected to a receiving electrode, and the other may be connected to a transmitting electrode. The first and second conductive wires may be electrically connected.

FIG. 75 is a view illustrating a flexible display of a mobile communication terminal according to one embodiment of the present disclosure. In the description below, redundant description of the above-described details will be omitted.

This figure shows multiple layers included in the first region 7712 of the flexible display 7711. Accordingly, there are differences in some layers compared to the second region 7713 and third region 7714 described above. The description below will focus on the differences from the configuration described above.

In a case in which the TFE layer 7913 discussed with respect to the second region 7713 and third region 7714 is provided to cover the pixel array 7912 included in the first region 7712, the TFE layer 7913 may be continuously bent or curved, and may crack. If a crack occurs in the TFE layer 7913, black spots may appear on the display panel 7814. To prevent the crack from occurring, the TFE layer 7913 included in the first region 7712 may be arranged to independently encapsulate some of the LEDs.

More specifically, the encapsulation members of the TFE layer 7913 may be spaced apart from each other, and an adhesive having a high elasticity modulus and low modulus may fill in the gap between the encapsulation members. To this end, the encapsulation members may encapsulate one or more capsules in a trapezoidal shape. The encapsulation members may individually encapsulate one or more pixels to minimize stress applied to the TFE layer 7913 and prevent cracks from occurring in the layer. That is, the encapsulation members may independently encapsulate the organic material and the cathode electrode. Accordingly, the flexible display 7711 may bend smoothly without damage to the TFE layer 7913.

Unlike the second region 7713 and the third region 7714, the base film 7815 of the first region 7712 may have a groove formed in a direction perpendicular to the extension direction of the base film 7815. Here, the groove formed in the base film 7815 may be formed perpendicular to the direction in which the flexible display 7711 is bent. Accordingly, when the first region 7712 is bent or curved, damage to the base film 7815 may be prevented.

The touch panel 7813 in the first region 7712 may include multiple touch electrodes arranged on the substrate 7911 and a touch panel circuit electrically connected to control each of the touch electrodes. Likewise, the touch panel circuit formed on the touch panel 7813 may include conductive wires 7914 and 7915 extending in the column and row directions of the touch panel 7813. However, the conductive wires included in the first region 7712 may have a different structure from the conductive wires 7914 and 7915 included in the second region 7713 or the third region 7714.

In one embodiment, the second conductive wire 7915 included in the first region 7712 may be formed in a zigzag-shaped conductive pattern. On the other hand, the first conductive wire 7914 may be formed as a straight line as in the second region 7713 or the third region 7714.

Considering the bending direction of the first region 7712, when the first conductive wire 7914 perpendicular to the bending direction is bent, a relatively small stress may be applied to the longitudinal direction of the first conductive wire 7914. Accordingly, the first conductive wire 7914 may be less likely to be damaged or short-circuited due to bending.

On the other hand, the second conductive wire 7915 arranged parallel to the bending direction may generate relatively large stress in the longitudinal direction of the second conductive wire 7915, which may act as stress on the conductive wires formed on the substrate 7911, causing the second conductive wire 7915 to be short-circuited or damaged. Accordingly, the second conductive wire 7915 may be formed to have a zigzag pattern. Accordingly, the stress acting on the second conductive wire 7915 in the bending direction may be effectively distributed.

FIG. 76 is a view illustrating a pressure sensor array of a flexible display according to one embodiment of the present disclosure. In the description below, redundant description of the above-described details will be omitted.

In particular, the pressure sensor array 7921 included in the second region 7713 or the third region 7714 of the flexible display 7711 according to one embodiment of the present disclosure will be described.

The pressure sensor array 7921 may include at least one pressure sensor 7922 arranged on the array and a wire for electrically connecting the pressure sensor 7922.

In one embodiment, the pressure sensor array 7921 may be omitted in the second region 7713 or the third region 7714. This is because the first region 7712 needs to sense pressure when a stick is inserted, but the second region 7713 or the third region 7714 does not need to sense the pressure.

FIG. 77 is a view illustrating a pressure sensor array of a flexible display according to one embodiment of the present disclosure. In the description below, redundant description of the above-described details will be omitted.

In particular, the pressure sensor array 7921 included in the first region 7712 of the flexible display 7711 according to one embodiment of the present disclosure will be described.

The pressure sensor array 7921 included in the first region 7712 may include multiple grooves 7923.

Here, the multiple grooves 7923 may be formed between the pressure sensors 7922 and may extend in a direction perpendicular to the bending direction or in directions parallel and perpendicular to the bending direction. In particular, the grooves 7923 formed in a direction perpendicular to the direction in which the flexible display 7711 is bent or curved may distribute the stress acting on the base film 7815.

In one embodiment, the pressure sensor array 7921 may sense pressure applied to the first region 7712 of the mobile communication terminal. For example, when a user inserts a stick into the aerosol generator, the pressure sensor array 7921 may sense the pressure applied to the first region 7712. Accordingly, the first region 7712 of the flexible display 7711 may be transformed into a curved surface due to the pressure applied as the stick is accommodated.

FIG. 78 illustrates component modules of a mobile communication terminal according to one embodiment of the present disclosure. In the description below, redundant description of the above-described details will be omitted.

The mobile communication terminal may include a controller 100, an aerosol generator 200, and a flexible display 7711. Hereinafter, for simplicity, the operations performed by the controller 100 will be described as performed by the mobile communication terminal.

The mobile communication terminal may further include a power supply unit 300 configured to supply power to the mobile communication terminal. For details, refer to FIG. 1. Additionally, a stick may include a susceptor that is inductively heated by the aerosol generator 200. For details, refer to FIG. 1.

In one embodiment, the mobile communication terminal may control the power applied to the aerosol generator 200 based on a change in magnetism of the susceptor. For details, refer to FIGS. 57 to 60.

Additionally, in one embodiment, the mobile communication terminal may estimate the temperature of the susceptor based on the equivalent resistance. Then, the mobile communication terminal may control the flexible display 7711 based on the temperature of the susceptor and the measured temperature of the flexible display 7711. For details, refer to FIGS. 53 to 56.

Additionally, in one embodiment, the mobile communication terminal may measure a change in resonant frequency occurring in the aerosol generator 200 according to a change in temperature of the susceptor. Then, the mobile communication terminal may control the temperature of the susceptor based on the change in resonant frequency. For details, refer to FIGS. 36 to 45.

Additionally, in one embodiment, the mobile communication terminal may sense a change in magnetic force occurring in the aerosol generator 200 according to the change in temperature of the susceptor. Then, the mobile communication terminal may control the temperature of the susceptor based on the change in magnetic force. For details, refer to FIGS. 46 to 52.

Additionally, in one embodiment, the mobile communication terminal may further include a communicator 400 including an antenna for receiving location information. Here, the antenna may be coupled to the aerosol generator 200 and disposed on the body of the aerosol generator 200. It may be provided with a patch formed of a conductor and a ground spaced apart from the patch. For details, refer to FIGS. 28 to 35.

Additionally, in one embodiment, the mobile communication terminal may generate first temperature information about the flexible display 7711. Then, the mobile communication terminal may control the flexible display 7711 based on the first temperature information and may further acquire second temperature information about the aerosol generator 200 as the stick is accommodated. For details, refer to FIGS. 61 to 65.

Additionally, in one embodiment, the mobile communication terminal may further include a heat pipe that is internally vacuumed and contains a fluid. Here, a first region of the heat pipe may be connected to the first region of the aerosol generator 200, and a second region of the heat pipe may be connected to the second region of the mobile communication terminal. For details, refer to FIGS. 79 to 83.

FIG. 79 is a view illustrating a mobile communication terminal according to one embodiment of the present disclosure. In the description below, redundant description of the above-described details will be omitted.

The mobile communication terminal may include an aerosol generator 7400 that accommodates a stick 7300 that generates an aerosol, and a heat pipe 7500 that is internally vacuumed and contains a heat transfer means.

The heat pipe 7500 may include a long metal pipe with a specific internal shape, which may be vacuum sealed to contain a small amount of refrigerant (a heat transfer means, e.g., water). When the end regions of the heat pipe 7500 are heated and cooled and there is a difference in temperature therebetween, the refrigerant in the heat pipe 7500 may trap heat and transfer heat by convection between the two ends of the heat pipe 7500.

Embodiments of the present disclosure may utilize this feature of the heat pipe 7500 to attach a heated portion of the heat pipe 7500 to a region whose temperature increases as the stick 7300 is accommodated and the heating part of the aerosol generator 7400 is turned on. Conversely, a cooled portion of the heat pipe 7500 may be attached to a region whose temperature is relatively lower than the aerosol generator 7400 whose temperature is increased as the stick 7300 is accommodated. Related details will be described below with the reference to the figures.

In one embodiment, a first region 7501 of the heat pipe 7500 may be connected to the first region 7504 of the aerosol generator 7400, and a second region 7502 of the heat pipe 7500 may be connected to the second region 7505 of the mobile communication terminal. Here, the first region 7504 may correspond to an exterior or antenna region of the aerosol generator 7400. Related details will be described below with the reference to the figure.

The second region 7505 may include at least one electronic component of the mobile communication terminal. That is, the second region 7502 of the heat pipe 7500 may be connected to the at least one electronic component. Here, the electronic component may refer to various internal components included in the mobile communication terminal, such as a sensor, camera module, microphone module, sound output module, and storage unit.

In particular, in one embodiment, the electronic component may maintain a lower temperature than the aerosol generator 7400 when the stick 7300 is accommodated in the aerosol generator 7400.

More specifically, when the stick 7300 is accommodated in the aerosol generator 7400 and power is supplied to the aerosol generator 7400 to generate heat, the temperature of the aerosol generator 7400 increases. Accordingly, the heat transfer means disposed in the first region 7501 of the heat pipe 7500 connected to the aerosol generator 7400 moves to the second region 7502. Subsequently, when the heat transfer means of the heat pipe 7500 reaches the second region 7502, the electronic components located in the second region 7505 may dissipate the internal heat generated in the first region 7501 because they are maintaining a relatively lower temperature than the aerosol generator 7400.

To this end, in one embodiment, the second region 7505 may correspond to a region in contact with the outside, if possible. For example, among the modules included in the mobile communication terminal, the module for connecting an external terminal (e.g., the part into which a charging cable or earphone cable is inserted) may be at a lower temperature than the other electronic components. Accordingly, the second region 7502 of the heat pipe 7500 may correspond to a region in the mobile communication terminal that is in contact with the outside.

FIG. 80 is a view illustrating a heat pipe according to one embodiment of the present disclosure. In the description below, redundant description of the above-described details will be omitted.

The heat pipe 7500 may include a container that holds a fluid or vapor that is a means of heat transfer, a first region 7501 connected to a heat source, and a second region 7502 that is an emitter that emits heat. The heat pipe 7500 may be made of various structures of materials such as electrical resistors, such as nichrome wire, and may have a tubular shape as a whole, for example.

In particular, in order to more efficiently transport the heat transfer means, the inner wall of the container of the heat pipe 7500 may be configured in the form of a sponge structure or a metal tube with metal fins densely embedded therein. In other words, the inner wall may be designed to have a large contact area relative to the volume of the container. Accordingly, when cooled and liquefied, the heat transfer means may flow by capillary action while soaking the sponge structure or the like. When heated to a gaseous state, it may move through the space in the center of the pipe.

The first region 7501 may include an evaporator that is thermally connected to a heat source and evaporates the fluid inside the heat pipe 7500. In one embodiment of the present disclosure, the heat source may correspond to an aerosol generator, which will be described in more detail below with reference to the figure.

The second region 7502 may include an emitter that is thermally connected to an electronic component of the mobile communication terminal and emits heat by condensing vapor inside the heat pipe 7500. The emitter may be made of any suitable material or structure capable of dissipating heat to the outside. For example, the emitter may be coupled in a lid shape, may form a coating layer, or may include a metallic component with high thermal conductivity.

In one embodiment of the present disclosure, the heat pipe 7500 may transfer heat generated from the aerosol generator through evaporation of the fluid inside the heat pipe 7500. That is, the heat pipe 7500 has a heat transfer rate that is 40 to 80 times faster than a typical heat sink formed of only copper or aluminum. Thus, the heat pipe 7500 may dissipate heat generated by the aerosol generator to areas where electronic components of the mobile communication terminal at lower temperature are located.

The heat pipe 7500 may include a heat transfer component (e.g., a fluid or vapor) that is vaporized by the heat source and moved toward the emitter, and a movement medium (wick) that moves the heat transfer component in a liquid state on the heat source-facing side of the heat pipe 7500 toward the heat source. The heat transfer component may move automatically depending on the internal tubular shape of the heat pipe 7500 as described above. In other words, the fluid or vapor may be changed to a gaseous form by heat from the heat source and transfer heat toward the emitter.

In one embodiment of the present disclosure, the first region 7501 of the heat pipe 7500 may be connected to the first region 7504 of the aerosol generator, and the second region 7502 of the heat pipe 7500 may be connected to the second region 7505 of the mobile communication terminal to utilize the heat transfer capability of the heat pipe 7500. Thereby, heat generated in the first region of the aerosol generator may be dissipated to the second region. Related details will be described below with reference to a figure.

FIG. 81 is a view illustrating an aerosol generator according to one embodiment of the present disclosure. In the description below, redundant description of the above-described details will be omitted.

The aerosol generator 7400 may generate heat using any of the methods described above. For example, heat may be generated by electrical resistance, or by a combustion method capable of generating heat. The heat generated by the heat source may be transferred in different directions through heat pipes 7500a and 7500b.

In one embodiment, the heat pipes 7500a and 7500b may be thermally connected to the exterior of the aerosol generator 7400.

More specifically, as shown in the figure, the mobile communication terminal may include at least one heat pipe 7500a, 7500b attached to the aerosol generator 7400. While the figure shows an example in which two heat pipes 7500a and 7500b are attached, one, three, or more heat pipes may be attached.

The first region 7501 of the heat pipes 7500a and 7500b may be attached to the exterior of the aerosol generator 7400. The aerosol generator 7400 accommodates the stick 7300 and may heat the heater or heating part contained therein in various ways to heat the stick 7300. Accordingly, the temperature on the exterior of the aerosol generator 7400 may rise, and the first region 7501 of the heat pipes 7500a and 7500b may transfer the heat generated on the exterior of the aerosol generator 7400 to the second region (not shown) through an internal heat transfer means.

Thereby, the mobile communication terminal may dissipate the heat generated by the aerosol generator 7400 to a place where electronic components are at a relatively low temperature.

FIG. 82 is a view illustrating an aerosol generator according to one embodiment of the present disclosure. In the description below, redundant description of the above-described details will be omitted.

In one embodiment, the heat pipes 7500a and 7500b may be thermally connected to an antenna 7600 of the aerosol generator. As described above, the aerosol generator 7400 of the present disclosure may be coupled to the antenna 7600 of the communicator described above.

The figure shows two heat pipes 7500a and 7500b, but this is merely an example. In one embodiment, the number of heat pipes 7500a and 7500b is determined based on the arrangement and structure of the antenna 7600.

Additionally, as described above, the heating part 7700 may be operated under the control of the mobile communication terminal. For example, the mobile communication terminal may heat the aerosol generator 7400 by operating the heating part 7700 as the stick 7300 is accommodated in the aerosol generator 7400.

Accordingly, when the temperature of the aerosol generator 7400 increases, the temperature of the antenna 7600 connected to the exterior of the aerosol generator 7400 increases. If the temperature of the antenna 7600 increases, the communication function of the mobile communication terminal may deteriorate. Therefore, in one embodiment of the present disclosure, the first region 7501 of the heat pipes 7500a and 7500b may be connected to the antenna 7600 to prevent the temperature of the antenna 7600 from rising. Thus, the fluid that is a heat transfer means inside the heat pipes 7500a and 7500b may be vaporized by the heat generated from the antenna 7600 and moved to the second region (not shown).

Additionally, the first region 7501 of the heat pipes 7500a and 7500b may be attached to a region containing the antenna 7600, rather than to the antenna 7600 itself. For example, the region containing the antenna 7600 may include a patch disposed outside the aerosol generator 7400, a ground, a feed line connected to the patch, and an antenna wire connecting the feed line and the communicator, as described above. That is, the first region 7501 of the heat pipes 7500a and 7500b may be connected to at least one antenna component included in the antenna region.

Accordingly, the mobile communication terminal may dissipate the heat generated by the aerosol generator 7400 to a location where electronic components are at a relatively low temperature.

FIG. 83 is a view illustrating component modules of a mobile communication terminal according to one embodiment of the present disclosure. In the description below, redundant description of the above-described details will be omitted.

The mobile communication terminal may include a controller 100, an aerosol generator 200, a communicator 400, and a heat pipe 7500. Hereinafter, for simplicity, the operations performed by the controller 100 will be described as performed by the mobile communication terminal.

The mobile communication terminal may further include a power supply unit 300 configured to supply power to the mobile communication terminal. For details, refer to FIG. 1. Additionally, a stick may include a susceptor that is inductively heated by the aerosol generator 200. For details, refer to FIG. 1.

In one embodiment, the mobile communication terminal may control the power applied to the aerosol generator 200 based on a change in magnetism of the susceptor. For details, refer to FIGS. 57 to 60.

Additionally, in one embodiment, the mobile communication terminal may estimate the temperature of the susceptor based on the equivalent resistance. Then, the mobile communication terminal may control the display module 710 based on the temperature of the susceptor and the measured temperature of the display module 710. For details, refer to FIGS. 53 to 56.

Additionally, in one embodiment, the mobile communication terminal may measure a change in resonant frequency occurring in the aerosol generator 200 according to a change in temperature of the susceptor. Then, the mobile communication terminal may control the temperature of the susceptor based on the change in resonant frequency. For details, refer to FIGS. 36 to 45.

Additionally, in one embodiment, the mobile communication terminal may sense a change in magnetic force occurring in the aerosol generator 200 according to the change in temperature of the susceptor. Then, the mobile communication terminal may control the temperature of the susceptor based on the change in magnetic force. For details, refer to FIGS. 46 to 52.

Additionally, in one embodiment, the mobile communication terminal may further include a communicator 400 including an antenna for receiving location information. Here, the antenna may be coupled to the aerosol generator 200 and disposed on the body of the aerosol generator 200. It may be provided with a patch formed of a conductor and a ground spaced apart from the patch. For details, refer to FIGS. 28 to 35.

Additionally, in one embodiment, the mobile communication terminal may generate first temperature information about the display module 710. Then, the mobile communication terminal may control the display module 710 based on the first temperature information and may further acquire second temperature information about the aerosol generator 200 as the stick is accommodated. For details, refer to FIGS. 61 to 65.

Additionally, in one embodiment, the mobile communication terminal may further include a flexible display including a first region that contacts the first surface of the aerosol generator 200. Here, the first region of the flexible display is transformed into a curved surface as a stick is accommodated. For details, refer to FIGS. 66 to 78.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors, controllers, or the like, are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor or controller which may be considered a type of circuitry, the circuitry, means, or units are a combination of hardware and software, the software being used to configure the hardware and/or processor.

For firmware or software implementation, an embodiment of the present disclosure may be implemented in the form of a module, a procedure, a function, and so on for performing the above-described functions or operations. Software code may be stored in a memory and executed by a processor or controller. The memory is located at the interior or exterior of the processor or controller and may transmit and receive data to and from the processor or controller via various known means.

The above-described embodiments are combinations of elements and features of the present disclosure in specific forms. The elements or features may be considered selective unless mentioned otherwise. Each element or feature may be implemented without being combined with other elements or features. Further, the embodiments of the present disclosure may be configured by combining some of the elements and/or features. The order of operations described in the embodiments of the present disclosure may be rearranged. Several configurations or features of any one embodiment may be included in another embodiment or may be replaced with related configurations or features of another embodiment. It is obvious that claims that are not explicitly cited in the appended claims may be combined to form an embodiment or included as a new claim by amendment after filing.

Various embodiments of the present disclosure may be carried out in other specific ways than those set forth herein without departing from the essential characteristics of the present disclosure. The above implementations are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

Embodiments of the present disclosure as described above are applicable to various mobile communication terminals.

1. A mobile communication terminal comprising:
a power supply configured to supply power;
an aerosol generator configured to supply power to a coil using the power supplied by the power supply to heat a susceptor located in the aerosol generator and cause heating of an aerosol generating article;
a sensor configured to sense a change in magnetic force occurring in the aerosol generator in response to a change in temperature of the susceptor;
a communication circuit; and
a controller configured to:
control the communication circuit to transmit and receive wireless signals; and
control the power supplied to the coil, based on the change in magnetic force.

2. The mobile communication terminal of claim 1, wherein the aerosol generator is shaped to define an accommodation space, wherein the susceptor is located in the accommodation space.

3. The mobile communication terminal of claim 1, wherein the susceptor is included in the aerosol generating article.

4. The mobile communication terminal of claim 1, wherein the controller is further configured to control the power supplied to the coil to inductively heat the susceptor, based on the aerosol generating article being located in the aerosol generator.

5. The mobile communication terminal of claim 1, wherein the sensor comprises:
a magnetic force sensor comprising at least one Hall sensor,
wherein the magnetic force sensor senses a change in the magnetic force in response to the change in temperature of the susceptor.

6. The mobile communication terminal of claim 1, further comprising:
a flexible display comprising a first region contacting a first surface of the aerosol generator,
wherein the first region of the flexible display changes from a flat surface to a curved surface, based on the aerosol generating article being received at the aerosol generator.

7. The mobile communication terminal of claim 1, further comprising:
a heat pipe shaped to define a vacuumed interior,
wherein a fluid is located in the vacuumed interior,
wherein a first region of the heat pipe is coupled to a first region of the aerosol generator, and
wherein a second region of the heat pipe is coupled to a second region of the mobile communication terminal.

8. The mobile communication terminal of claim 1, further comprising:
a display; and
an additional sensor,
wherein the controller is further configured to:
receive, from the additional sensor, first temperature information for the display;
control the display based on the first temperature information; and
control the additional sensor to obtain second temperature information for the aerosol generator, based on the aerosol generating article being received by the aerosol generator.

9. A mobile communication terminal comprising:
a power supply configured to supply power;
an aerosol generator sized to receive an aerosol generating article;
a coil coupled to the aerosol generator;
a sensor configured to sense a change in magnetic force occurring in the aerosol generator in response to a change in temperature of a susceptor located in the aerosol generator;
a communication circuit; and
a controller configured to:
control the communication circuit to transmit and receive wireless signals; and
control the power from the power supply to be supplied to the coil to heat the susceptor and cause heating of the aerosol generating article to generate an aerosol, based on the change in magnetic force.
